(19) United States
(12) Patent Application Publication
(10) Pub. No.: US 2024/0185113 A1
(43) Pub. Date: Jun. 6, 2024

(54) FAULT-TOLERANT QUANTUM COMPUTATION

(71) Applicants: President and Fellows of Harvard College, Cambridge, MA (US); QuEra Computing Incorporated, Boston, MA (US)

(72) Inventors: Iris Cong, Cambridge, MA (US); Shengtao Wang, Arlington, MA (US); Harry Jay Levine, Cambridge, MA (US); Alexander Keesling Contreras, Cambridge, MA (US); Mikhail D. Lukin, Cambridge, MA (US)

(21) Appl. No.: 18/512,860

(22) Filed: Nov. 17, 2023

Related U.S. Application Data
(63) Continuation of application No. PCT/US22/31297, filed on May 27, 2022.
(60) Provisional application No. 63/194,012, filed on May 27, 2021.

(51) Int. Cl. G06N 10/70; G06N 10/20

(52) U.S. Cl. CPC G06N 10/70; G06N 10/20

(57) ABSTRACT

Error detection and correction in a quantum computer are provided. The quantum computer includes qubits encoding a plurality of data qudits and an ancilla qudit. The qubits encoding the plurality of data qudits are arranged into a grouping wherein the qubits encoding each of the data qudits are within an interaction distance of an interacting state of the qubits encoding the ancilla qudit. A leakage error of a first data qudit of the plurality of data qudits into the interacting state is detected by detecting a state of the ancilla qudit. Quantum states of the qudits are selected such that angular momentum selection rules prohibit mixing between the selected quantum states during a leakage error of one of the qudits into a noninteracting state. The leakage error is corrected by optical pumping of the noninteracting state, preserving coherence of the selected quantum states in the absence of the leakage error.

### CROSS-REFERENCE TO RELATED APPLICATIONS

This application is a continuation of International Application No. PCT/US2022/031297, filed May 27, 2022, which claims the benefit of U.S. Provisional Application No. 63/194,012, filed May 27, 2021, each of which is hereby incorporated by reference in its entirety.

### STATEMENT REGARDING FEDERALLY SPONSORED RESEARCH OR DEVELOPMENT

This invention was made with government support under 2012023 and 1734011 awarded by National Science Foundation (NSF) and under DE-SC0021013 and DE-AC02-05CH11231 awarded by U.S. Department of Energy (DOE) and under W911NF-20-1-0021 awarded by U.S. Department of Defense/Defense Advanced Research Projects Agency (DOD/DARPA). The government has certain rights in this invention.

### BACKGROUND

Embodiments of the present disclosure relate to fault-tolerant quantum computation, and more specifically, to systems and methods for error correction in quantum computers, for example, those implemented using Rydberg Atoms.

### BRIEF SUMMARY

According to embodiments of the present disclosure, systems, methods and computer program products for fault-tolerant quantum computation are provided.

In various embodiments, methods of error detection in a quantum computer are provided. The quantum computer comprises a plurality of qubits encoding a plurality of data qudits and an ancilla qudit. The qubits encoding the plurality of data qudits are arranged into a grouping wherein the qubits encoding each of the plurality of data qudits are within an interaction distance of an interacting state of the qubits encoding the ancilla qudit. A leakage error of a first data qudit of the plurality of data qudits into the interacting state is detected by detecting a state of the ancilla qudit.

In some embodiments, each of the plurality of data qudits and the ancilla qudit is encoded in the atomic states of neutral atoms. In some embodiments, each of the plurality of data qudits is encoded in the atomic states of a first species of neutral atoms, and the ancilla qudit is encoded in the atomic states of a second species of neutral atoms.

In some embodiments, each of the plurality of data qudits and the ancilla qubit corresponds to a qubit.

In some embodiments, the interacting state is a Rydberg state.

In some embodiments, the grouping is a seven qudit grouping.

In some embodiments, the grouping is a three qudit grouping.

In various embodiments, methods of error correction in a quantum computer are provided. The quantum computer comprises a plurality of qubits encoding a plurality of qudits. Quantum states of the plurality of qudits are selected such that angular momentum selection rules prohibit mixing between the selected quantum states during a leakage error of one of the plurality of qudits into a noninteracting state. The leakage error is corrected by optical pumping of the noninteracting state, the optical pumping preserving coherence of the selected quantum states in the absence of the leakage error.

In some embodiments, each of the plurality of qudits is encoded in atomic states of neutral atoms.

In some embodiments, selecting the quantum states of the plurality of qudits comprises: selecting a first qudit state having a first magnetic quantum number and a second qudit state having a second magnetic quantum number, the first and second magnetic quantum numbers having opposite signs. In some embodiments, correcting the leakage error further comprises: prior to the optical pumping, coherently transferring atoms in the first qudit state into a first shelving state; prior to the optical pumping, coherently transferring atoms in the second qudit state into a second shelving state; subsequent to the optical pumping, coherently transferring the population of atoms in the first shelving state into the first qudit state; subsequent to the optical pumping, coherently transferring the population of atoms in the second shelving state into the second qudit state, wherein the optical pumping does not transfer atoms out of the first shelving state and the optical pumping transfers atoms from any ground state other than the first shelving state into the second shelving state.

In some embodiments, each of the plurality of qudits corresponds to a qubit.

In various embodiments, methods of implementing a controlled gate in a quantum computer are provided. The quantum computer comprises a plurality of qubits encoding at least one target qudit and at least one control qudit. Conditionally, according to a control state of the at least one control qudit, qubits encoding the at least one target qudit are coherently transferred from a plurality of states to corresponding shelving states, each selected from a first plurality of shelving states, the at least one control qudit precluding said transferring when the control state is an interacting state. The plurality of states is a subset of possible qudit states, and each possible qudit state can be populated by a decay process from at most one of the first plurality of shelving states. Conditionally, according to a control state of the at least one control qudit, qubits encoding the at least one target qudit are coherently transferred from the plurality of states to corresponding shelving states selected from a second plurality of shelving states when an error occurred during the transfer from the first plurality of states to the corresponding shelving states, the at least one control qudit precluding said transferring when the control state is an interacting state. Any of the plurality of qubits in the plurality of states is modified. Conditionally, according to a control state of the at least one control qudit, qubits encoding the at least one target qudit are coherently transferred from the shelving states of the first plurality of shelving states to each shelving state's corresponding state from the plurality of states. Any qubits encoding the target qudit not in a qudit state are incoherently transferred to a corresponding qudit state.

In some embodiments, each of the plurality of qudits is encoded in atomic states.

In some embodiments, each of the at least one target qudit and at least one control qudit correspond to a qubit.

In some embodiments, modifying any of the plurality of qubits comprises applying a unitary operation. In some embodiments, the unitary operation is an X gate.

In various embodiments, a system comprising a confinement system and a detector is provided. The confinement system is configured to arrange a plurality of particles in an array, the plurality of particles configured to encode a plurality of data qudits and an ancilla qudit, the confinement system further configured to arrange the plurality of particles encoding the plurality of data qudits into a grouping wherein the particles encoding each of the plurality of data qudits are within an interaction distance of an interacting state of the particles encoding the ancilla qudit. The confinement system comprises a laser source arranged to create a plurality of confinement regions and a source of an atom cloud, the atom cloud capable of being positioned to at least partially overlap with the plurality of confinement regions. The detector is configured to detect a state of the ancilla qudit, and thereby detect a leakage error of a first data qudit of the plurality of data qudits into the interacting state.

In some embodiments, the array is two-dimensional.

In various embodiments, a system comprising a confinement system and a plurality of laser sources is provided. The confinement system is configured to arrange a plurality of particles in an array, the plurality of particles configured to encode a plurality of data qudits and an ancilla qudit. The confinement system comprises a first laser source arranged to create a plurality of confinement regions and a source of an atom cloud, the atom cloud capable of being positioned to at least partially overlap with the plurality of confinement regions. The second laser source is configured to drive each of the plurality of particles into one of a plurality of quantum states, the plurality of quantum states selected such that angular momentum selection rules prohibit mixing between the plurality of quantum states during a leakage error of one of the plurality of particles into a noninteracting state. The third laser source is configured to optically pump the noninteracting state, the optical pumping preserving coherence of the plurality of quantum states in the absence of the leakage error.

In some embodiments, the array is two-dimensional.

### BRIEF DESCRIPTION OF THE SEVERAL VIEWS OF THE DRAWINGS

FIG. 1A is a schematic view of ancilla and data atoms using a seven-qubit encoding according to embodiments of the present disclosure.

FIG. 1B is a schematic view of a circuit implementing a procedure to measure a stabilizer operator according to embodiments of the present disclosure.

FIG. 1C is a level diagram showing an example encoding of a qubit in the hyperfine clock states of ⁸⁷Rb according to embodiments of the present disclosure.

FIG. 1D is a schematic view of ancilla and data atoms using a three-qubit encoding according to embodiments of the present disclosure.

FIG. 1E is a schematic view of a circuit for measuring a stabilizer operator according to embodiments of the present disclosure.

FIG. 2A is a level diagram illustrating a Rydberg blockade mechanism according to embodiments of the present disclosure.

FIG. 2B shows a protocol for performing a multi-qubit entangling Rydberg gate according to embodiments of the present disclosure.

FIG. 3 illustrates the reordering of physical gates in performing a logical CCZ operation according to embodiments of the present disclosure.

FIG. 4 is a schematic view of a circuit implementing Steane's Latin rectangle encoding method according to embodiments of the present disclosure.

FIG. 5 illustrates an optical pumping protocol to convert non-Rydberg leakage errors to Pauli-Z errors according to embodiments of the present disclosure.

FIG. 6 is a schematic view of a circuit to measure a stabilizer according to embodiments of the present disclosure.

FIG. 7 illustrates a pulse sequence for the target atom in a bias-preserving CNOT gate according to embodiments of the present disclosure.

FIG. 8 is a schematic view of a circuit using an ancilla qubit and multiple Rydberg states to eliminate X type errors arising from control qubit decay according to embodiments of the present disclosure.

FIG. 9 is a schematic view of a circuit providing a pieceable fault-tolerant implementation of the Toffoli gate in the repetition code according to embodiments of the present disclosure.

FIG. 10 is a schematic view of a circuit implementing a logical Hadamard gate using a logical Toffoli gate combined with fault-tolerant measurements in the X basis according to embodiments of the present disclosure.

FIG. 11 is a relevant level diagram for implementing error correction with neutral alkaline earth Rydberg atoms according to embodiments of the present disclosure.

FIG. 12 is a graph of branching ratios for BBR transitions out of a stretched Rydberg state according to embodiments of the present disclosure.

FIG. 13 is a schematic view of a circuit for detecting atom loss according to embodiments of the present disclosure.

FIG. 14 is a schematic view of a circuit using two ancilla qubits and multiple Rydberg states to implement a bias-preserving Toffoli gate according to embodiments of the present disclosure.

FIG. 15A is a schematic view of ancilla and data atoms using a seven-qubit encoding according to embodiments of the present disclosure.

FIG. 15B is a schematic view of ancilla and data atoms using a three-qubit encoding according to embodiments of the present disclosure.

FIG. 16 is a schematic view of ancilla and data atoms using a three-qubit encoding on a square lattice geometry according to embodiments of the present disclosure.

FIG. 17 is a schematic view of an apparatus for fault tolerant quantum computation according to embodiments of the present disclosure.

### DETAILED DESCRIPTION

Neutral atom arrays have emerged as a promising platform for quantum information processing. However, a limitation on application of these systems is the ability to perform error-corrected quantum operations. One important remaining roadblock for large-scale quantum processing in such systems is associated with the finite lifetime of atomic Rydberg states during entangling operations. To entangle the qubits in these systems, atoms are typically excited to Rydberg states, which could decay or give rise to various correlated errors. Because Rydberg state decay errors can result in many possible channels of leakage out of the computational subspace as well as correlated errors, they cannot be addressed directly through traditional methods of fault-tolerant quantum computation.

The present disclosure provides a detailed analysis of the effects of these sources of error in a neutral-atom quantum computer and propose hardware-efficient, fault-tolerant quantum computation schemes that mitigate them. By using the specific structure of the error model, the multi-level nature of atoms, and dipole selection rules, the present disclosure provides a novel and distinctly efficient method to address the most important errors associated with the decay of atomic qubits to states outside of the computational subspace. These advances enable a significant reduction in the resource cost for fault-tolerant quantum computation compared to alternative, general-purpose, schemes, even when these novel types of errors are accounted for. The experimental feasibility of these protocols is illustrated through concrete examples with qubits encoded in ⁸⁷Rb, ⁸⁵Rb, or ⁸⁷Sr atoms. The protocols provided herein can be implemented in the near-term using state-of-the-art neutral atom platforms with qubits encoded in both alkali and alkaline-earth atoms.

The term qudit (quantum digit) denotes the unit of quantum information that can be realized in suitable d-level quantum systems. A collection of qubits that can be measured to N states can implement an N-level qudit.

Neutral atom systems have emerged as a promising platform for quantum information processing. While the exceptional coherence times of their ground states enable long-lived quantum memories, fast, high-fidelity quantum operations can be achieved by individually addressing atoms with laser pulses and coupling them to highly-excited Rydberg states. Furthermore, large numbers of individual neutral atoms can be deterministically arranged with arbitrary geometry in two- and three-dimensional systems. Experiments have demonstrated quantum manipulation in large arrays of atoms for applications ranging from quantum computing to quantum simulations and quantum metrology. Several advances in the dynamic reconfiguration of atoms have even led to the realization of logical qubits encoded in color, surface, or toric codes, which is an important step in performing quantum error correction (QEC) on neutral atom platforms.

While current experiments are already demonstrating a remarkable level of quantum control, experimental imperfections such as Rydberg state decay will eventually limit the depth of accessible quantum operations. To scale up the computation size, it is therefore essential to consider quantum error correction (QEC) protocols. In particular, such protocols should be fault-tolerant and protect against the key sources of errors occurring within any of the computation, error detection, and encoding and decoding stages. Fault-tolerant protocols for generic quantum platforms do not address certain errors present in Rydberg atom setups. Indeed, Rydberg-atom QEC seems to face a daunting challenge at first glance: Rydberg states could decay into multiple other states, which not only results in leakage errors out of the computational space, but could also give rise to high-weight correlated errors from ensuing undesired blockade effects.

To address these considerations, the present disclosure describes the effects of these intrinsic errors and describes how to utilize the unique capabilities of Rydberg systems and the structure of the error model to design hardware-efficient fault-tolerant quantum computation (FTQC) schemes that address these errors despite the aforementioned challenges. This tailored FTQC approach can even be much more resource efficient than generic alternatives, which often require a larger number of qubits and quantum operations with smaller threshold error than what is achievable in near-term experiments to perform non-Clifford logical operations, either directly or by using state distillation. The high overhead associated with such protocols is why experimental demonstrations of QEC have thus far been limited to only one or two logical qubits.

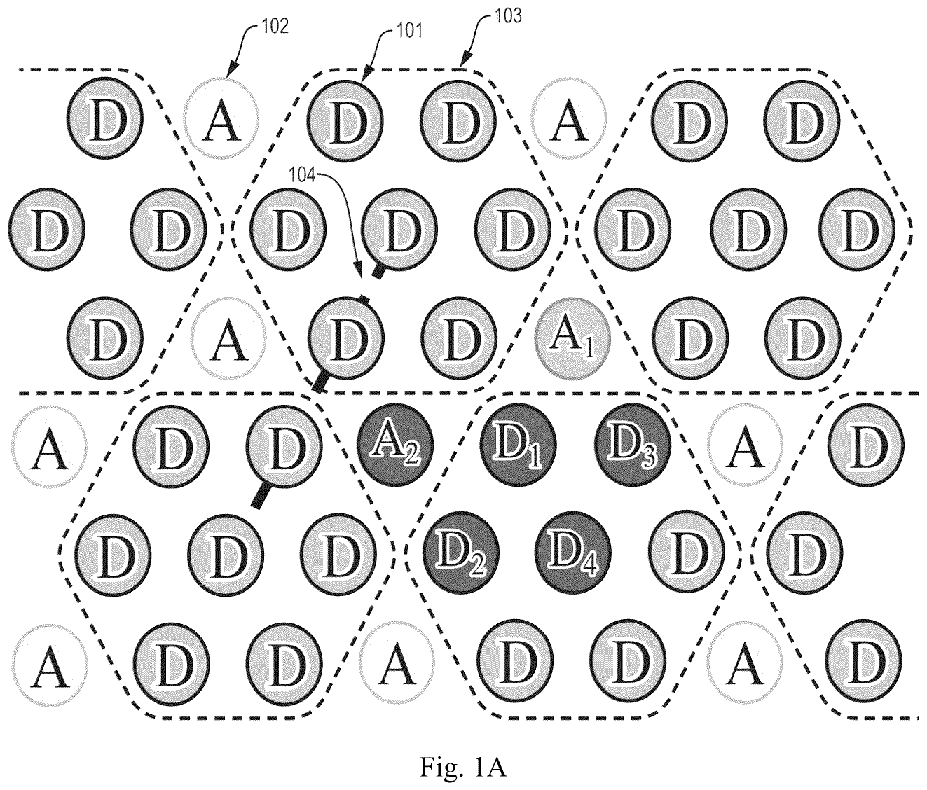

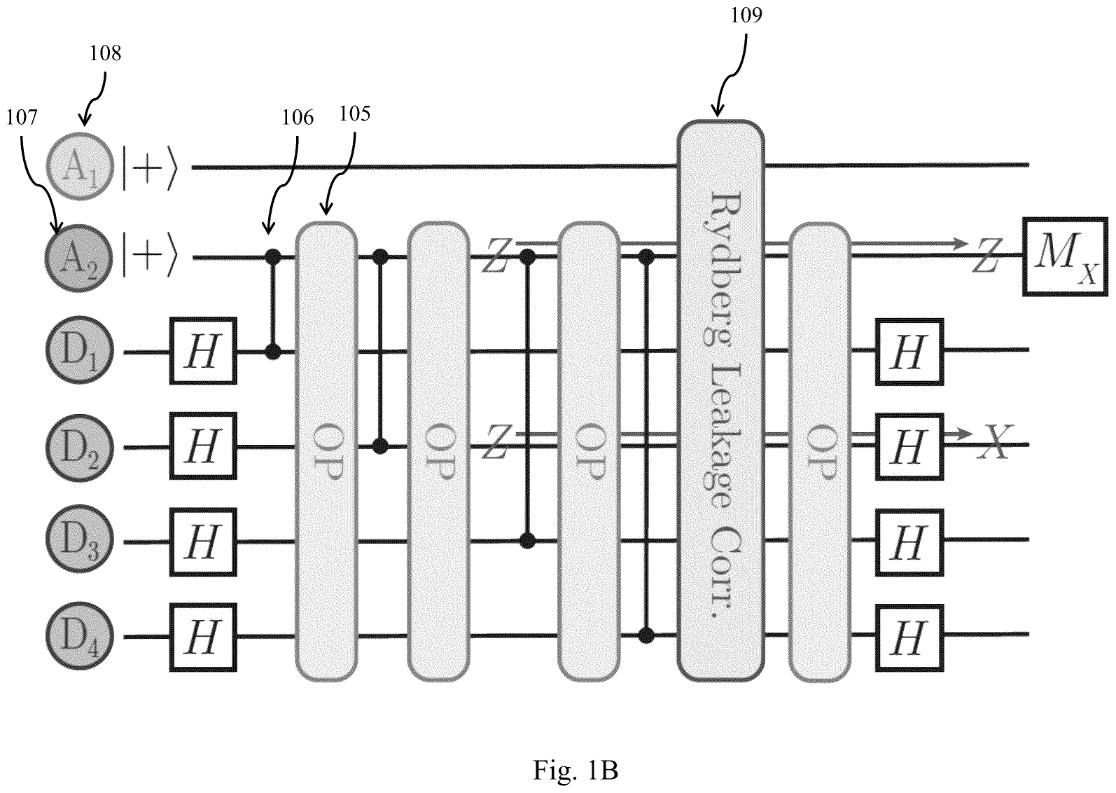

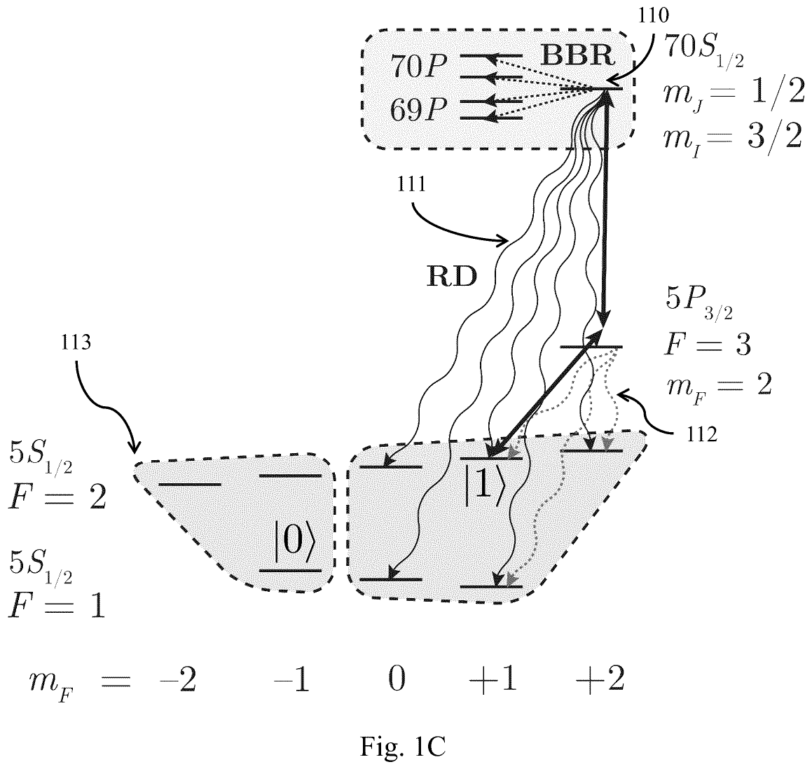

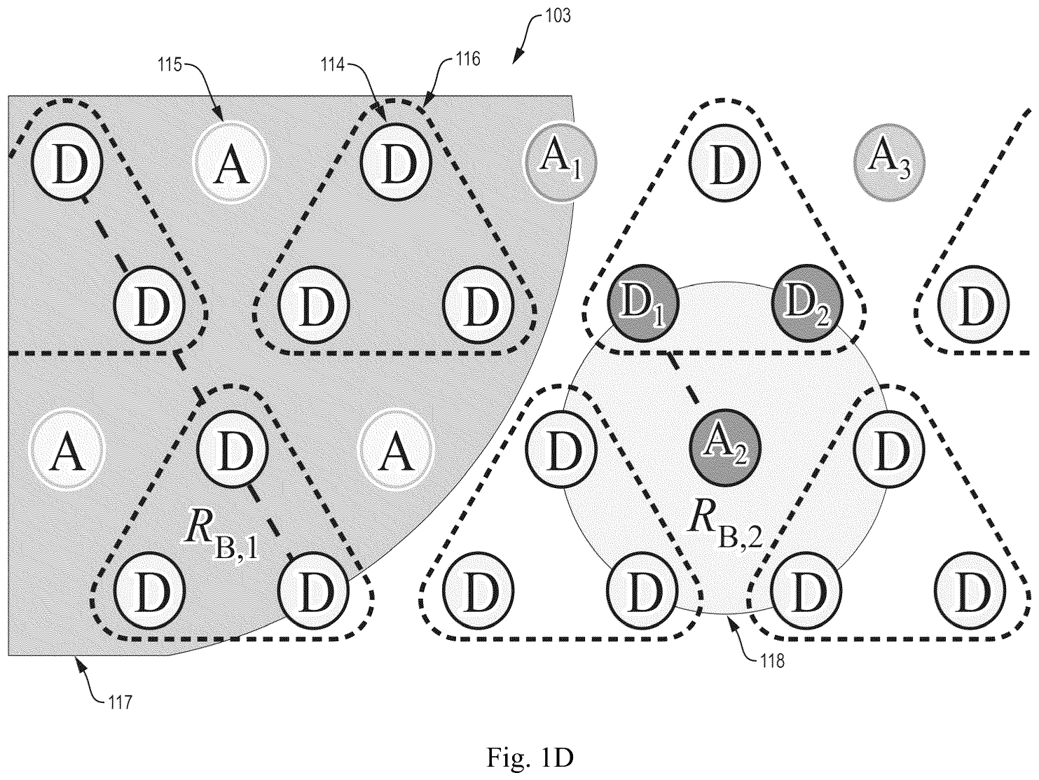

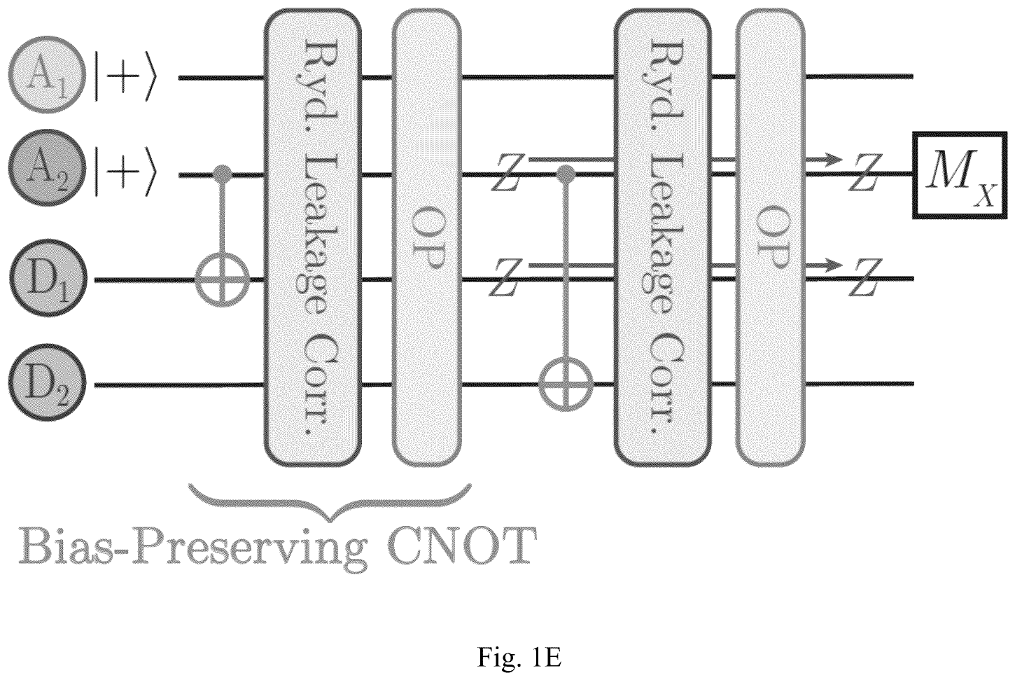

The present disclosure provides, first, a detailed description from the QEC perspective, of the errors arising from the finite lifetime of the Rydberg state or from imperfections in Rydberg laser pulses. Methods are provided for performing hardware-efficient, fault-tolerant quantum computation (FTQC) while addressing the intrinsic sources of error in neutral Rydberg atom platforms (FIG. 1).

Second, the present disclosure shows that nine atoms—seven data qubits and two ancilla qubits—are sufficient to encode each logical qubit fault-tolerantly based on the seven-qubit Steane code. Performance of a universal set of fault-tolerant quantum operations is provided.

For atomic species with sufficiently large nuclear spin and high-fidelity ground-state operations, it is shown that quantum computation with leading-order fault-tolerance can be achieved even using a simple three-atom repetition code. The three-qubit repetition code does not correct any Pauli-X errors, so it cannot be used for FTQC in typical setups. However, because the error model for Rydberg-atom setups does not contain any Pauli-X errors at the leading order (as shown below), the repetition code is applicable in these platforms. The term “leading-order fault-tolerance” is thus used when describing the Ryd-3 protocol to emphasize this point explicitly. Both the seven-atom and three-atom codes can be implemented on scalable geometries with atoms placed in a triangular lattice configuration (see FIGS. 1A, 1D), enabling their demonstration and application in near-term implementations.

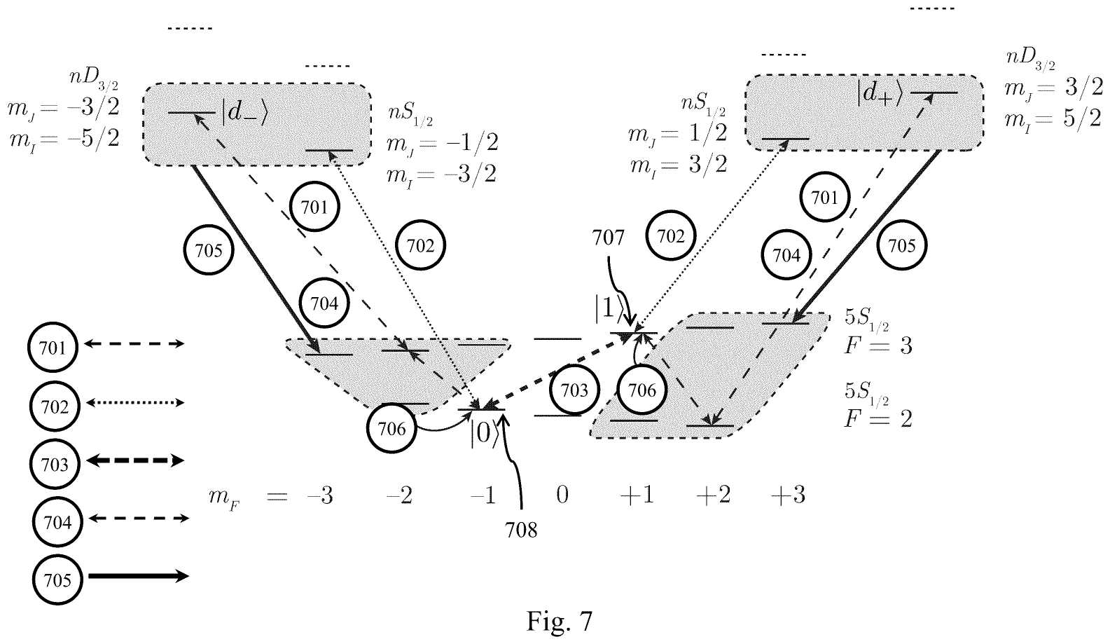

Various embodiments of hardware-efficient FTQC are based on several key insights. First, a realistic error model is provided to show that by making use of dipole selection rules, the Rydberg blockade effect, and optical pumping techniques, a complex leakage error associated with Rydberg atom decay can be reduced to a simple Pauli-Z type error (FIG. 1C). Second, it is shown that the logical state preparation, stabilizer measurements, and a universal set of logical gates for the seven-qubit code can all be implemented as a sequence of physical gates which commute with Pauli-Z errors, up to single-qubit unitaries at the beginning and end of the operation. Thus, any Rydberg gate error cannot spread to other qubits within a single stabilizer measurement or logical operation, and can be efficiently detected and corrected using much fewer entangling gates than existing, general-purpose schemes (FIG. 1B, Table 1 and Table 2). Third, to adopt an even more compact three-atom code for this error model, it is provided that all error correction and logical operations can be implemented in a bias-preserving way—that is, Pauli-X and Y errors cannot emerge at any stage of computation. For atomic species with sufficiently high nuclear spin, this can be achieved by designing a new laser pulse sequence for entangling gates between Rydberg atoms, which can be used to implement bias-preserving controlled-NOT (CNOT) and Toffoli gates (see FIG. 1E and FIG. 7). Fourth, by studying the qubit-connectivity required to implement all error correction and logical operations, it is shown that both the seven-atom and three-atom codes can be implemented on scalable geometries with atoms placed in a triangular lattice configuration (FIGS. 1A, D), allowing for their demonstration and study in near-term experiments.

The present disclosure provides an important advance over prior methods by introducing a distinctly efficient approach to address the leakage of qubits out of the computational subspace. For traditional QEC proposals, such leakage is one of the most difficult and costly types of errors to detect and address, making it unfavorable to encode qubits in large multi-level systems, such as neutral atoms. The methodology provided herein to address these leakage errors makes use of techniques based on optical pumping, such that the multi-level structure of each atom can be utilized as part of the redundancy required for QEC. While the focus herein is on neutral atom-based quantum information processors, these techniques are adaptable to many other hardware platforms—for example, they could also greatly facilitate the correction of leakage-type errors in superconducting qubits or trapped ions. For the Rydberg-atom systems described herein, a method is provided that even converts all leading-order errors to Pauli-Z type errors (see FIG. 1B), which enables the development of particularly efficient FTQC protocols.

Referring to FIG. 1A, an architecture for FTQC with Rydberg atoms is illustrated according to embodiments of the present disclosure.

FIG. 1A shows the geometrical layout of atoms for FTQC using the seven-qubit encoding. Data (D, 101) and ancilla (A, 102) atoms are placed on the vertices of a triangular lattice, with seven data atoms comprising a logical qubit (dotted hexagons 103). The dotted grey line 104 indicates the Rydberg interaction range required.

FIG. 1B illustrates a circuit implementing a procedure to measure a stabilizer operator, X₁X₂X₃X₄, for the seven-qubit code supported on the four data atoms highlighted in FIG. 1A. Optical pumping (OP, 105) is performed following every controlled-phase gate (106) to correct for leakage into other ground states. Ancilla qubit A₂ (107) measures the stabilizer eigenvalue, while ancilla qubit A₁ (108) is used to detect and correct for Rydberg leakage errors (109). In this way, all gate errors are converted to Pauli-Z type errors and do not spread to other qubits.

FIG. 1C is a level diagram showing an example encoding of a qubit in the hyperfine clock states of ⁸⁷Rb. The dominant intrinsic errors for this encoding arise from blackbody radiation (BBR, 110), radiative decay (RD, 111), and intermediate state scattering (112). Their effects can be determined via dipole selection rules (113), and the relevant leakage errors can be corrected by making use of the Rydberg blockade effect or optical pumping.

FIG. 1D illustrates a geometrical layout for quantum computation with leading-order fault-tolerance using the three-atom encoding. Data 114 and ancilla 115 atoms are placed on the vertices of a triangular lattice, with three data atoms comprising a logical qubit (116). In this case, two Rydberg states with different blockade radii, R_{B,1} and R_{B,2} (117 and 118, respectively) are required.

FIG. 1E shows a circuit for measuring a stabilizer operator, X₁X₂, of the repetition code supported on the two data atoms highlighted in FIG. 1D. By combining a novel entangling pulse sequence with Rydberg leakage correction and optical pumping, a bias-preserving CNOT gate is implemented (see FIG. 7), allowing performance of QEC without introducing X or Y errors at any point in the computation.

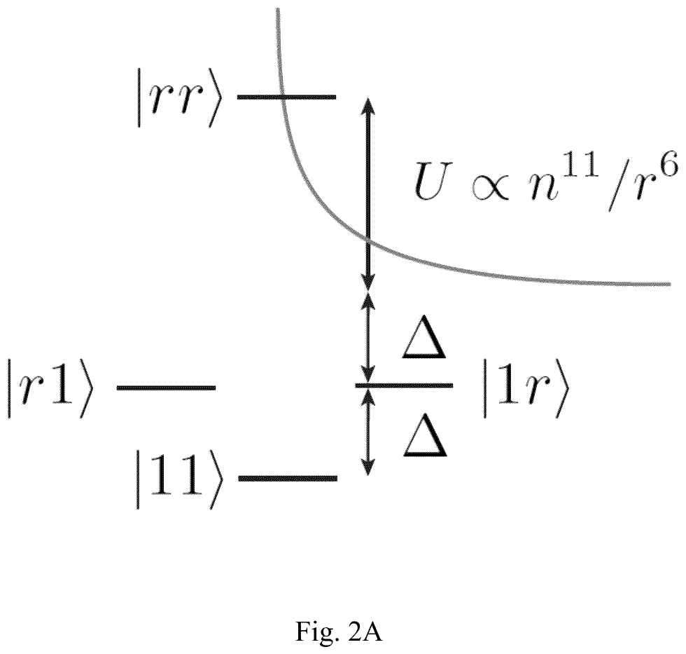

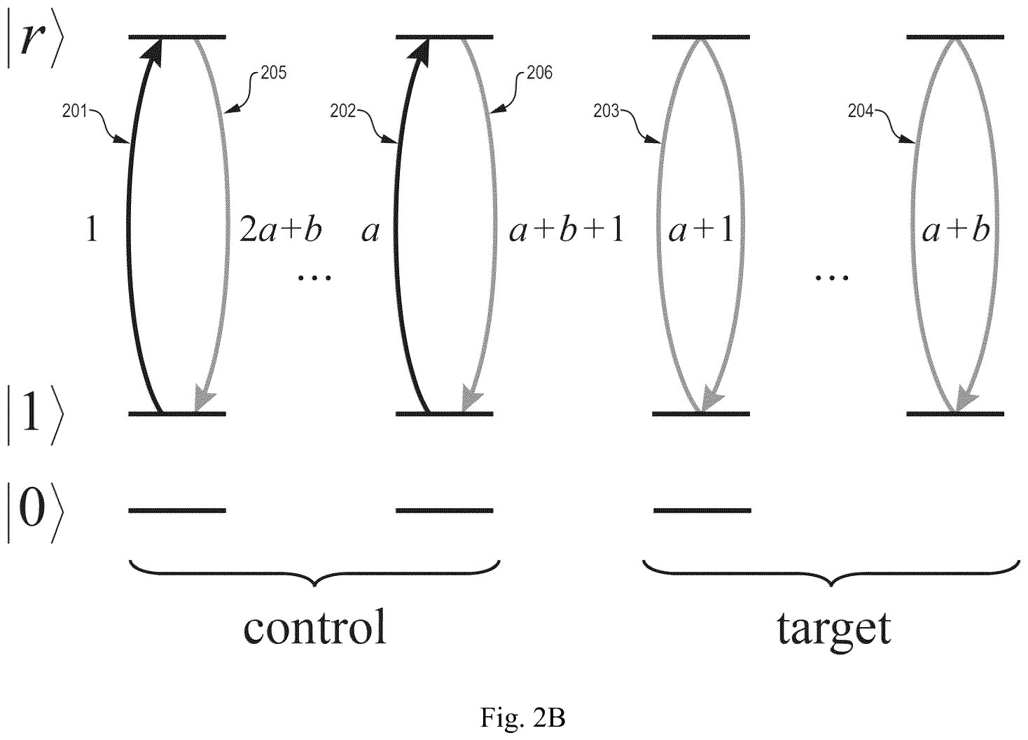

Consider neutral atoms in a static magnetic field B=B_{z}\hat{z}. Due to the nonzero nuclear spin I, the electronic ground state manifold consists of many sub-levels split by hyperfine coupling and a finite B field. These levels exhibit remarkably long lifetimes, making them particularly good candidates for encoding qubits (or more generally, qudits) for quantum information processing. Furthermore, although neutral atoms in ground electronic states are effectively non-interacting, entangling gates between nearby atoms can be performed by coupling one of the qubit states (e.g., |1 [symbol] ) to a Rydberg nS state |r [symbol] with large n, which exhibits strong van der Waals interactions (FIG. 2A). Under certain conditions, these interactions can be interpreted effectively as a blockade constraint prohibiting simultaneous Rydberg population within a blockade radius R_{B}. These can be leveraged to perform, for example, fast multi-control, multi-target phase gates R(C₁, C₂, . . . , Cₐ; T₁, T₂, . . . T_{b}) (sometimes also referred to as collective gates), which are related to the standard C^{a}Z^{b} gates upon conjugating all control qubits Cⱼ and the first target qubit T₁ by Pauli-X gates; this is achieved by applying individually addressed, resonant π and 2π pulses between the qubit |1 [symbol] state and the Rydberg state (FIG. 2B). Such an operation is also related to the gate C^{a}NOT^{b} by single-qubit unitaries.

While this procedure provides an efficient scheme to entangle two or several atoms, for large-scale quantum computations, the finite lifetime of Rydberg states presents an important source of error even if the rest of the experimental setup is perfect. This lifetime is determined by several contributions. First, interactions with blackbody photons can induce transitions from the nS state to nearby Rydberg n′P states of higher or lower energy; such errors are subsequently referred to as blackbody radiation-induced (BBR) errors. Second, spontaneous emission of an optical frequency photon can result in radiative decay (RD) to a low-lying P state, which will quickly relax into the ground state manifold.

In addition, if a multi-photon Rydberg excitation scheme is used for the Rydberg pulses, another intrinsic source of error during Rydberg gates is photon scattering from an intermediate state. These error channels are illustrated in FIG. 1C.

For the purposes of QEC, these errors can be formally described as follows: BBR errors give rise to quantum jumps from the qubit |1 [symbol] state to Rydberg P states (corresponding to a leakage error), as well as Pauli-Z errors within the qubit manifold, while RD and intermediate state scattering may also result in quantum jumps from |1 [symbol] to the Rydberg nS state or other hyperfine ground states. The relative error probabilities are determined by selection rules and branching ratios. In addition to these intrinsic errors, errors in the experimental setup such as Rydberg pulse imperfections or finite atomic temperatures are also considered. These experimental errors fall within a subset of the RD error model and can therefore also be addressed using the techniques provided herein. Throughout this work, it is assumed that the rotations within the hyperfine manifold have much higher fidelity than the Rydberg pulses, as is typically the case. Such errors can also be suppressed to high orders by using existing experimental methods, such as composite pulse sequences, or addressed by incorporating traditional QEC techniques such as concatenation.

Referring to FIG. 2A, a Rydberg blockade mechanism according to the present disclosure is illustrated. Δ is the Rydberg laser detuning, and the Rydberg interaction strength U∝n¹¹/r⁶, where n is the principal quantum number and r is the atom separation.

FIG. 2B shows a protocol for performing a multi-qubit entangling Rydberg gate R(C₁, C₂, . . . , Cₐ; T₁, T₂, . . . T_{b}) on a set of atoms which are all within one given blockade volume. Resonant it pulses |1 [symbol] ↔|r [symbol] are first applied to each control qubit (201, 202), followed by 2π pulses on each target qubit (203, 204). The control qubits are then returned to the ground state manifold via it pulses 205, 206.

Labels on the arrows indicate the ordering of pulses. This Rydberg gate is related to the more conventional controlled-phase gate C^{a}Z^{b} by conjugating all control qubits and one target qubit by Pauli-X operations, or by applying Pauli-Z gates on both control and target qubits in the special case of a=b=1 (CZ=R(C₁; T₁)Z_{C}_{₁}Z_{T}_{₁}). It can also be used to implement C^{a}NOT^{b} from C^{a}Z^{b} by conjugating the target qubits by Hadamard gates. The Rydberg gate R(C₁, C₂, . . . , Cₐ; T₁, T₂, . . . T_{b}) is sometimes referred to as a collective gate.

### Reduction to Pauli-Z Errors

To protect against the errors mentioned above, three critical observations are used (see FIG. 1C). First, it is noted that quantum jumps from |1 [symbol] to Rydberg states associated with BBR can be detected via the Rydberg blockade effect by using a nearby ancilla qubit, and subsequently converted to a Pauli-Z type error by incoherently repumping the Rydberg states back to the ground state manifold or ejecting the Rydberg atom and replacing it with a fresh atom prepared in the |1 [symbol] state. Second, quantum jumps from |1 [symbol] to ground state sublevels outside the qubit subspace can be corrected via optical pumping techniques. This is particularly efficient as it does not require any qubit measurement for feed-forward corrections, unlike alternative proposals for correcting leakage errors.

Third, for atomic species with large enough nuclear spin, dipole selection rules prevent a stretched Rydberg state from decaying to certain ground state sublevels. By making use of this multi-level structure of neutral atoms along with the high-fidelity manipulations of hyperfine states, it is ensured that RD and intermediate state scattering errors do not result in |1 [symbol] →|0 [symbol] transitions, thereby eliminating X and Y type errors from the error model. This reduction of error types can significantly alleviate the resource requirement for FTQC.

TABLE 1

| | 2-Qubit Gates | | 3-Qubit Gates | Ancillas |
|---|---|---|---|---|
| 7-Qubit Flagged | 36 | (48) | 0 | 2 |
| 15-Qubit Flagged | 80 | (112) | 0 | 2 |
| Ryd-7 | 24 | (36) | 0 | 2 |
| Ryd-3 | 8 | (16) | 4 (8) | 4 |

Table 1 provides a comparison of resource costs for fault-tolerant measurement of all stabilizers to correct Pauli errors. Numbers in parentheses indicate the maximum number of operations required in the unlikely scenario where an error is detected. Details on how to obtain the gate counts for the Ryd-7 and Ryd-3 protocols can be found below.

TABLE 2

| | 2-Qubit Gates | | 3-Qubit Gates | Ancillas |
|---|---|---|---|---|
| Yoder, Takagi, | 162 | | 21 | 72 |
| and Chuang (CCZ) | | | | |
| Chao and Reichardt (CCZ) | 1352 | (1416) | 84 | 4 |
| Ryd-7 (CCZ) | 0 | (78) | 27 (29) | 2 |
| Ryd-3 (CCZ) | 0 | (18) | 27 (27) | 4 |
| Ryd-3 (H) | 20 | (28) | 53 (57) | 10 |

Table 2 provides a comparison of resource costs for the highest-cost fault-tolerant logical operation. CCZ denotes the three-qubit controlled-controlled-phase gate, while H denotes the single-qubit Hadamard gate. Numbers in parentheses indicate the maximum number of operations required in the unlikely scenario where an error is detected. For the Rydberg protocols, the gate counts presented assume a blockade radius of 3 d, where d is the nearest-neighbor lattice spacing. Derivations of the gate counts for the Ryd-7 and Ryd-3 protocols and details on how to obtain the blockade radius requirement can be found below.

Fault-Tolerant Protocols

Two FTQC protocols are now described to address these intrinsic errors in neutral Rydberg atom platforms. The first is based on the seven-qubit Steane code, while the second uses the three-qubit repetition code; the latter is more compact and efficient, but has additional experimental requirements such as control over multiple Rydberg states and more complex encoding of logical operations.

To realize the seven-qubit code (Ryd-7), it is noted that logical state preparation, stabilizer measurements, and a universal set of logical gates (Hadamard and Toffoli) can be implemented using only controlled-phase (CZ) or controlled-controlled-phase (CCZ) gates, up to single-qubit unitaries at the beginning and end of the operation. For example, while the stabilizer measurements are typically presented as a sequence of CNOT gates between the data atoms and an ancilla atom, these CNOT gates can be constructed by conjugating a CZ gate with Hadamard gates on the target qubit. By mapping each Rydberg gate error to a Pauli-Z error, it is ensured that it will commute with all subsequent entangling gates in the logical operation or stabilizer measurement, so it does not spread to other qubits (FIG. 1B). The resulting single-qubit X or Z error can be corrected by the seven-qubit code in a subsequent round of QEC. This eliminates the need for flag qubits, which are otherwise necessary to prevent spreading of errors. To further reduce resource costs for experimental implementation, additional use is made of the structure of the Rydberg error model, stabilizer measurement circuits, and logical operations of the seven-qubit code. For example, one of the key findings is that leakage errors into other Rydberg states do not need to be corrected after every Rydberg gate, but can be postponed to the end of a stabilizer measurement (e.g., FIG. 1B). This allows minimization of the number of intermediate measurements necessary for each FTQC component, which is typically a limiting factor in state-of-the-art neutral atom experiments.

The simplified error model introduced by conversion of all Rydberg gate errors to Pauli-Z errors motivates the use of a three-qubit repetition code instead of the seven-qubit code to design a leading-order fault-tolerant protocol (Ryd-3). In this case, the stabilizer measurement circuits are also comprised of CNOT gates on data atoms controlled by the ancilla. However, the implementation of each CNOT must be modified: when a CZ gate is conjugated by Hadamard gates as in FIG. 1B, a Pauli-Z type error that occurs during the CZ gate will be converted to a Pauli-X error after the Hadamard. Such an error can no longer be corrected by the repetition code.

Additional errors, such as radiative decay of a control qubit prior to manipulation of the target qubit, can lead to error spreading and correlated errors.

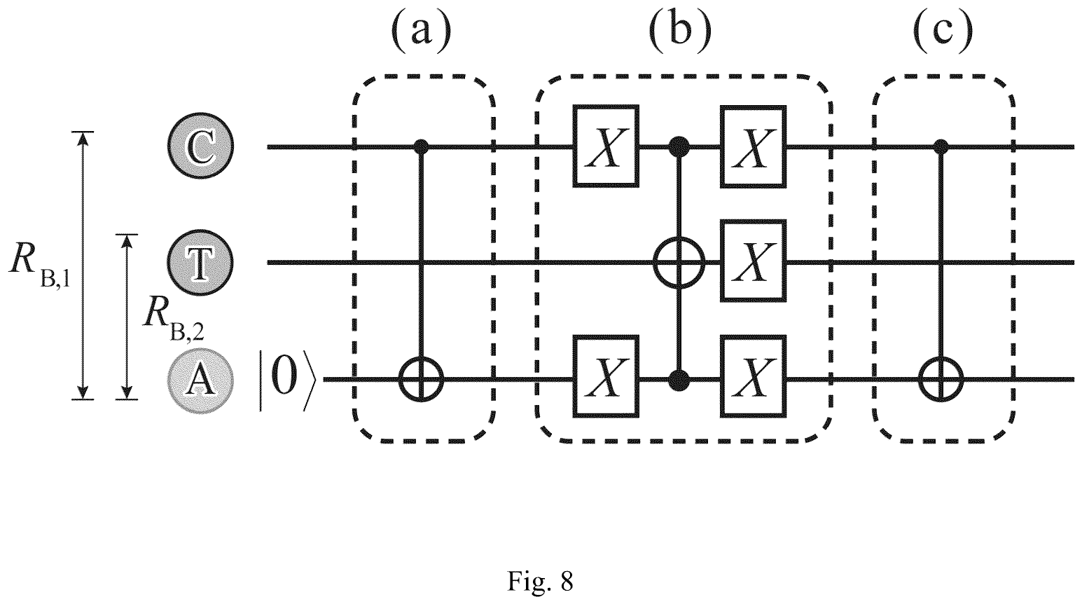

These errors can be addressed via a protocol to directly implement CNOT gates in a bias-preserving way, such that these implementations will not generate any Pauli-X and -Y errors to leading order (FIGS. 7 and 8). Protocols provided herein make use of the rich multilevel structure of atoms with large nuclear spin (I≥5/2, e.g., ⁸⁵Rb, ¹³³Cs, ⁸⁷Sr, . . . ), as well as additional Rydberg states for shelving. Furthermore, the fact that pulses between certain (hyperfine) levels can be performed with very high fidelity is leveraged, so that leading-order errors involve only Rydberg state decay or Rydberg pulse imperfections. This assumption is particularly important, as a bias-preserving CNOT gate cannot be implemented in any qudit system with a finite number of levels without such structure in the error model. To circumvent this, the pulse sequence directly implements a hyperfine Pauli-X gate on the target qubit only if a nearby Rydberg atom is present (without the need for subsequent Hadamard gates), and it is shown that errors during this sequence can all be mapped to Pauli-Z errors. Additionally, correlated errors due to control-atom decay can be prevented by using multiple control atoms, such that if one atom decays, the remaining atom(s) still ensure proper gate operation on the target atom. This bias-preserving CNOT protocol can be directly generalized to implement a bias-preserving Toffoli operation, enabling a leading-order fault-tolerant implementation of each operation of the three-atom repetition code. Throughout the present disclosure, the term “leading-order fault-tolerance” is used in referring to the Ryd-3 protocol, as the framework provided herein does not inherently address all single-qubit errors, but existing experimental techniques, such as composite pulse sequences, can be used in conjunction with the protocol provided herein to suppress such errors to higher orders (see below).

The protocols provided herein are preferable to general-purpose FTQC proposals. In particular, the number of required physical qubits and gates for both approaches provided herein are dramatically reduced (Table 1 and Table 2). For example, as seen in Table 2, performing the highest-cost operation from the logical gate set, the Ryd-7 protocol requires only 2 ancilla qubits compared with 72 ancillas in Yoder, et al. See T. J. Yoder, R. Takagi, and I. L. Chuang, Universal fault-tolerant gates on concatenated stabilizer codes, Phys. Rev. X vol. 6, p. 031039 (2016). Likewise, Ryd-7 uses at most 60 2-qubit gates (when errors are detected) to perform this logical operation, instead of 1416 gates as in Chao, et al. See R. Chao and B. W. Reichardt, Fault-tolerant quantum computation with few qubits, Quantum Information vol. 4, p. 42 (2018). Such a significant reduction is possible for the protocols provided herein, because both the special structure of the error model and the unique capabilities of Rydberg setups are leveraged.

Certain single-qubit errors addressed in Chao and Yoder are not corrected in the protocols provided herein (e.g., Pauli-X errors arising from rotations in the hyperfine manifold). However, Chao and Yoder did not consider additional types of errors, such as leakage errors which are corrected by the protocol provided herein. Indeed, incorporating leakage correction would further increase the resource cost for the earlier proposals considerably. As such, Table 1 and Table 2 should be interpreted as a comparison of the cost of ensuring fault-tolerance against the leading-order sources of error in a given setup. In the case of Chao and Yoder these errors include all single-qubit Pauli errors, but not leakage errors, while in Rydberg systems, one must address leakage errors at leading order, but can neglect certain single-qubit errors. Such a significant reduction in cost is possible for the protocols provided herein because both the special structure of the error model and the unique capabilities of Rydberg setups are leveraged.

### Experimental Implementation

For scalable implementation of the FTQC protocols provided herein, it is important to consider the geometrical placement of atoms. In addition, because Rydberg entangling gates can only be implemented between atoms within the blockade radius R_{B}, each protocol defines a minimum value of R_{B} (in units of d, which is the smallest atom-atom separation). It is shown that both the Ryd-7 and Ryd-3 protocols can be implemented naturally when the atoms are placed on the vertices of a triangular lattice as shown in FIGS. 1A, D. For both protocols, the required Rydberg gates can be implemented when the blockade radius (R_{B} for Ryd-7, or the larger radius R_{B,1} for Ryd-3) is greater than 3 d. This requirement can be further reduced in both cases if it is possible to move atoms in between certain operations while preserving the coherence of hyperfine ground states, a capability that is now available.

Each component of the FTQC schemes provided herein can be implemented in near-term experiments. For neutral alkali-atom systems, high-fidelity control and entanglement are available. The near-deterministic loading of atoms into lattice structures as shown in FIGS. 1A, 1D is available in two and three dimensions.

To perform QEC according to the protocols provided herein, an important requirement is the ability to measure individual qubits and/or detect Rydberg population and perform feed-forward corrections. One approach for performing fast measurements of individual qubit states in neutral atom arrays is to use arrays with two atomic species, where the data atoms are encoded in one atomic species and ancilla atoms are encoded in the other species so that they can be easily measured. Alternatively, if an atom can be moved far enough away from the rest of the array to mitigate effects of cross-talk while preserving quantum coherence of the remaining atoms, this rapid qubit state detection could be performed in a single-species array using resonant photon scattering on a cycling transition. Fast detection schemes are demonstrable in experiments with large atomic ensembles using Rydberg electromagnetically induced transparency (EIT) technologies and can be integrated with the tweezer array platforms currently used for quantum computation. In these procedures, the Rydberg blockade effect translates to clean signatures in the absorption spectrum, and the collectively enhanced Rabi frequency allows for ultrafast detection in microseconds.

Finally, while the present disclosure focuses primarily on neutral alkali atoms, alkaline-earth atoms may also be used for Rydberg-based quantum computations. The clock transition in these atoms allows for high-fidelity qubit encodings, and the large nuclear spin in fermionic species is particularly advantageous for the protocols provided herein.

### Error Channels in Rydberg Atoms

Dominant error mechanisms for quantum operations involving Rydberg atoms (FIG. 1C) are analyzed below. Because the predominant errors in single-qubit operations can be suppressed to high orders via composite pulse sequences, one may primarily focus on errors occurring during Rydberg-mediated entangling operations. The decay channels of the Rydberg states include blackbody radiation-induced (BBR) transitions and spontaneous radiative decay (RD) transitions to lower-lying states. Depending on the specific choice of atomic species, another source of error for Rydberg gates can be the scattering from an intermediate state if a two- or multi-photon excitation scheme is used; this is the case for excitation of ⁸⁷Rb or ⁸⁵Rb to Rydberg nS states. It is assumed that these effects are the predominant source of errors that occur during the entangling operations, and contributions to the error model to leading order in the total error probability.

### Error Modeling for BBR Transitions

When a BBR transition occurs on one of the atoms during an entangling gate, it signals that this atom has started in the |1 [symbol] state, since |0 [symbol] is not coupled to |r [symbol] . Such a procedure corresponds to a quantum jump. The resulting state will predominantly be a nearby Rydberg state |r′ [symbol] compatible with dipole selection rules. Due to the relatively long lifetimes of Rydberg states, it may be assumed that the atom will not decay again within the timescale of several Rydberg gate operations, as these would be higher-order processes. In this case, because the states |r′ [symbol] are not de-excited in the ensuing operations, one serious consequence of BBR quantum jumps is that the remaining Rydberg operations on atoms within the interaction range will be affected by blockade, potentially resulting in multiple, correlated Pauli-Z type errors. Less intuitively, even if a quantum jump does not occur during the gate operation, the atom's state is still modified due to evolution under a non-Hermitian Hamiltonian: it will be more likely that the atom started out in the |0 [symbol] state.

For the purposes of QEC, it is useful to express the decay channels in the Kraus operator form, where time evolution of a density operator is given by ρ [symbol] Σ_{α}M_{α}ρM_{α}^{†} and the Kraus operators M_{α} satisfy the completeness relation Σ_{α}M_{α}^{†}M_{α}=1. For the BBR error model, there will be one Kraus operator

M_{r′}∝|r′ [symbol] [symbol] 1| Equation 1
for each possible final Rydberg state |r′ [symbol] , where the proportionality constant is determined by the BBR transition rate from |r [symbol] to |r′ [symbol] . In the absence of quantum jumps, the evolution is given by the Kraus map

$${M}_{0} = \sqrt{1 - P} \vert 1 〉 〈 1 \vert + {\sum }_{\vert n 〉 \neq \vert 1 〉} \vert n 〉 〈 n \vert \qquad Equation 2$$

where P is the probability for a BBR transition to occur.

During entangling operations, these BBR errors can give rise to correlated errors. For example, in the Rydberg gates shown in FIG. 2B, a target qubit can only incur a BBR error if the control qubits were all in the |0 [symbol] state. Thus, for the C^{a}Z^{b} gates shown in FIG. 2B, the possible correlated errors may involve one of the Kraus maps M_{r′} or M₀ occurring on one of the qubits, together with Z-type errors on some or all of the remaining qubits involved in that gate.

The rate of BBR transitions from a given Rydberg state nL to another specific state n′L′ can be calculated from the Planck distribution of photons at the given temperature T and the Einstein coefficient for the corresponding transition. For ⁸⁷Rb atoms excited to the 70S Rydberg state, there are four dominant final states associated to these BBR errors; these are illustrated in FIG. 1C. The total rate of BBR transitions summed over all possible final states is given in Equation 3.

$${Γ}_{BBR = \frac{4 {k}_{B} T}{3 {c}^{3} {n}_{eff}^{2}}} \qquad Equation 3$$

In Equation 3, k_{B} is Boltzmann's constant, c is the speed of light, and n_{eff} is the effective principal quantum number of the Rydberg state which determines its energy: E_{nL}∝−1/(2n_{eff}²). The overall rate of BBR transitions can be suppressed by operating at higher n_{eff} or operating at cryogenic temperatures.

### Error Modeling for RD Transitions

The spontaneous emission events corresponding to RD transitions can be modeled as quantum jumps involving the emission of an optical-wavelength photon. Unlike BBR, however, the resulting state will be a low-lying P state, which will quickly decay back into the ground state manifold. For the stretched Rydberg state of ⁸⁷Rb, the RD transitions are almost entirely two- or four-photon decay processes to one of the five states in the ground state manifold indicated in FIG. 1C. For the purpose of QEC, separately consider the cases of decay into the qubit |1 [symbol] state and decay into one of the other ground state sub-levels. Because the spontaneous emission event can occur anytime during the Rydberg laser pulse, the first type of decay can result in a final state which is a superposition of |1 [symbol] and |r [symbol] . Upon averaging over all possible decay times during the entire pulse, one finds that these errors can be modeled using a combination of Z-type errors and leakage into the |r [symbol] state, with the Kraus operators

M₀=|r [symbol] [symbol] |+α|1 [symbol] [symbol] 1|+β|0 [symbol] [symbol] 0|, Mᵣ∝|r [symbol] [symbol] 1|, M₁∝|1 [symbol] [symbol] 1|, M₂∝|0 [symbol] [symbol] 0|. Equation 4
where α, β, and the proportionality constants depend on the probability for the atom to incur an RD transition to the |1 [symbol] state and the specific Rydberg pulse being performed.

At the same time, decay to one of the other ground state sublevels shown in FIG. 1C leads to leakage out of the computational subspace as in the traditional QEC setting (without influencing Rydberg operations on neighboring atoms). That is, for each hyperfine state |f|1 [symbol] ≠|1 [symbol] , there is a Kraus operator

M_{f}∝|f [symbol] [symbol] 1| Equation 5
where the proportionality constant depends on the probability for an RD transition and the branching ratio from |r [symbol] to the specific state |f [symbol] . Note that due to dipole selection rules, the number of RD channels with non-negligible final state probability is minimized by choosing to couple the |1 [symbol] state to a so-called stretched Rydberg state for entangling gates. If, for example, one had instead chosen a Rydberg state with m_{J}+m_{I}=0, there would be several additional final states in each case. In particular, in this analysis, the decay into the qubit |0 [symbol] state is negligible to leading order. Such an event, corresponding to the Kraus operator M∝|0 [symbol] [symbol] 1| (or equivalently, Pauli-X and Y errors), is considered below.

As in the BBR case, the absence of quantum jumps results in the atom's population being shifted toward the |0 [symbol] state, which can be modeled using Pauli-Z errors. RD errors can also give rise to correlated errors when they occur during the primitive entangling gates illustrated in FIG. 2B. For example, target qubit Rydberg pulses may become resonant if a control qubit incurs an RD transition. In this case, possible correlated errors may involve one of the aforementioned Kraus maps occurring on one of the qubits, together with Pauli-Z and/or |r [symbol] [symbol] 1| errors on some or all of the remaining qubits involved in that gate.

While as noted above, the rate of BBR transitions depends upon the temperature T and n_{eff}, the total RD rate is temperature-independent. Due to reduced overlap between the atomic orbitals, it scales as Γ₀˜1/n_{eff}³. Comparing this with the scaling for the BBR decay rate, while both error rates decrease for larger n, BBR processes dominate for large n, and RD processes dominate for smaller n or very low T.

Errors from Intermediate State Scattering

When multi-photon excitation is used to couple the |1 [symbol] state to the Rydberg state, scattering from an intermediate state can give rise to another important intrinsic source of error. By using σ⁺-polarized light in the first step of the excitation and choosing the intermediate state to be a P_{3/2} state with the lowest possible n, the intermediate state scattering channels form a subset of the RD channels—they can only result in decay 112 into the qubit |1 [symbol] state or two other hyperfine ground states, as shown in FIG. 1C. If an intermediate state with higher n is used, such as 6P_{3/2}, this is still true to leading order; however, a (highly improbable) four-photon process could potentially lead to mixing between the qubit states |1 [symbol] and |0 [symbol] . Thus, whenever intermediate state scattering is not explicitly mentioned in the following sections, it is assumed that it has been incorporated with RD errors. This error rate can be suppressed by increasing intermediate laser detuning in the multi-photon transition, while also increasing laser power.

### Experimental Imperfections

While BBR, RD, and intermediate state scattering processes constitute the dominant errors for Rydberg-mediated collective gates, it is also important to consider other types of error, such as technical imperfections in the experimental setup. The most significant errors of this kind are atom loss and fluctuations in laser phase, intensity, and frequency. The Rydberg laser fluctuations can all be modeled using Pauli-Z errors and leakage into the |r [symbol] state, so these errors can be addressed together with the other errors discussed above. Finite atomic temperature, resulting in velocity spread and Doppler broadening on the Rydberg transition, likewise leads to Pauli-Z errors and leakage into the |r [symbol] state. Temperature-induced positional spread causes similar errors, and due to the robustness of the blockade-based gate, these errors can even be rendered negligible with sufficiently large interaction strengths. On the other hand, atom loss forms a more complicated version of a leakage error (called erasure in the quantum information literature). However, as discussed below, it is shown that such errors can also be addressed efficiently in the present framework. In certain cases, the special properties of these errors can be further leveraged to improve QEC efficiency.

Experimental imperfections can also affect the hyperfine qubits used for storing quantum information and performing single-qubit gates. However, these primarily result in Pauli-Z errors and leakage to other hyperfine states, which group together with the error types described above. Moreover, these tend to be significantly smaller sources of error than for the two-qubit gates. Choosing a magnetically insensitive transition for the qubit states eliminates the leading order errors arising from magnetic field fluctuations. However, Z-type dephasing errors can still arise from the differential light shift from the optical trap. Finite atomic temperature, fluctuating tweezer power, and atom heating can thus cause dephasing, although these can be alleviated to achieve qubit coherence times T₂ of about 1 second by applying standard dynamical decoupling sequences. Leakage to other hyperfine m_{F} states can also occur due to Raman scattering from the tweezer light, but these effects can be greatly suppressed to timescales greater than 10 seconds by sufficiently detuning the tweezer light. Since the qubit states are separated by Δm_{F}=2 (a nuclear-spin-flip transition), bit-flip X and Y error rates from tweezer-induced scattering are even smaller. Finally, temperature-induced Doppler effects which could in principle result in Z-type errors, are negligible since the qubit transition is of microwave-frequency, and microwave phase stability can be exceptional on the Raman laser used for single-qubit manipulations.

At the same time, as noted above, certain experimental imperfections associated with the hyperfine rotations are not directly corrected with the protocol provided herein, but can be minimized or suppressed via other mechanisms, such as composite pulse sequences. For example, the primary source of single-qubit gate errors in recent experiments involves laser amplitude drifts or pulse miscalibrations, which can result in X, Y, and Z-type errors. However, these coherent errors can be significantly suppressed by using composite pulse sequences. In particular, the BB1 pulse sequence suppresses pulse amplitude errors to sixth order. On the other hand, the error rates associated with phase noise in single-qubit gates are typically much smaller: for example, the phase noise in ¹⁷¹Yb⁺ hyperfine qubits has been shown to limit coherence to an order of 5,000 seconds. Although other sources of frequency fluctuations result in a T₂* of approximately 4 ms for the Rb qubit, thereby inducing pulse frequency errors, these errors are strongly suppressed to second-order due to the MHz-scale Raman Rabi frequencies, and they can be further suppressed with improved cooling and microwave source stability. Furthermore, they can be made completely negligible by using appropriate composite pulse sequences. Finally, incoherent scattering from the Raman beams used for single-qubit rotations can also cause leakage and X-, and Y-type errors, which can be on the 10⁻⁵ level for the far-detuned Raman beams used for electron-spin-flip transitions, but may be higher for nuclear-spin-flip transitions as used for the qubit states here. These remaining hyperfine qubit error rates are significantly smaller than the primary sources of error considered, and they can be further corrected via concatenation of additional error correction codes.

### Summary of Error Channels

It is shown herein that the multi-level nature of neutral atoms gives rise to various complexities in the error model, including a large number of decay channels and the possibility for Rydberg leakage errors to influence many future operations, resulting in high-weight correlated errors. Despite these complications, one important feature of the error model provided herein makes it substantially simpler than the set of all Pauli errors studied in more generic setups-no Pauli-X or Y-type errors are introduced during the Rydberg gates. Indeed, in the following sections, it is shown how all the additional leakage errors and correlated errors in the error model can be converted into Z-type errors, and this is used to design FTQC protocols with substantially reduced resource costs.

FTQC with the Seven-Qubit Steane Code

Having established the error model for the Rydberg operations, fault-tolerant schemes to detect and correct these errors and perform a universal set of logical operations are provided. The key concept for this construction is the ability to convert all errors described in the previous section into Pauli-Z type errors by introducing ancilla qubits and using the blockade effect, dipole selection rules, and optical pumping (see FIG. 1C). The protocol when only BBR errors are significant (in the limit of higher Rydberg principal quantum number n) is described first, as the error model and QEC mechanisms are simpler to understand in this case. The universal gate set developed herein comprises a logical Hadamard gate and a logical controlled-controlled-phase (CCZ) or Toffoli gate. The more general case involving both BBR and RD errors is described. Subsequently, the resource cost of these protocols is compared against other fault-tolerant computation schemes and considerations for scalable computation are discussed. The final scheme presented in the following section is referred to as Ryd-7. Throughout this section, qubits encoded in ⁸⁷Rb are used as a concrete example to illustrate the protocols.

While various equivalent definitions of FTQC have been given in the literature for traditional error models, to accommodate the possibility of Rydberg leakage errors—that is, any Rydberg population remaining after the gate operation—the following stricter one must be applied:

A distance-d QEC code is fault-tolerant if after any round of error detection and correction, to order (pₜₒₜ)^{t}, at most t single-qubit Pauli errors are present, where

$$t = ⌊ \frac{d - 1}{2} ⌋$$

and pₜₒₜ is the sum of all error probabilities. In addition, no Rydberg population can be present after any round of error detection and correction.

The final requirement is important because any remnant Rydberg population could blockade future Rydberg gates.

In the following, the case of code distance d=3 and

$${p}_{tot} ∼ O ( \frac{{Γ}_{BBR} + {Γ}_{0}}{Ω} )$$

is examined. The QEC has the following properties: to leading order in pₜₒₜ,
1. Code states can be prepared with at most a single physical qubit error, without leaving any final Rydberg state population.
2. After each round of error detection and correction, there is at most a single physical qubit error per logical qubit, and there is no Rydberg state population.
3. Each logical gate introduces at most a single physical qubit error per involved logical qubit, without leaving any final Rydberg state population.

It is straightforward to show that any distance-3 code satisfying the above properties is fault-tolerant.

Below, the term data qubit is used to refer to physical qubits used to encode a logical qubit, and ancilla qubit is used to refer to physical qubits which are used to perform stabilizer measurements or detect errors.

FTQC with BBR Errors

### 1. Qubit Encoding

The quantum code in this example is based on the seven-qubit Steane code, which uses a logical state encoding derived from classical binary Hamming codes:

$${\vert 0 〉}_{L} = \frac{1}{2 \sqrt{2}} ( \vert 0000000 〉 + \vert 1010101 〉 + \vert 0110011 〉 + \vert 1100110 〉 + \vert 0001111 〉 + \vert 1011010 〉 + \vert 0111100 〉 + \vert 1101001 〉 ) \qquad Equation 6$$

$${\vert 1 〉}_{L} = \frac{1}{2 \sqrt{2}} ( \vert 1111111 〉 + \vert 0101010 〉 + \vert 1001100 〉 + \vert 0011001 〉 + \vert 1110000 〉 + \vert 0100101 〉 + \vert 1000011 〉 + \vert 0010110 〉 ) \qquad Equation 7$$

The stabilizer operators for this code are

g₁=IIIXXXX g₂=IXXIIXX g₃=XIXIXIX g₄=IIIZZZZ g₅=IZZIIZZ g₆=ZIZIZIZ Equation 8

In Equation 8 and the rest of the manuscript when appropriate, tensor product symbols and qubit indices are omitted, and it is assumed that the j^{th} operator in each product acts on qubit j. Measurements of the stabilizers g₁, . . . , g₆ allow for unique identification and correction of single-qubit X and Z errors. For instance, the absence of any error corresponds to all stabilizers gⱼ=+1, and a Z error on the first qubit would be detected by g₃=−1 and gⱼ=+1 for all j≠3. The error can then be corrected via an appropriate single-qubit gate.

### 2. Error Detection and Correction

To fault-tolerantly detect and correct for the errors associated with BBR events, one must be able to address both Rydberg leakage and Pauli-Z errors. For the former case, even though leakage errors in traditional QEC settings can be particularly difficult to detect and correct, the particular form of leakage caused by BBR errors make them much easier to identify-one can use an ancilla and the blockade effect to detect the leaked Rydberg population. Specifically, a nearby ancilla qubit is prepared in the state

$$\vert + 〉 = \frac{1}{\sqrt{2}} ( \vert 0 〉 + \vert 1 〉 )$$

and a 2π Rydberg pulse is applied to detect whether there is another Rydberg atom within the blockade radius. Due to the blockade effect, the ancilla will be in the |+ [symbol] (respectively, |− [symbol] ) state if a nearby Rydberg population is (is not) present.

Once detected, such errors can be converted to atom loss errors or Z-type errors. Conversion of the error to an atom loss error leverages the fact that the Rydberg atom naturally expels itself due to the anti-trapping potential of the tweezer, and can also be directly ejected in about 100 ns by pulsing a weak, ionizing electric field (about 10 V/cm), which removes the ion and electron. The exact location of the ejected atom can be determined by following the atom loss protocol outlined below; subsequently, the error can be corrected by replacing the ejected atom with a fresh atom prepared in the |1 [symbol] state (thereby converting it to a Z-type error), and applying another round of QEC. To reduce the need for applying the atom loss protocol, one could add a preventative step after every entangling gate, which incoherently re-pumps any remnant population in several most probable Rydberg states into the qubit |1 [symbol] , state. This procedure, along with more details on the conversion of Rydberg population errors, is further described below.

For fault-tolerant error detection and correction, it is important to note that the ancilla used to probe for Rydberg population may also incur a BBR error. This can be resolved by repeating the detection protocol upon finding a BBR error and also using a multi-step measurement procedure for the ancilla qubit. Such a protocol will be assumed below when using an ancilla to detect for Rydberg population.

To fault-tolerantly detect and correct for Pauli errors, the stabilizers are measured in a manner robust against errors that may occur during the detection procedure. The stabilizers for this seven-qubit code are either products of Pauli-X operators or products of Pauli-Z operators, since the Steane code is a CSS code. A non-fault-tolerant way to measure a product of four Pauli-X operators (stabilizers g₁, g₂, or g₃) uses four controlled-phase gates conjugated by Hadamards (FIG. 1B). Since Rydberg gate errors can occur during this protocol, a second ancilla qubit is used to detect for BBR errors after each entangling operation and convert them to Z-type errors when detected.

The Z errors that occur during a Rydberg gate (or result from conversion of a BBR error) commute with the remaining CZ operations. Thus, the only errors that can occur during a round of stabilizer measurements, to first order in pₜₒₜ, consist of a Pauli error acting on the ancilla and a Pauli error on one of the data qubits (FIG. 1B). By resetting the ancilla and repeating the measurement protocol when a −1 measurement outcome is obtained, the effect of the error on the ancilla qubit can be eliminated. An analogous method can be used for the Z stabilizers.

In this way, after each round of stabilizer measurements, the correct stabilizer eigenvalues can be obtained to leading order in pₜₒₜ, while introducing at most one physical qubit X or Z error.

While the above description has presented the fault-tolerant stabilizer measurement protocol in the simplest form where Rydberg state detection is performed after every physical gate, this is in fact not necessary. Indeed, if one postpones all such detection operations to the end of a circuit which measures the stabilizer X_{α}X_{β}X_{γ}X_{δ} (where Rydberg gates are applied to data atoms in the order α, β, γ, δ), the only possible correlated errors that can arise are X_{β}X_{γ}X_{δ}, X_{γ}X_{δ}, or X_{δ}, corresponding to BBR transitions on data atoms β, γ, or δ, respectively. For the stabilizers of Equation 8, these errors will all give rise to distinct error syndromes upon measuring Z^{⊗4} stabilizers and can thus be corrected. This can substantially reduce the number of measurements required to implement this protocol, making it more feasible for near-term experiments. A similar procedure can be applied to measure the Z^{⊗4} stabilizers.

### 3. Logical Operations

Logical Hadamard, Paulis, and S gate. One particular advantage of the Steane code is the transversality of the logical Hadamard, Pauli, and S=diag(1, i) gates. Specifically, the logical Hadamard simply consists of a Hadamard on each physical qubit:

H_{L}=⊗ⱼ₌₁⁷Hⱼ Equation 9

These operations can be performed without ever populating the Rydberg state, and hence without introducing Rydberg gate errors. Similar decompositions exist for the S gate and the Pauli gates X, Y, and Z.

Logical controlled-phase gate. The controlled-phase gate in the Steane code is also transversal:

$${CZ}_{AB} = {{⊗}^{7}}_{{j}_{A} = {j}_{B} = 1} CZ ( {j}_{A} , {j}_{B} ) \qquad Equation 10$$

One can thus implement a logical controlled-phase operation by performing only seven physical controlled-phase operations and probing for BBR errors in between each physical controlled-phase gate (to convert them to Z-type errors). This eliminates the possibility of correlated multi-qubit errors within a single logical qubit.

Logical Toffoli gate. To implement the Toffoli gate fault-tolerantly and complete the universal gate set, the logical CCZ gate is implemented where the target qubit has been conjugated by Hadamard gates. While this gate is not transversal in the Steane code, it may still be decomposed into a product of physical CCZ gates in a round-robin fashion:

$${CCZ}_{ABC} = {\prod }_{{j}_{A} , {k}_{B} , {l}_{C} ∈ \{ 1 , 2 , 3 \}} {CCZ}_{( {j}_{A} , {k}_{B} , {l}_{C} )} \qquad Equation 11$$

so that a logical CCZ operation can be implemented using 27 physical CCZ operations. In the Rydberg setup, this is implemented with the three-qubit Rydberg gate R(j_{A}, k_{B}; l_{C})=diag(1, −1, −1, −1, −1, −1, −1, −1) and conjugating all involved data qubits by Pauli-X. To avoid propagation of correlated errors resulting from an input X error which does not commute with these Rydberg gates, one begins by fault-tolerantly measuring all the Z^{⊗4} stabilizers, and correcting any detected errors. This protocol can only result in single-qubit Z errors. This can also be achieved in a more resource-efficient manner by requiring that the stabilizer measurements immediately preceding every logical CCZ gate be done in a way which measures all Z^{⊗4} stabilizers last. Furthermore, Rydberg population detection (followed by conversion to Z-type errors, if necessary) is performed after every Rydberg gate, but stabilizers do not need to be measured until the very end; this is because only Z errors occur during the gate operations. In this way, the logical CCZ satisfies the fault-tolerance property.

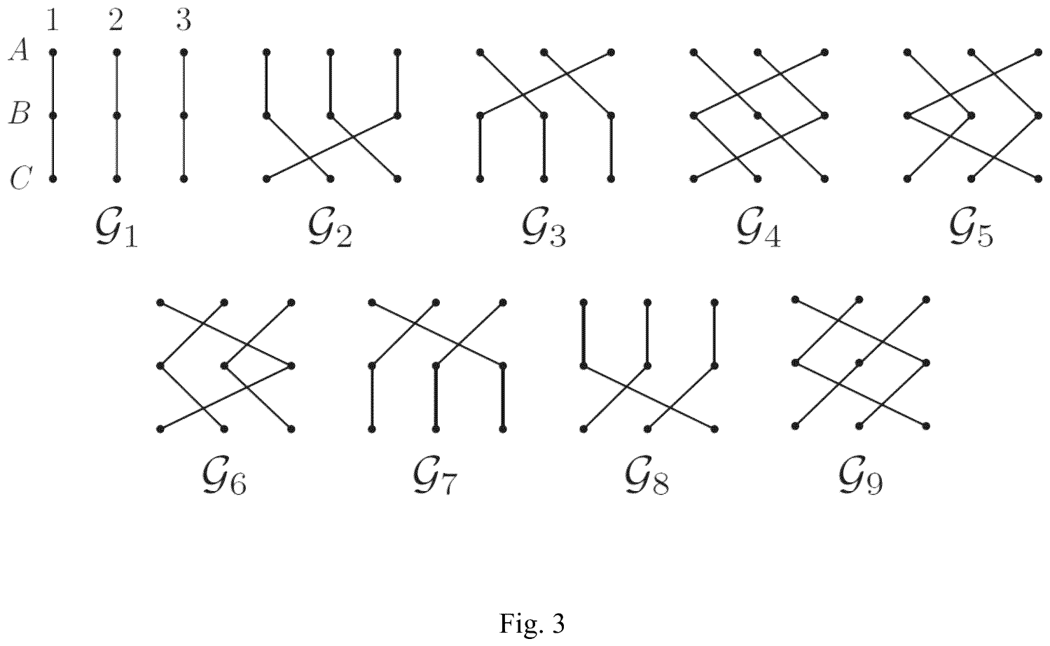

Referring to FIG. 3, the reordering of physical gates in performing the logical CCZ operation is illustrated. For each logical qubit, only the first three data qubits are shown, since the other data qubits are not involved in the logical gate. Within each group [symbol] ᵢ, the Rydberg gates R(a, b; c) are ordered by increasing index of the physical control qubit a (the data qubit of A involved in the gate).

Although the physical implementation of the CCZ gate is not transversal, the physical gates may be reordered as they all commute with each other. In doing so, one can eliminate some but not all of the intermediate Rydberg population detection steps, to reduce the total number of measurement operations as was done for the fault-tolerant stabilizer measurements. Specifically, the three-qubit physical Rydberg gates of the protocol are grouped into nine groups of three, [symbol] ₁, . . . , [symbol] ₉ so that each physical qubit j_{A}, k_{B}, l_{C}∈{1,2,3} is used in every group. One example of such a grouping [symbol] ₁, . . . , [symbol] ₉ is shown in FIG. 3. With this reordering, detection for Rydberg leakage only needs to be performed after each group [symbol] ₁. This is because a Rydberg leakage error can only result in the blockading of the last two, the last, or no Rydberg gates within a group [symbol] ᵢ, and these cases correspond to disjoint possible sets of stabilizer eigenvalues (g₂, g₃) for the three logical qubits.

The Hadamard and CCZ gates together form a universal gate set for quantum computation, and therefore a scheme to construct any quantum operation on the code space fault-tolerantly against BBR errors is demonstrated herein.

### 4. Logical State Preparation

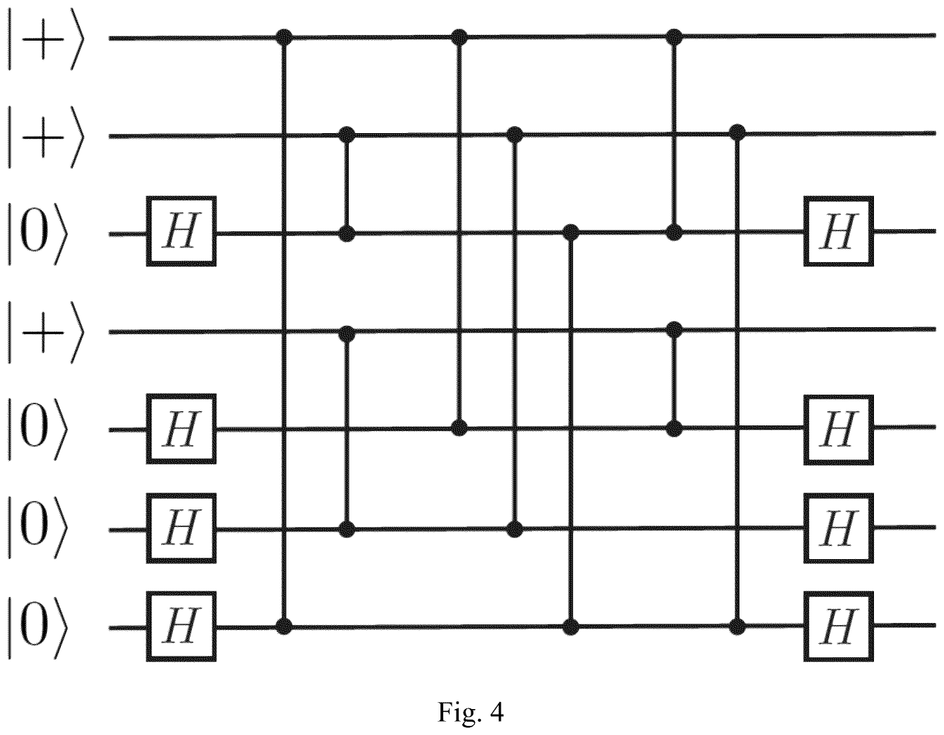

Referring to FIG. 4, a protocol to prepare the logical |0 [symbol] _{L} state for the Steane code is illustrated.

Finally, one can prepare the logical |0 [symbol] _{L} state in a fault-tolerant manner. The most straightforward preparation of this state uses Steane's Latin rectangle encoding method, whose circuit is shown in FIG. 4. In the Rydberg setup, controlled-NOT gates are replaced by Rydberg controlled-phase gates with target qubit conjugated by Hadamard gates. Because the Z errors associated with Rydberg gates commute with controlled-phase operations, to leading order in pₜₒₜ, there will be at most one Pauli-Z error among the three data qubits initially in the |+ [symbol] state, and at most one Pauli-X error among the four data qubits initially in the |0 [symbol] state. Although this could be a two-qubit error, it is correctable because the Steane code identifies and corrects X and Z errors separately. In this procedure, it is assumed that the Rydberg population arising from BBR errors is detected after each physical entangling gate and these errors are converted to Z errors as necessary. In this way, by applying one round of stabilizer measurements and error correction, one obtains (to leading order in pₜₒₜ) a logical |0ϵ_{L} state with a Pauli error on at most one physical qubit.

FTQC with BBR and RD Errors

To address RD errors and intermediate state scattering, one must consider two new classes of leakage errors: (1) leakage into the original Rydberg state |rϵ and (2) leakage into the other hyperfine ground states, which will also be called non-Rydberg leakage herein. The first class of errors is similar to the quantum jumps in the BBR error model, and can be detected and corrected in the same way using an ancilla qubit. In the following sections, this error will be grouped together with BBR errors and collectively referred to as Rydberg leakage errors.

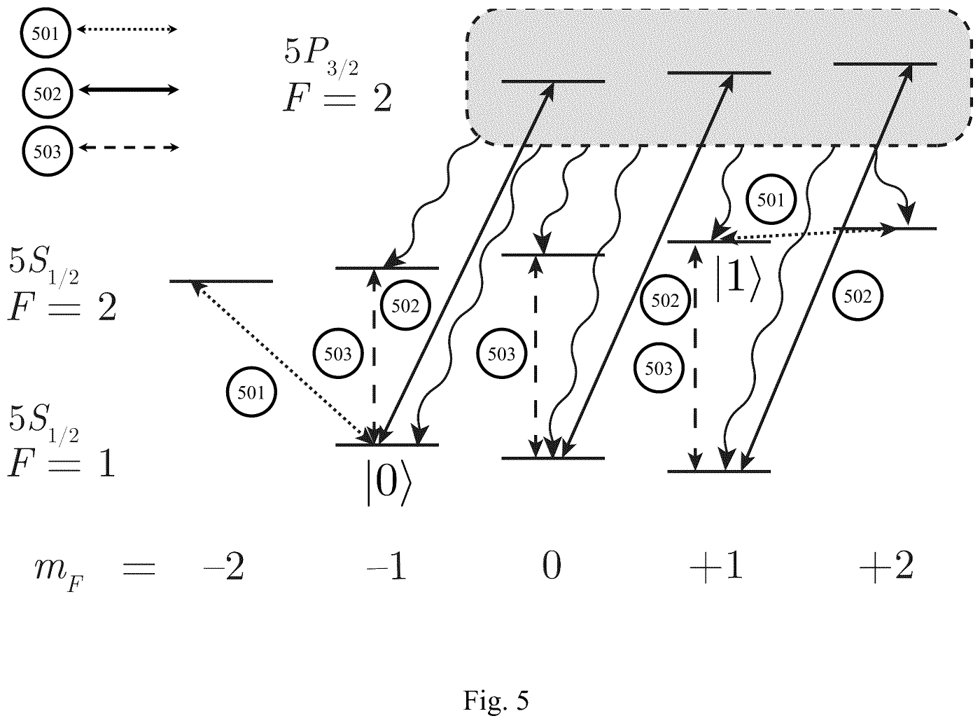

Referring to FIG. 5, the optical pumping protocol to convert non-Rydberg leakage errors to Pauli-Z errors in a ⁸⁷Rb atom is illustrated. First, one applies π pulses |1 [symbol] ↔|F=2, m_{F}=2 [symbol] and |0 [symbol] ↔|F=2, m_{F}=−2 [symbol] (501, dotted lines). In the second step, one uses σ⁺ light to excite states in the F=1 ground state manifold to the 5P_{3/2} F=2 manifold (502, solid lines). These states decay quickly back into the ground state manifold, as indicated by wavy arrows. Thirdly, one applies resonant it pulses |F=2, m_{F} [symbol] ↔|F=1, m_{F} [symbol] (503, dashed lines). The second and third steps are repeated until all population with m_{F}≥−1 has been transferred to the stretched state |F=2, m_{F}=2). Finally, the first step (501) is repeated to restore the qubit state populations.

As demonstrated above, leakage to other states in the hyperfine manifold can be converted into Pauli-Z type errors using optical pumping, for example, for ⁸⁷Rb, by using the novel optical pumping protocol shown in FIG. 5. One crucial property of this optical pumping procedure is that it does not affect the qubit coherence when there is no error.

Furthermore, notice that while leakage in traditional QEC settings may be particularly difficult to address, requiring additional entangling gates or ancilla qubits, the particular multi level structure of neutral atoms allows for efficient correction of these errors. Notably, this optical pumping can be performed without the need for qubit measurement and feed-forward corrections, allowing for efficient implementation in experiments.

The correction of non-Rydberg leakage errors can be incorporated into the fault-tolerant protocols of the previous section by performing this procedure between the Rydberg entangling gates. Thus, the protocols from the previous section will be fault-tolerant against generic intrinsic Rydberg decay errors. Furthermore, note that when considering this full error model including both BBR and RD events, it is no longer necessary to swap population between the |1 [symbol] state and the stretched ground state

$$\vert F = I + \frac{1}{2} , {m}_{F} = I + \frac{1}{2} 〉$$

when addressing Rydberg leakage errors; instead, the Rydberg population can be pumped directly to the

$$\vert F = I + \frac{1}{2} , {m}_{F} = I + \frac{1}{2} 〉$$

state, converting it into a non-Rydberg leakage error which is corrected by optical pumping. The full protocols for fault-tolerant stabilizer measurement, the logical controlled-phase gate, and the logical CCZ gate are given in Algorithms 1-3.

Algorithm 1: Fault-tolerant method to measure X^{⊗4} stabilizers for Rydberg 7-qubit code.
1. For each X^{⊗4} stabilizer X_{α} X_{β} X_{γ} X_{δ}:
   a. Initialize ancilla qubit A₂ to |+ [symbol] state.
   b. Apply gate Zⱼ Hⱼ to all data qubits j∈{α, β, γ, δ}.
   c. For each j∈{α, β, γ, δ}, apply the Rydberg gate R (A₁; Dⱼ). If j=δ, use ancilla qubit A₁ to detect for Rydberg population; if a Rydberg leakage error is detected, convert it to a non-Rydberg leakage error

$$\vert F = I + \frac{1}{2} , {m}_{F} = I + \frac{1}{2} 〉 〈 1 \vert .$$

Finally, use the optical pumping technique described herein to convert any possible non-Rydberg leakage error into a possible single-qubit Z error.
d. Apply Hadamard gates to all data qubits j∈{α, β, γ, δ}.
e. Measure A₂ in the X basis.
f. If A₂ measurement yields −1, break.
2. If any stabilizers are measured to be −1:
   a. Measure all X^{⊗4} stabilizers again, this time in the unprotected way and without checking for leakage. There was either already an error in the input, or an error occurred in the initial measurement process. The resulting outcomes will then be the correct stabilizer values to leading order in pₜₒₜ.

Algorithm 2: Fault-tolerant logical CZ for Rydberg 7-qubit code.
1. Apply single-qubit Z gates to all physical control and target qubits.
2. For each j=1, 2, . . . , 7:
   a. Apply the two-qubit Rydberg gate R(Cⱼ; Tⱼ).
   b. Use ancilla qubit A₁ to detect for Rydberg population.
   c. If a Rydberg leakage error is detected, convert it to a non-Rydberg leakage error

$$\vert F = I + \frac{1}{2} , {m}_{F} = I + \frac{1}{2} 〉 〈 1 \vert .$$

3. Use the optical pumping techniques described herein to convert any possible non-Rydberg leakage error into a possible single-qubit Z error.

Algorithm 3: Fault-tolerant logical CCZ_{ABC} for Rydberg 7-qubit code.
1. Apply X gate to all physical qubits j_{A}, k_{B}, l_{C}∈{1,2,3}.
2. For each group [symbol] ᵢ of physical three-qubit Rydberg gates to apply (where [symbol] ᵢ are ordered as discussed herein):
   a. Apply gates in [symbol] ᵢ.
   b. Use ancilla qubit A₁ to detect for Rydberg population. If Rydberg leakage is detected:
      i. Convert this leakage error to a possible single-qubit X error.
      ii. Measure stabilizer eigenvalues g₂ and g₃ for each logical qubit in an unprotected way. This is safe because an error already occurred.
   iii. Apply the appropriate correction circuit for the correlated error (since the possible correlated errors all result in disjoint sets of possible syndromes).
   iv. Measure Z^{⊗4} stabilizers for all logical qubits in an unprotected way to detect for a possible single-qubit X error induced by step i) above; correct this error if found.
   v. The remaining three-qubit Rydberg gates needed to implement the logical CCZ operation can all be applied in an unprotected way.
c. Use the optical pumping techniques described herein to convert any possible non-Rydberg leakage error into a possible single-qubit Z error.
   3. Apply X gate to all physical qubits j_{A}, k_{B}, l_{C}∈{1,2,3}.

While the above discussion has focused on intrinsic RD errors, the non-intrinsic errors described above as “Experimental Imperfections” can also be incorporated into these FTQC protocols. Specifically, the errors resulting from Rydberg laser imperfections such as intensity and phase fluctuations only cause Pauli-Z errors and single-qubit Rydberg leakage errors, so they are already addressed within the current framework. Similarly, atom loss can be detected by using an ancilla qubit and performing a small leakage detection circuit. In this case, if a reservoir of atoms is available, the atom loss error can be converted into a single-qubit Pauli-X or Z error, for instance, by replacing the lost atom with a new atom initialized into the |0 [symbol] state.

Comparison to Alternative Fault-Tolerant Quantum Computing Protocols

To demonstrate the significance of the Ryd-7 FTQC protocol provided herein and emphasize the importance of considering specific error models when designing QEC approaches, the model provided herein is compared below with alternative general-purpose FTQC schemes. Specifically, one can compare the costs of measuring stabilizers and implementing fault-tolerant logical operations, using as metrics the number of two- and three-qubit entangling operations required for the physical qubits, and the minimum number of ancilla qubits needed. Details on how these numbers can be obtained for the Ryd-7 protocol are provided below.

Table 1 compares the minimum number of two-qubit gates and ancilla qubits required for fault-tolerant stabilizer measurement (and associated error correction) in various QEC proposals. The results for general-purpose FTQC protocols for the 7- and 15-qubit CSS/Hamming codes are based on flagged syndrome extraction procedures. For each protocol, the resource cost for cases without any errors is presented separately from the worst-case cost when an error is present (numbers in parentheses), as the former case is typically much more probable. While the number of ancilla qubits required is the same for all cases, one finds that the protocol provided herein requires the smallest number of entangling operations in either case even though one must detect for leakage, an additional kind of error not considered in alternative approaches.

Similarly, Table 2 demonstrates this comparison for the fault-tolerant logical CCZ gate, where the improvements are striking. The general-purpose implementation of this non-Clifford gate for three logical qubits in the 7-qubit Steane code is given by Yoder; while this implementation requires only a modest number of physical two- and three-qubit gates, it requires a considerable overhead of 72 additional ancilla qubits, making an experimental demonstration very challenging. On the other hand, while Chao's proposal for a fault-tolerant Toffoli gate using the [[15,7,3]] code significantly reduces the ancilla qubit count, the number of physical entangling operations is substantial. The protocol provided herein uses only 2 ancilla qubits compared with 72 required in Yoder, while using significantly fewer entangling operations (e.g., ˜60 two-qubit gates) than Chao (1416 two-qubit gates) even in the unlikely scenario where one must correct for an error. While the protocol provided herein does use more three-qubit entangling gates than Yoder, such gates are nearly as straightforward to implement as two-qubit CZ gates in the Rydberg atom setup.

These results clearly demonstrate the advantage of considering a hardware-specific error model and leveraging the unique capabilities of the Rydberg setup when designing FTQC schemes. In particular, even though one must correct for additional errors not considered in traditional settings, one can still dramatically reduce the required number of entangling gates or ancilla qubits.

### Scalable Implementation

Additional details are described below regarding the scalable implementation of the protocols provided herein, including potential geometrical layouts of physical qubits, resource trade-offs, and residual error rates.

Geometrical considerations. One particular advantage of the Rydberg atom platform is the flexibility in allowing arbitrary geometrical arrangements of atoms. Motivated by experimental demonstrations of near-deterministic loading and rearrangement of neutral atoms into regular lattice structures, scalable FTQC architectures in which logical qubits form a coarser lattice on top of the lattice of physical atoms are provided herein. For the Ryd-7 scheme, one natural layout in a two-dimensional atomic array setup could comprise placing physical atoms on the vertices of a triangular lattice (FIG. 1A). In this geometry, the hexagonally shaped logical qubits (dotted hexagons, 103) form a coarser triangular lattice, with ancilla qubits (A, 102) placed on the edges of this coarser lattice to mediate error correction and logical gates. Fault-tolerant universal quantum computation can be performed if nearest-neighbor logical qubits can be entangled; because physical entangling gates can only be implemented between atoms within a blockade radius R_{B}, this defines a minimum required value of R_{B} in terms of the closest atom-atom separation d. Upon examining the physical gates required to implement the logical operations for the seven-qubit code, one finds that the requirement in this case is R_{B}>3 d (dotted grey line, 104). This requirement on R_{B} can be further reduced if atoms can be moved in between certain logical operations while preserving coherence between the hyperfine ground states.

Resource tradeoffs. For any experiment, resource trade-offs may be made to minimize the total logical error probability. For instance, if the timescale of one round of measurements is much larger than typical gate times (as is the case in certain atomic setups), one may wish to reduce the number of measurement shots required at the expense of performing additional operations. This can be incorporated into the protocol provided herein by incoherently driving Rydberg states to the low-lying P state after each entangling gate to convert any possible Rydberg leakage error into the non-Rydberg leakage

$$\vert F = I + \frac{1}{2} , {m}_{F} = I + \frac{1}{2} 〉 〈 1 \vert .$$

In this case, ancilla measurements are no longer necessary to detect and correct for Rydberg leakage errors, but this incoherent pumping would be done after every gate, regardless of whether an error had actually occurred. Alternatively, the number of entangling gates can be further reduced at the cost of additional measurements.

Improvements. The FTQC protocol presented in this section relies upon selection rules which impose restrictions on the possible RD error channels. Specifically, to leading order in the error probability, the decay channel |0 [symbol] [symbol] 1| arising from RD was ignored. Given the low branching ratio (determined numerically to be on the order of 10⁻³ in ⁸⁷Rb, from the stretched Rydberg state to |0 [symbol] , this is already a reasonable assumption; however, several approaches can be taken to suppress the probability of such errors even further. First, this probability can be reduced by a factor of roughly 3 or 4 by employing a shelving procedure in which population in the |0 [symbol] state is swapped with the stretched ground state

$$\vert F = - {m}_{F} = I + \frac{1}{2} 〉$$

before and after each entangling gate, due to the lower branching ratio from |r [symbol] to this stretched state: To avoid errors arising from near-degenerate Rydberg transitions in this case, one would also transfer population in the |1 [symbol] state to |F=I−1/2, m_{F}=1 [symbol] to perform Rydberg excitation in this case, instead of exciting out of the F=I+1/2 manifold. Moreover, by utilizing higher magnetic fields to reduce the branching ratio for RD processes involving large |Δm_{F}|, or by using a species with higher nuclear spin (e.g., ⁸⁵Rb) where the shelving state can be further separated from the stretched Rydberg state, one can suppress the probability of such errors to even higher orders.

Leading-Order Fault-Tolerance with a Repetition Code

Given that all Rydberg errors can be converted to the Z-type, one may naturally ask whether the full seven-qubit Steane code is even necessary to detect and correct these errors; in particular, one may be tempted to simply use a three-qubit repetition code in the X basis to detect and correct Z-type errors. In such a code, the logical states are

|+ [symbol] _{L}=|+++

[symbol]

|− [symbol] _{L}=|−−− [symbol] Equation 12
and stabilizer operators are

g₁=X₁X₂, g₂=X₂X₃ Equation 13

However, direct application of such a repetition code for FTQC is challenging even with this biased noise model, as one must be able to implement every physical gate in the encoding, decoding, stabilizer measurement, and logical gate procedures without introducing Pauli-X or Y-type errors at any stage—that is, each gate must be implemented in a bias-preserving way.

This requirement can easily be satisfied for certain physical gates such as the Rydberg controlled-phase or collective gates (after all leakage errors are mapped to Pauli-Z type), but is much more difficult to fulfill for other gates. Specifically, measurement of the stabilizers of Equation 13 requires performing controlled-NOT (CNOT) gates as shown in FIG. 1E.

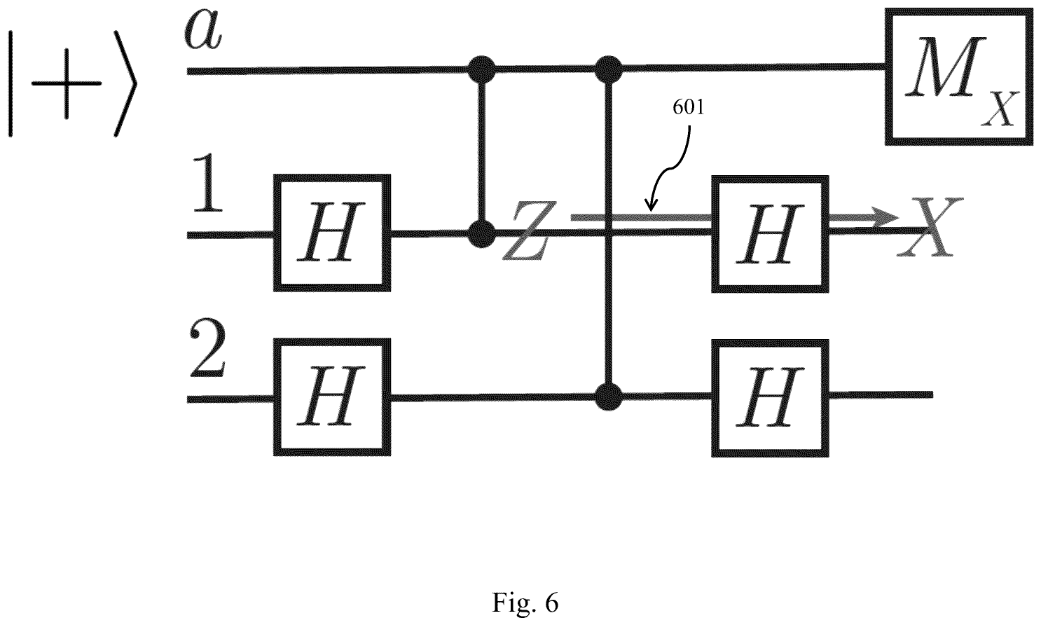

Referring to FIG. 6, a circuit to measure the stabilizer X₁ X₂ for the repetition code is provided. CNOT gates must be performed between the ancilla qubit and data qubits 1 and 2. A standard implementation of the CNOT gate using Rydberg controlled-phase gates conjugated by single-qubit Hadamard gates on the target qubits would not be bias-preserving, as a Z error on a target qubit during a controlled-phase gate would become an X error once the final Hadamard gate is applied (601).

In other setups, where a π-rotation of the target qubit about the x axis on the Bloch sphere can be performed conditioned on the state of the control qubit (e.g., by engineering a Hₜᵢₙₜ=ZX interaction), an over-rotation or under-rotation error would also translate to an X error and violate the bias-preserving constraint.

A bias-preserving CNOT gate is not possible between two qubits encoded in systems where the underlying Hilbert space is finite-dimensional, because the identity gate cannot be smoothly connected to CNOT while staying within the manifold of bias-preserving operations. In the setup provided herein, one circumvents the no-go theorem using the special fact that certain pulses in this finite-dimensional atomic system—the pulses between hyperfine states—can be implemented at very high fidelities, so that leading-order errors arise only from Rydberg pulse imperfections and Rydberg state decay. This allows one to develop a novel laser pulse sequence for entangling Rydberg atoms that directly implements a CNOT or Toffoli gate while preserving the noise bias.

The protocol provided herein can be applied on any atomic species with sufficiently high nuclear spin (I≥5/2). For concreteness, the protocol is illustrated using the example case of ⁸⁵Rb throughout the section.

### Bias Preserving CNOT in a Rydberg Atom Setup

Referring to FIG. 7, a pulse sequence for the target atom in a bias-preserving CNOT gate between ⁸⁵Rb atoms is illustrated. Rydberg pulses are resonant if and only if no nearby Rydberg population is present; otherwise, the Rydberg levels are shifted due to the blockade effect (dotted levels). This pulse sequence eliminates target atom X errors in the standard implementation of CNOT shown in FIG. 6.

Step 1: Coherent transfer of population from the qubit states to stretched Rydberg states

$$\vert {d}_{\pm } 〉 ≡ \vert {nD}_{\frac{3}{2}} , {m}_{J} = \frac{3}{2} , {m}_{I} = I = \frac{5}{2} 〉 .$$

To do this, first apply hyperfine π pulses |1 [symbol] ↔|F=2, m_{F}=2 [symbol] and |0 [symbol] ↔|F=3, m_{F}=−2), then apply Rydberg it pulses |F=2, m_{F}=2 [symbol] ↔|d₊ [symbol] , |F=3, m_{F}=−2 [symbol] ↔|d₋ [symbol] , and finally reapply the hyperfine it pulses |1 [symbol] ↔|F=2, m_{F}=2 [symbol] and |0)↔|F=3, m_{F}=−2 [symbol] (arrows 701, thin dashed). In some embodiments, the Rydberg pulses are performed using multi-photon transitions through the intermediate states

$$\vert {r}_{+} 〉 ≡ \vert {nS}_{\frac{1}{2}} , {m}_{J} = \frac{1}{2} , {m}_{I} = I = \frac{5}{2} 〉 and \vert {r}_{-} 〉 ≡ \vert {nS}_{\frac{1}{2}} , {m}_{J} = - \frac{1}{2} , {m}_{I} = - I = - \frac{5}{2} 〉 ,$$

respectively (not shown).

Step 2: Apply resonant it pulses from the qubit states to the Rydberg states

$$\vert 1 〉 ↔ \vert {nS}_{\frac{1}{2}} , {m}_{J} = \frac{1}{2} , {m}_{I} = \frac{3}{2} 〉 and \vert 0 〉 ↔ \vert {nS}_{\frac{1}{2}} , {m}_{J} = - \frac{1}{2} , {m}_{I} = - \frac{3}{2} 〉$$

(arrows 702, dotted).

Step 3: Apply a resonant it pulse between the |0 [symbol] and |1 [symbol] ground states (arrow 703, thick dashed).

Step 4: Repeat Step 701, but use −π instead of π pulses on all transitions (arrows 704, thin dashed).

Step 5: Incoherently drive any remaining Rydberg population into stretched ground states (arrows 705, solid). Specifically, send Rydberg states with m_{J}+m_{I}>0 (respectively, <0) to a stretched 5P state with F=m_{F}=I+3/2 (F=−m_{F}=I+3/2), which decays quickly and only to the stretched ground state with F=m_{F}=I+1/2 (F=−m_{F}=I+1/2).

Step 6: Use optical pumping techniques to map states outside the computational subspace with m_{F}>0 (respectively, m_{F}<0) to the qubit state |1 [symbol] (|0 [symbol] ) (arrows 706).

As shown in FIG. 6, the standard implementation of a CNOT gate in a Rydberg system is not bias-preserving. In particular, given the error model for Rydberg gates, X errors on the target qubit can be induced in two ways.

First, the target qubit could directly undergo a Rydberg error (e.g., radiative decay) during the controlled-phase gate, resulting in a Pauli-Z error that is transformed into an X error after the Hadamard gate (arrow 601 in FIG. 6).

Alternatively, the control atom could decay from the Rydberg state to the ground state at some point during the controlled-phase gate, so that the target qubit Rydberg pulses, which should have been blockaded, are now resonant during the controlled-phase gate. This results in a two-qubit correlated error between the control and target atoms, where the target atom undergoes an X-type error.

Here, one begins by introducing a novel entangling gate pulse sequence for Rydberg atoms to address the target atom X errors. In this discussion, one first assumes that the Rydberg pulses on the target atom are either all resonant or all blockaded; that is, one ignores the possibility of a neighboring Rydberg atom decaying during the target atom sequence. One then subsequently includes this effect and also eliminates the correlated errors by introducing an ancilla qubit and making use of two Rydberg states with different blockade radii.

To remove the target atom X errors, one wishes to design an entangling gate protocol which uses Rydberg states to conditionally swap |0 [symbol] and |1 [symbol] population directly, without the change-of-basis from Hadamard gates. This can be accomplished for atomic species with high enough nuclear spin (I≥5/2).

Consider qubits encoded in the ⁸⁵Rb clock states |1 [symbol] ≡|F=I+1/2, m_{F}=+1 [symbol] , |0≡|F=I−1/2, m_{F}=−1) (levels 707, 708, respectively, in FIG. 7), which have a magnetic field-insensitive transition frequency at low fields. The protocol then proceeds as illustrated in FIG. 7.

The first step of the procedure (arrows 701) aims to transfer population in the qubit state |1 [symbol] (respectively, |0 [symbol] to the Rydberg state

$$\vert {d}_{+} 〉 ≡ \vert {nD}_{\frac{3}{2}} , {m}_{J} = \frac{3}{2} , {m}_{I} = I = \frac{5}{2} 〉$$

(respectively,

$$\vert {d}_{-} 〉 ≡ \vert {nD}_{- \frac{3}{2}} , {m}_{J} = - \frac{1}{2} , {m}_{I} = I = - \frac{5}{2} 〉 )$$

conditionally, dependent on the state of a control atom. This is achieved because the Rydberg pulses from the qubit states to |d_{±} [symbol] are resonant if and only if there are no neighboring atoms in |r_{±} [symbol] or nearby Rydberg states. the Rabi frequency for each multi-photon Rydberg pulse is negligible when the intermediate states |r_{±} [symbol] are shifted in energy due to blockade interactions. Since each stretched Rydberg state predominantly decays only into ground states with |Δm_{F}|=|Δ(m_{J}+m_{I})|≤2 during RD processes, the |0 [symbol] and |1 [symbol] populations will not be mixed by Rydberg state decay; however, due to the possible decay channels |F=2, m_{F}=2 [symbol] [symbol] d₊| and |F=3, m_{F}=−2 [symbol] [symbol] d₋|, it is possible that the first step fails to excite the atom into a Rydberg state even in the absence of nearby Rydberg population. Consequently, in the second step, one again attempts to transfer the qubit states to Rydberg states, this time using resonant π pulses

$$\vert 1 〉 ↔ \vert {nS}_{\frac{1}{2}} , {m}_{J} = \frac{1}{2} , {m}_{I} = \frac{3}{2} 〉 and \vert 0 〉 ↔ \vert {nS}_{\frac{1}{2}} , {m}_{J} = - \frac{1}{2} , {m}_{I} = - \frac{3}{2} 〉 . \qquad ( arrows 702 )$$

Then, in the third step, the population in the qubit states is swapped via the π pulse |0 [symbol] ↔|1 [symbol] (arrow 703). This step only swaps population if nearby Rydberg atoms prevented transfer out of the qubit manifold in Steps 1 and 2. Step 4 then acts to invert the first step (arrows 704).

After Step 4, one finds that if no Rydberg errors have occurred, the atomic state is restored to the original qubit state (identity map) when no nearby Rydberg population is present, or to the opposite qubit state |0 [symbol] ↔|1 [symbol] otherwise. Rydberg errors can occur only if the pulses of Step 1 are resonant (if no nearby Rydberg atoms are present); moreover, because transitions from |d₊ [symbol] (respectively, |d₋ [symbol] ) only result in states with m_{F}>0 (m_{F}<0), any Pauli errors must be of Z-type (for example, projectors |0 [symbol] [symbol] 0|, |1 [symbol] [symbol] 1|), and any leakage error must be of the form |m_{F}>0 [symbol] [symbol] |1| or |m_{F}<0 [symbol] [symbol] 0|.

One can then verify that after the pumping steps (5 and 6), the resulting state is the same as in the error-free case, up to a local error of Z type (e.g., |0 [symbol] [symbol] 0|, |1 [symbol] [symbol] 1|). As before, the error channels for intermediate state scattering and other Rydberg pulse imperfections (such as fluctuations in phase, frequency, and intensity) can be captured by the error model provided herein which contains BBR and RD errors.

Referring to FIG. 8, using an ancilla qubit and multiple Rydberg states to eliminate X type errors arising from control qubit decay is illustrated according to embodiments of the present disclosure. The atoms are positioned on a line, such that atom T is in the middle, and the distance between neighboring atoms is d≡d_{CT}=d_{AT}. The ancilla qubit is initially prepared in the |0 [symbol] state. The protocol consists of three steps, labelled (a)-(c), and can be visualized as a quantum circuit. One uses two different pairs of Rydberg S states, |r_{i,±} [symbol] and |r_{2,±} [symbol] , with blockade radii R_{B,1} and R_{B,2}, respectively, such that R_{B,1}>2 d and d<R_{B,2}<2 d.

Steps (a), (c): Apply a CNOT gate with C as control and A as target. This is done by applying a π pulse |1 [symbol] ↔|r_{i,+} [symbol] on atom C, performing the pulse sequence of FIG. 7 on atom A, and applying a −π pulse |1 [symbol] ↔|r_{1,+} [symbol] on atom C, so that the Rydberg pulses on A are resonant only if C is not in |r_{1,+} [symbol] (or a nearby Rydberg state). For these steps, the Rydberg levels |r_{±} [symbol] in FIG. 7 are chosen to be |r_{1,±} [symbol] (see Table 3).

Step (b): Apply a three-atom gate between C, A, and T. This is done by applying π pulses |1 [symbol] ↔|r_{2,+} [symbol] on both atom C and atom A, performing the pulse sequence of FIG. 7 on atom T, and applying −π pulses |1 [symbol] ↔|r_{2,+} [symbol] on both atom C and atom A, so that the Rydberg pulses on T are resonant only if neither C nor A is in |r_{2,+} [symbol] (or a nearby Rydberg state). For this step, the Rydberg levels |r_{±} [symbol] in FIG. 7 are chosen to be |r_{2,±} [symbol] (see Table 3).

TABLE 3

| | RYDBERG TRANSITIONS ADDRESSED | | |
|---|---|---|---|
| STEP | Atom C | Atom T | Atom A |
| (a), (c) | \|1 [symbol] ↔ \|r₁, + [symbol] | none | \|0 [symbol] ↔ \|r₁, − [symbol] |
| | | | \|1 [symbol] ↔ \|r₁, + [symbol] |
| (b) | \|1 [symbol] ↔ \|r₂, + [symbol] | \|0 [symbol] ↔ \|r₂, − [symbol] | \|1 [symbol] ↔ \|r₂, + [symbol] |
| | | \|1 [symbol] ↔ \|r₂, + [symbol] | |

Table 3 shows the Rydberg transitions used to implement the bias-preserving CNOT gate between two atoms C and T as shown in FIG. 8. Within each step, one Rydberg transition (|1 [symbol] ↔|r_{1,+} [symbol] or |1 [symbol] ↔|r_{2,+} [symbol] ) is addressed for each control atom, while two Rydberg transitions (|0 [symbol] ↔|r_{1,-} [symbol] , |1 [symbol] ↔|r_{1, +} [symbol] or |0 [symbol] ↔|r_{2,-} [symbol] , |1 [symbol] ↔|r_{2,+} [symbol] ) are addressed for each target atom. |r_{i,±} [symbol] and |r_{2,±} [symbol] have different blockade radii R_{B,1} and R_{B,2} as explained above and in connection with FIG. 8.

Having eliminated X errors arising from target qubit Rydberg errors, one now proceeds to address the second type of potential X error arising from control qubit decay. The crux here is to utilize multiple Rydberg atoms (e.g., a control atom and an ancilla atom) to blockade the target atom if the control is in the |1 [symbol] state; in this way, if one of the atoms decays, the remaining Rydberg atom(s) can still ensure (to leading order in the total error probability) that the Rydberg pulses on the target atom do not become resonant. For the simplest case, the bias-preserving CNOT gate can be implemented with one ancilla qubit. Assume that the control (C), target (T), and ancilla (A) atoms are placed evenly along a line, with the target atom in between the control and ancilla atoms; the ancilla atom is initialized in the state |0 [symbol] . One can make use of two sets of Rydberg states, |r_{i,±} [symbol] and |r_{2,±} [symbol] , with blockade radii R_{B,1} and R_{B,2}, respectively, such that R_{B,1}>2 d and d<R_{B,2}<2 d, where d is the distance between neighboring atoms (between C and T or T and A); as such, atoms C and A are within the blockade radius R_{B,1}, but beyond R_{B,2}, whereas neighboring atoms are within the blockade radius R_{B,2}. The full bias-preserving CNOT gate between the control and target atoms then consists of the three-step procedure illustrated in FIG. 8, followed by correction of Rydberg leakage errors (as described below) and optical pumping to eliminate non-Rydberg leakage errors (see FIG. 5). The Rydberg transitions addressed in each step of FIG. 8 are listed in Table 3.

This protocol is robust against control atom decay errors, as the Rydberg pulses on atom T are resonant only if neither C nor A is excited to the Rydberg state, and one can see that, to leading order in the total error probability, this can only occur if C starts in the |0 [symbol] state: first, if C begins in the |0 [symbol] state, A must also remain in |0 [symbol] , so the state of T will not be flipped. On the other hand, if C begins in the |1 [symbol] state and no decay events occur during Step (a), |C,A [symbol] =|1,1 [symbol] after this step. The Rydberg pulses for T are blockaded in Step (b), so its state will be flipped. Finally, if C begins in the |1 [symbol] state but decays during the first step, |C,A [symbol] =|1,1 [symbol] or |1,0 [symbol] after this step. The Rydberg pulses for T are still blockaded in Step (b), so its state will be flipped. Finally, Rydberg decay errors in Step (c) will result in projections of the form |0 [symbol] [symbol] 0| or |1 [symbol] [symbol] 1|, which can be expressed in terms of Z errors.

In this way, one has eliminated any possible source of X errors arising from the CNOT gate, to leading order in the total error probability. The protocol can also be generalized to implement a bias-preserving Toffoli gate as set out herein. Alternatives leading to suppression at higher orders are discussed below.

The ability to couple atoms to two sets of Rydberg states |r_{1,±} [symbol] and |r_{2,±} [symbol] in the bias-preserving CNOT implementation provided herein allows atom C to interact with atom A during Steps (a) and (c) of FIG. 8, but not during Step (b). Alternatively, this tunability of interaction could be achieved with only a single set of addressable Rydberg states |r_{1,±} [symbol] if the atoms can be rearranged while preserving coherence between hyperfine ground states. In this case, one could move atoms in between Steps (a) and (b) to further separate C, T, and A from each other such that the distance between C and A becomes greater than R_{B,1}, while the distance between either of them and atom T remains less than R_{B,1}. The atoms can then be returned to their original configuration after Step (b) to allow for interaction between C and A during Step (c).

Leading-Order Fault-Tolerance with the Repetition Code

The bias-preserving operations discussed above allow for a direct implementation of each component of the three-atom repetition code to perform quantum computation with leading-order fault-tolerance on a Rydberg setup. In particular, logical states can be prepared or measured fault-tolerantly in the X basis by transversally preparing or measuring each atom. The measurement of stabilizers can be achieved using the circuit of FIG. 1E, where each controlled-NOT gate is done in the bias-preserving way described above; for robustness against errors occurring during this circuit, one must repeat the stabilizer measurement if either g₁ or g₂ is measured to be −1.

A universal set of logical operations can be achieved by implementing a logical Toffoli gate and a logical Hadamard gate as in the seven-qubit case, using the bias-preserving pulse sequences presented above. While not strictly necessary, the implementation of logical controlled-phase and CCZ gates is also provided herein. These gates may be of use for simplifying the implementation of certain quantum algorithms, as they do not require the new bias-preserving pulse sequences and can be implemented using the standard method for performing Rydberg-mediated entangling gates illustrated in FIG. 2B.

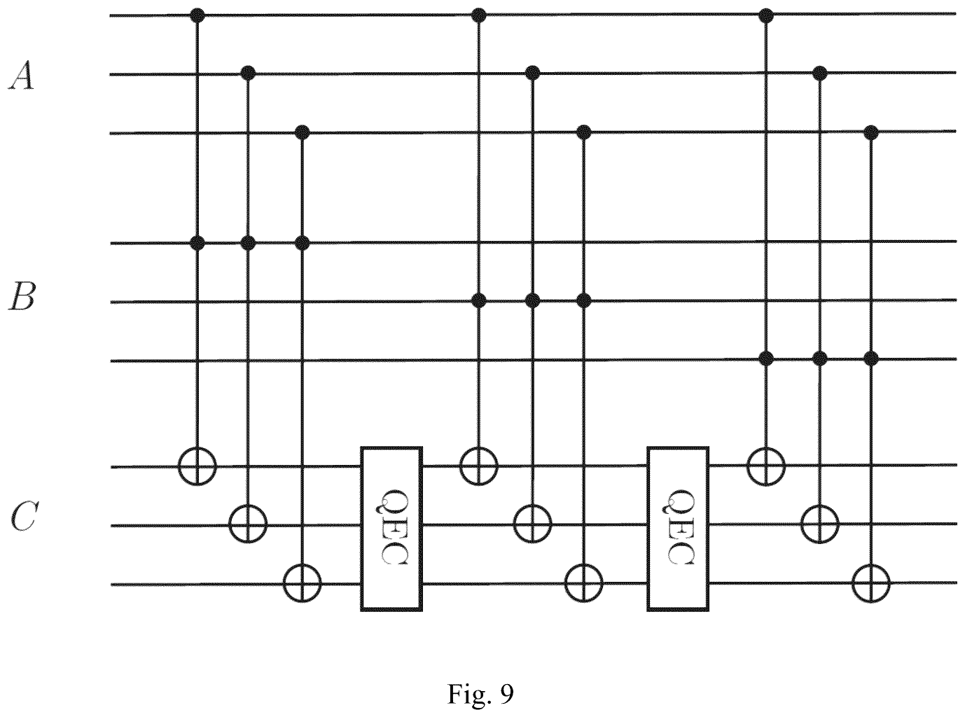

Referring to FIG. 9, a pieceable fault-tolerant implementation of the Toffoli gate in the repetition code is provided.

Logical Toffoli gate. One important feature of the encoding is that the logical |0 [symbol] _{L} (respectively, |1 [symbol] _{L}) state consists of an equal superposition of states with an even (odd) number of physical qubits in the |1 [symbol] state:

$$\begin{matrix}{\vert 0 〉}_{L} = \frac{1}{2} ( \vert 000 〉 + \vert 110 〉 + \vert 101 〉 + \vert 011 〉 ) \\ {\vert 1 〉}_{L} = \frac{1}{2} ( \vert 111 〉 + \vert 001 〉 + \vert 010 〉 + \vert 100 〉 )\end{matrix} \qquad Equation 14$$

From this observation, one can see that the Toffoli gate CCX_{ABC} with logical control qubits A, B and logical target qubit C can be implemented as a product of nine physical Toffoli gates:

$${CCX}_{ABC} = {{\prod }_{{j}_{A} , {k}_{B} ∈ \{ 1 , 2 , 3 \}}}_{{l}_{C} = {j}_{A}} CCX ( {j}_{A} , {k}_{B} , {l}_{C} ) \qquad Equation 15$$

Each physical Toffoli gate can be implemented in a bias-preserving fashion as described previously, resulting in at most one physical Z error in each logical qubit, assuming that Rydberg and non-Rydberg leakage errors are converted to possible Z errors after each physical gate. In this case, however, while Z errors on the control qubits A or B would commute with remaining Toffoli gates, a Z error on one of the physical qubits of C could spread to multiple Z errors within A or B after subsequent Toffoli gates if uncorrected. To address this, order the physical gates as shown in FIG. 9 and perform error correction after every three physical Toffoli operations by measuring the stabilizers; this follows the pieceable fault-tolerant implementations of non-transversal gates. In this way, after the entire logical gate, there will be at most one physical qubit Z error per involved logical qubit.

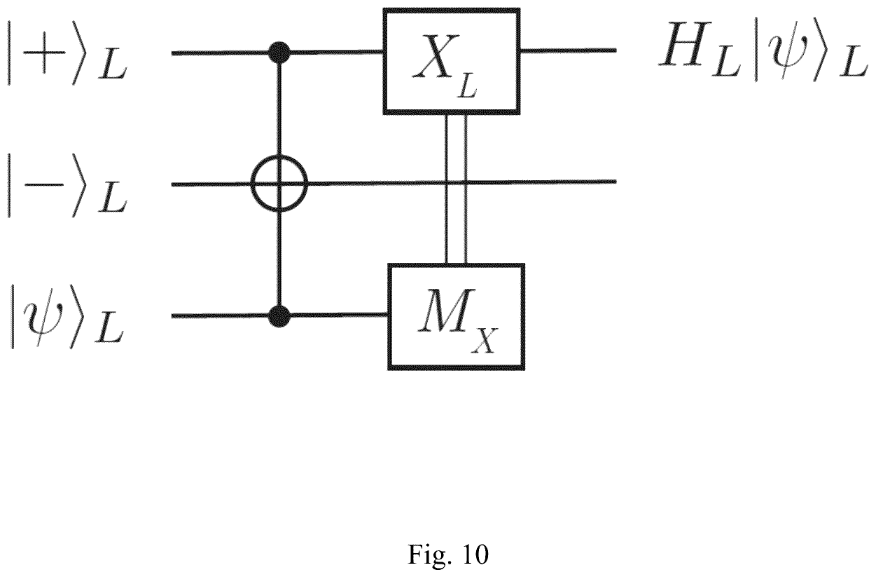

Referring to FIG. 10, an implementation of the logical Hadamard in the repetition code using the logical Toffoli gate is provided.

Logical Hadamard gate. Unlike the Steane code, the repetition code is not a CSS code, and its logical Hadamard gate is not transversal. However, the logical Hadamard gate can be implemented using a logical Toffoli gate combined with fault-tolerant measurements in the X basis, as shown in FIG. 10. The logical Hadamard gate combined with the logical Toffoli or CCZ gate form a universal set of logical operations.

Logical controlled-phase gate. A logical controlled-phase operation in the three-qubit code can be implemented using the standard Rydberg pulse sequences for controlled-phase gates between each pair (j_{A}, k_{B}) of physical qubits, where j_{A} and k_{B} belong to the encoding of logical qubits A and B, respectively:

$${CZ}_{AB} = {\prod }_{{j}_{A} , {k}_{B} ∈ \{ 1 , 2 , 3 \}} CZ ( {j}_{A} , {k}_{B} ) \qquad Equation 16$$

To correct for the errors that occur during gates, one should remove any Rydberg population and apply the optical pumping scheme to convert non-Rydberg leakage errors into possible Z errors after each physical controlled-phase operation. The stabilizers only need to be measured after the entire logical operation, since Rydberg gates can only produce Z errors which commute with all the physical CZ gates being performed (and hence do not spread to higher-weight errors).

Logical CCZ gate. Similarly, a logical controlled-controlled-Z operation between logical qubits A, B, C,

$${CCZ}_{ABC} = {1}_{A} {1}_{B} - \frac{1}{4} ( {Z}_{A} - {1}_{A} ) ( {Z}_{B} - {1}_{B} ) ( {Z}_{C} - {1}_{C} ) \qquad Equation 17$$

can be implemented as a sequence of physical CCZ operations:

$${CCZ}_{ABC} = {\prod }_{{j}_{A} , {k}_{B} , {l}_{C} ∈ \{ 1 , 2 , 3 \}} CCZ ( {j}_{A} , {k}_{B} , {l}_{C} ) \qquad Equation 18$$

As with the case of logical CZ, Rydberg and non-Rydberg leakage errors should be converted to possible Z errors after each physical gate. Notice that even though the logical CCZ is not transversal, this implementation is leading-order fault-tolerant because any given physical gate can result in at most one physical qubit Z error per logical qubit; since Z errors commute with the remaining gates applied, they do not propagate to become multi-qubit errors. While the CCZ gate is not strictly needed for the universal gate set given a leading-order fault-tolerant implementation of the logical Toffoli gate, it requires fewer resources to implement than the logical Toffoli as it uses the standard, simpler Rydberg gates R(C₁, C₂; T) instead of the more complicated bias-preserving CNOT pulse sequences (see Table 2). Thus, this operation may be useful for reducing the resource cost of certain quantum algorithms.

### Scalable Implementation

Some important considerations for the scalable implementation of the Ryd-3 protocol, including the geometrical layout, resource requirements, and potential improvements are described below.

Geometrical layout. Based on the implementations of logical gates, stabilizer measurement, and the underlying bias-preserving CNOT given in the previous sections, one finds that a convenient geometry is to place data and ancilla atoms on the vertices of a triangular lattice as shown in FIG. 1D, with three data atoms comprising a logical qubit. In this configuration, the logical qubits form a coarser triangular lattice, as in the case of Ryd-7. Two Rydberg states with different blockade radii R_{B,1}>R_{B,2} are required to implement the bias-preserving CNOT gate. Based on the interaction ranges required for performing fault-tolerant stabilizer measurements and logical operations as described previously, one finds that the larger blockade radius must be greater than 3 d (117 in FIG. 1D), where d is the nearest-neighbor spacing on the square lattice; this is required for some of the physical gates in the logical CCZ and Toffoli gates. On the other hand, the smaller blockade radius R_{B,2} should be strictly between d and 2 d for efficient implementation of the bias-preserving CNOT and fault-tolerant stabilizer measurements (118 in FIG. 1D). Details on how to obtain the requirement R_{B,1}>3 d can be found below.

Alternatively, the data and ancilla atoms can be placed on the vertices of a square lattice in an alternating fashion. In this case, the blockade radius requirements are R_{B,1}>3.61 d and d<R_{B,2}<2 d. For both the triangular lattice and square lattice geometries, experimental developments allowing for rearrangement of atoms while preserving the coherence of hyperfine ground states could be used to further reduce the requirement on R_{B,1} and eliminate the need for a second set of Rydberg states with blockade radius R_{B,2}.

Resource comparison. The resource cost of the Ryd-3 protocol is now compared with the Ryd-7 approach and alternative general-purpose proposals. Compared to the seven-qubit approaches, one finds that the number of entangling gates required for extraction of all stabilizers for error correction is significantly reduced due to the smaller number of data atoms and stabilizers per logical qubit, without a substantial increase in the number of required ancillas (Table 1). On the other hand, while the cost of performing a logical CCZ gate is essentially the same as in Ryd-7, the number of gates required for a logical Hadamard is larger (Table 2) because the Hadamard gate is not transversal using the repetition code. Notice that each CNOT gate in a stabilizer measurement translates to two two-atom entangling gates and one three-atom entangling gate in the bias-preserving implementation; this is reflected in Table 1 and Table 2 (more details on obtaining the Ryd-3 resource costs can be found below).

Nevertheless, the number of required gates is still very modest compared to logical operations in other universal FTQC gate sets. As a result, the substantial resource cost reduction for stabilizer measurements and the improved efficiency in using fewer atoms make the three-atom approach very promising for near-term implementation.

While the bias-preserving CNOT suppresses X-type errors to leading order, the amount of bias preservation is ultimately limited by the decay rate of the stretched Rydberg D state into the qubit states. To further suppress these errors, one can shelve to stretched Rydberg states with higher angular momentum, which would have a lower decay rate to the qubit states. Alternatively, one can also use an atomic species with higher nuclear spin, where the qubit states can be separated from the stretched Rydberg state by a larger |Δm_{F}|. Likewise, one could also increase the magnetic field in the experimental setup to suppress the rate of transitions with high |Δm_{F}|.

To achieve suppression beyond the leading order, one can then use more Rydberg shelving states in the target atom pulse sequence of FIG. 7 and more ancillas to suppress the effects of control atom decay.

The Ryd-3 hardware-tailored FTQC approach inherently addresses errors due to Rydberg pulse imperfections in addition to those arising from the finite Rydberg state lifetime, as these errors fall within a subset of the radiative decay errors. As in the Ryd-7 case, the Ryd-3 approach can also be enhanced to further protect against atom loss errors at the expense of additional physical operations by incorporating the atom loss detection scheme described below in between Rydberg operations.

### Experimental Implementation

In the following sections, further considerations on how the FTQC protocols provided herein can be implemented in near-term experiments are described. Neutral alkali atom systems can achieve near-deterministic trapping, loading, and rearrangement of tens to hundreds of atoms into two-dimensional lattice structures such as the triangular lattice needed for the protocol provided herein. Furthermore, high-fidelity manipulations within the ground state manifold and two- and three-atom Rydberg blockade-mediated entangling gates are possible. Blockade interactions between Rydberg atoms separated by three times the lattice spacing, which is the interaction range required for both of the protocols provided herein, is also possible.

### Measurements and Feed-Forward Corrections

To perform QEC, an important ingredient is the ability to measure the states of ancilla qubits and/or detect Rydberg population and perform feed-forward corrections. Several approaches can be considered. First of all, the rapid measurement of ancilla qubit states can be achieved by using two different atomic species for the data and ancilla atoms. In this approach, the ancilla atoms can still interact with the data atoms when both are coupled to Rydberg states, while they can be measured independently without disturbing the data atom states.

Alternatively, another way to rapidly measure individual qubit states is to drive a cycling transition

$$( e . g . , \vert 5 {S}_{\frac{1}{2}} , F = 2 , {m}_{F} = 2 〉 ↔ \vert 5 {S}_{\frac{3}{2}} , F = 3 , {m}_{F} = 3 〉 in {}^{87} Rb )$$

and detect the scattered photons. At lattice spacings of a few microns, this detection scheme can face cross-talk from the reabsorption of scattered photons by neighboring atoms. This effect can be mitigated by driving the cycling transition off-resonantly (at the expense of longer detection times). In addition, recent developments in coherent transport of entangled atom arrays can be used to mitigate these effects by coherently moving the atom far away from the rest of the array before it is measured.

To estimate the maximum speeds of coherent transport before atom loss and heating become significant, one can consider the harmonic oscillator potential (i.e., the optical tweezer) that the atom is trapped in. The average energy increase to the atom will be ΔE=m|ã(ω₀)|²/2, where m is the particle mass and ã(ω₀) is the Fourier transform of the acceleration profile a(t) evaluated at the trap frequency ω₀. When a(t) is linear in time, this energy depends on the total displacement D and time of movement T as approximately ΔE=36mD²/(ω₀²T⁴). Based on this estimate, it is reasonable to achieve substantial atom displacements D greater than 50 μm within 250 μs for performing feed-forward applications: for typical trap frequencies ω₀≈2π×50 kHz, the atom's vibrational quantum number would increase by only ΔN<1. Indeed, such transport has been demonstrated without significant decoherence or atom loss due to heating. Moving the atoms by a distance D would then suppress reabsorption rates during ancilla readout to σ/(4πD²), where σ is the absorption cross-section. Moreover, detuning the optical transitions for ancilla atoms by Δ further suppresses reabsorption by a factor of about

$${( \frac{Γ}{2 Δ} )}^{2} ,$$

where Γ is the resonance linewidth, and Δ>10Γ can be readily achieved with moderate powers of a light-shifting beam. Between moving and light-shifting the ancillary atoms, cross-talk errors on the data qubits can be suppressed by five or more orders of magnitude, to negligible levels.

Alternatively, the measurement of ancilla qubit states can be achieved by using two different atomic species for the data and ancilla atoms (such as two different isotopes of the same atom or two different atomic species). In this approach, the ancilla atoms can still interact with the data atoms when both are coupled to Rydberg states, while they can be measured independently without disturbing the data atom states.

Finally, fast detection schemes with atomic ensembles using Rydberg electromagnetically induced transparency (EIT) can be employed. These can be utilized to identify a Rydberg population after entangling gates. These schemes can be incorporated into the tweezer array platforms by creating larger, elongated traps at selected locations containing optically dense atomic ensembles.

In this approach, the Rydberg blockade effect leads to a sharp signature in the absorption spectrum of a weak EIT probe beam depending on whether a nearby Rydberg atom is present. Due to the collectively enhanced Rabi frequency, the detection time can be reduced to about 6 μs, comparable to the duration of an entangling gate. This ultrafast, non-destructive Rydberg atom detector thus provides a promising implementation for the measurement and feed-forward corrections needed for the protocols provided herein.

Implementation with Alkaline Earth(-Like) Atoms

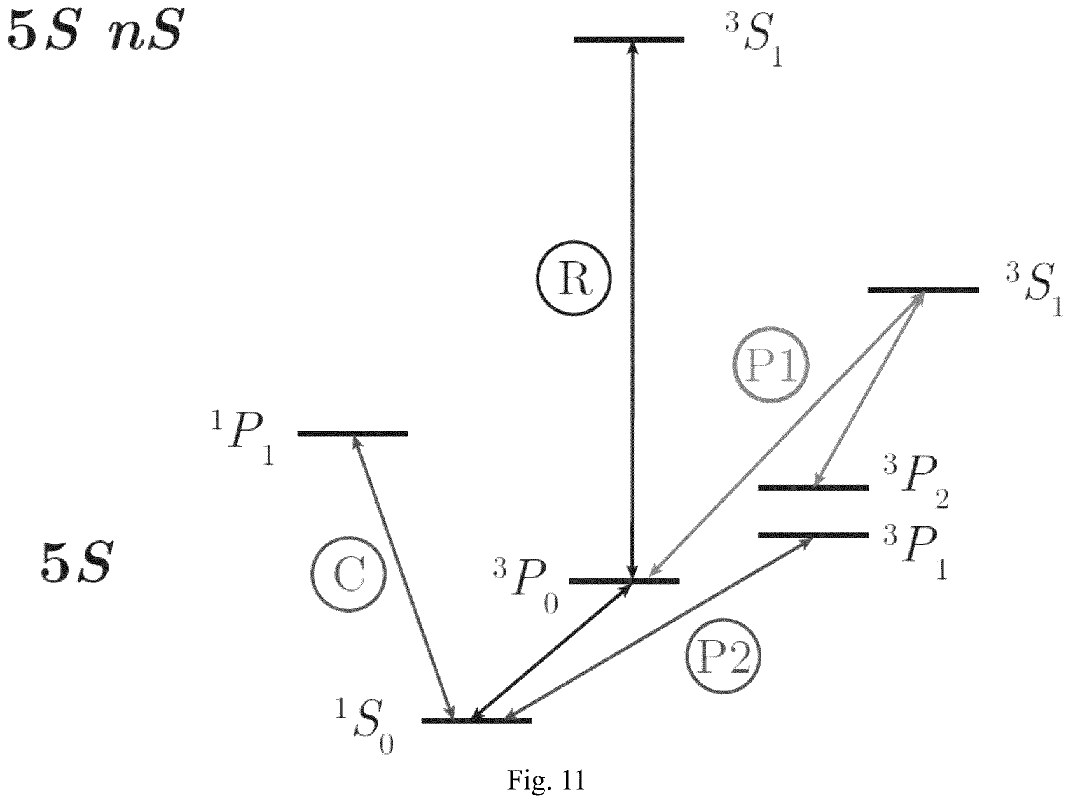

Referring to FIG. 11, a relevant level diagram is provided for implementing the FTQC protocols provided herein with neutral alkaline earth Rydberg atoms such as ⁸⁷Sr. The qubit is encoded in the stretched ¹S₀ ground state. Transitions to a 5S nS, ³S₁ Rydberg state can be driven by first coherently mapping one of the qubit states to the ³P₀ clock state and then exciting the clock state to the Rydberg state (R). Optical pumping to correct for non-Rydberg leakage is implemented in two stages by driving the P1 transitions followed by the P2 transition. State readout and strong cooling for state initialization are implemented via the ¹S₀↔¹P₁ transition (C), while narrow-line cooling can be implemented via the P2 transition.

The present disclosure has focused primarily on developing FTQC protocols for neutral alkali atoms coupled to Rydberg states. Alkaline earth(-like) atoms such as Sr and Yb can also be used for Rydberg-based quantum computations. The description below shows how the methods provided herein can also be applied to such setups. While the focus is on an example of ⁸⁷Sr for concreteness, the discussion provided herein is generic for fermionic species of alkaline earth(-like) atoms.

For alkaline earth(-like) atoms, the ¹S₀ ground states have no electronic orbital or spin angular momentum, so the only source of degeneracy is the nonzero nuclear spin (which can be quite large, e.g., I=9/2 for ⁸⁷Sr).

For the protocols provided herein, a most convenient qubit encoding uses the stretched ground states: |0 [symbol] ≡|m_{I}=−I [symbol] , |1 [symbol] ≡|m_{I}=+I [symbol] . In this encoding, strong cooling and state readout can be implemented via the ¹S₀↔¹P₁ transition, while narrow-line cooling can be performed on the ¹S₀↔³P₁ transition. Entangling gates can be implemented by selectively exciting the |1 [symbol] state to a stretched Rydberg ³S₁ state. This state selectivity can be achieved by coherently mapping one of the qubit states to the ³P₀ clock state, performing Rydberg pulses between the clock state and the Rydberg state, and mapping back to the ¹S₀ ground state, where one has utilized the linear Zeeman shift in the clock transition arising from hyperfine coupling between the ³P₀ and ³P₁ states. The relevant level diagram is shown in FIG. 11 for the case of ⁸⁷Sr.

During these entangling operations, an atom in the Rydberg state may undergo various errors such as BBR transitions, RD, or intermediate state scattering. For alkaline earth(-like) atoms, the resulting Kraus operators can be described by Pauli-Z errors and quantum jumps to Rydberg states, ¹S₀ ground states, or metastable ³P states as allowed by dipole selection.

Following the approach provided herein for alkali atoms, one must convert all such errors to Pauli-Z errors to apply the FTQC protocols provided herein. By using ancilla atoms and the blockade effect, the quantum jumps to Rydberg states can be corrected in the same fashion as for alkali atoms. However, due to the presence of metastable ³P levels, the correction of non-Rydberg leakage errors is more complicated, and the optical pumping must be done in two stages (see FIG. 11):
(1) Use σ⁺-polarized light from the ³P_{0,2} states to the triplet excited ³S₁ state to re-pump all ³P states to the ³P₁ manifold; these states will decay back into the ¹S₀ ground states.
(2) Use σ⁺-polarized light on the narrow-line cooling transition ¹S₀↔³P₁ to pump ground states with m_{F}>−I to the stretched ground state |1 [symbol] =|m_{I}=+I [symbol] .

After these two steps, all non-Rydberg leakage errors will be mapped to the error |1 [symbol] [symbol] 1|, which is expressible in terms of Pauli-Z errors. While Pauli-X errors could in principle arise from polarization impurities in the ¹S₀↔³P₁ beam in the second stage, this would require several consecutive polarization imperfections, each of which has a very low probability of roughly 0.2-0.5%; thus, the overall probability of Pauli-X errors arising from imperfect polarization is negligible. Therefore, by using this optical pumping scheme to convert all non-Rydberg leakage errors to Z errors, the FTQC schemes described above can be implemented in alkaline earth(-like) atoms.

The present disclosure provides a comprehensive analysis of the dominant error channels arising in quantum computation using neutral Rydberg atoms. Although the multilevel nature of atoms and the complex decay channels for Rydberg states lead to many additional types of errors not considered in traditional QEC settings, the specific structure of the error model allows design of hardware-efficient FTQC protocols based on the seven-qubit and hardware-tailored three-qubit codes with significantly reduced overhead compared to general-purpose schemes. These results provide the ability to convert the complicated error model to Pauli-Z errors by introducing ancilla atoms and making use of the Rydberg blockade effect, dipole selection rules, and new schemes for optical pumping. To use the three-atom repetition code, a new laser pulse sequence is provided to implement bias-preserving CNOT and Toffoli gates. For both protocols, scalable geometrical layouts are provided.

Compared to alternative general-purpose FTQC protocols, hardware-efficient approaches for Rydberg systems provided herein enable an order-of-magnitude improvement in resource overhead in terms of the number of physical gates or required ancillas. While the present disclosure focuses on certain implementations, the teachings provided herein are transferable to other quantum computing platforms such as trapped ions and superconducting qubits.

It will be appreciated that the present disclosure may be combined with topological codes such as surface codes or color codes. In exemplary embodiments the techniques provided herein are applied to address Rydberg and non-Rydberg leakage errors, followed by application of such topological codes. After eliminating all of the Rydberg-specific leakage errors using the FTQC protocols provided herein, one could concatenate those codes with alternative QEC approaches to address any higher-order Pauli-X or Y-type errors, or to further suppress the logical error rate to even higher orders.

### Numerical Computation of Branching Ratios and Transition Rates

This section presents the results of numerical computation of branching ratios for BBR and RD transitions out of the stretched Rydberg state 70S_{1/2}, m_{J}=1/2, m_{I}=3/2 for ⁸⁷Rb.

### 1. Blackbody Radiation-Induced Transitions

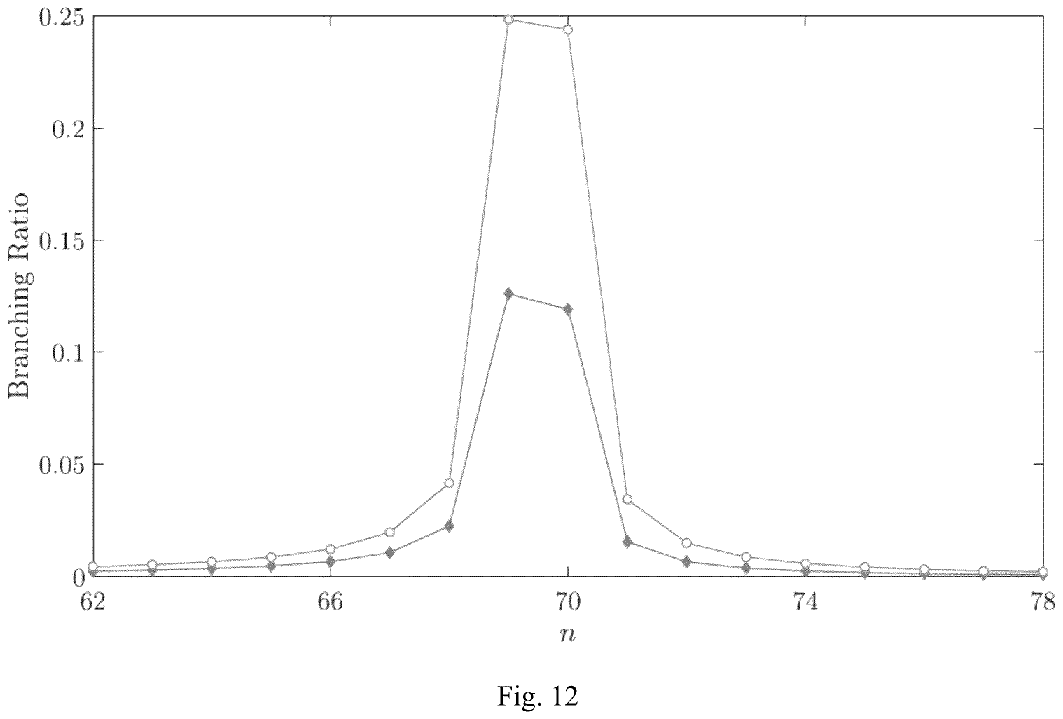

Referring to FIG. 12, branching ratios for BBR transitions between Rydberg states of ⁸⁷Rb, from the stretched 70S_{1/2}, state with m_{J}=1/2, m_{I}=3/2 to different P states with m_{J}=3/2 are shown in the plot (empty circles), or m_{J}=1/2 (filled diamonds).

To quantify the relative probability of transitioning into different nearby Rydberg P states, one computes the rate W(nL→n′L′) of BBR transitions from a given Rydberg state nL to other Rydberg states n′L′ using the Planck distribution of photons at the given temperature T and the Einstein coefficient for the corresponding transition:

W(nL→n′L′)=A(nL→n′L′)n̅_{ω} Equation 19
where ω=E_{nL}−E_{n,L}, is the transition frequency (E_{nL} and E_{n′L′} are energies of the initial and final states) and

$$A ( nL \to {n}^{′} {L}^{′} ) = \frac{4 {ω}^{3}}{3 {c}^{3}} \frac{{L}_{max}}{2 L + 1} {R}^{2} ( nL \to {n}^{′} {L}^{′} ) \qquad Equation 20$$

In the above equations, ℏ=1, Lₘₐₓ=max(L, L′), and R(nL→n′L′) is the radial matrix element for the electric dipole transition nL→n′L′.

The present disclosure used analytic formulas to numerically compute the radial dipole matrix elements for single-photon BBR transitions from the stretched Rydberg state 70S_{1/2}, m_{J}=1/2, m_{I}=3/2 of ⁸⁷Rb. One then computed the corresponding transition rates using Equation 19, and normalized these by the total BBR rate Γ_{BBR} (see Equation 3) to obtain the branching ratios.

The branching ratios for P states with m_{J}=3/2 and m_{J}=1/2 are plotted in FIG. 12 as empty circles and filled diamonds, respectively. Indeed, one finds that the atom decays primarily to the 69P and 70P states as illustrated in FIG. 1C.

### 2. Radiative Decay

As shown in FIG. 1C, the radiative decay transitions from the stretched 70S_{1/2}, m_{J}=1/2, m_{I}=3/2 Rydberg state of ⁸⁷Rb are almost entirely two- or four-photon decay processes to one of the five states in the ground state manifold; this fact was important for converting all Rydberg errors to Z type for fault-tolerant quantum computation. To justify this, one numerically computed the branching ratios for multi-photon spontaneous emission processes by evaluating the ratios of individual transition rates for each decay channel, which are given by the Einstein A coefficients of Equation 20. Due to the cubic dependence of these coefficients on transition frequency, the primary contributions arise from dipole-allowed transitions to states near the ground state manifold. The dipole matrix elements for such transitions scale with the effective principal quantum number n_{eff} of the Rydberg state as ˜1/n_{eff}^{1.5}. The total RD rate is then given by a sum over Einstein coefficients for all possible target states:

$$\frac{1}{{τ}_{0}} = {Γ}_{0} = {\sum }_{{n}^{′} {L}^{′} : {E}_{nL} {E}_{{n}^{′} {L}^{′}}} A ( nL \to {n}^{′} {L}^{′} ) \qquad Equation 21$$

By computing the radial dipole matrix elements, one evaluated the branching ratios for RD processes out of the 70S_{1/2}, m_{J}=1/2, m_{I}=3/2 stretched Rydberg state for ⁸⁷Rb.

TABLE 4

| F | m_{F} | Branching ratio |
|---|---|---|
| 2 | 2 | 0.534 |
| 2 | 1 | 0.177 |
| 2 | 0 | 0.055 |
| 2 | −1 | 0.003 |
| 2 | −2 | 0.001 |
| 1 | 1 | 0.168 |
| 1 | 0 | 0.059 |
| 1 | −1 | 0.003 |

Table 4 provides branching ratios for transition to each ground state of ⁸⁷Rb for radiative decay processes from the 70S_{1/2}, m_{J}=1/2, m_{I}=3/2 stretched Rydberg state, accounting for transitions involving up to four-photon emission processes. The contribution from transitions of even higher order is less than 2.5×10⁻⁴.

The results of this computation are shown in Table 4. Indeed, one finds that the branching ratios for the remaining three states are each on the order of 10⁻³, significantly smaller than those for the dominant five transitions. If the total error probability is already very small, these three processes (in particular, the decay to the stretched state with minimal m_{F}=−2) are highly unlikely.

### An Example of Master Equation Solution for Radiative Decay

Above, it is asserted that Kraus operators corresponding to spontaneous emission events from the Rydberg state |r [symbol] to the qubit |1 [symbol] are

M₀=|r [symbol] [symbol] r|+α|1 [symbol] [symbol] 1|+β|0 [symbol] [symbol] 0|, Mᵣ∝|r [symbol] [symbol] 1|, M₁∝|1 [symbol] [symbol] 1|, M₂∝|0 [symbol] [symbol] 0| Equation 22

where α, β, and the proportionality constants depend on the specific Rydberg pulse being performed and the probability for an atom in the Rydberg state to decay to the |1 [symbol] state. One now proceeds to derive these constants for the special case of a 2π pulse on the Rydberg transition |1 [symbol] ↔|r [symbol] by analytically solving the quantum master equation. For this example calculation, BBR transitions and RD transitions to other hyperfine states will be ignored; these can be included as a straightforward extension.

The master equation for this driven three-level system is (setting ℏ=1)

$$\frac{d \hat{ρ}}{dt} = - i [ {\hat{H}}_{d} , \hat{ρ} ] - \frac{γ}{2} ( {\hat{c}}^{†} \hat{c} \hat{ρ} + \hat{ρ} {\hat{c}}^{†} \hat{c} - 2 \hat{c} \hat{ρ} {\hat{c}}^{†} ) \qquad Equation 23$$

where \hat{ρ} denotes the density matrix of the system, Ĥ_{d}=iΩ(|r [symbol] [symbol] 1|−|1 [symbol] [symbol] r|) is the driving Hamiltonian, ĉ=|1 [symbol] [symbol] r| is the quantum jump operator corresponding to spontaneous emission |r [symbol] [symbol] |1 [symbol] , and γ is the probability for an atom in the Rydberg state to decay to |1 [symbol] . One assumes the qubit is initially encoded in the hyperfine manifold Span{|0 [symbol] , |1 [symbol] }, so that the initial density matrix can be written as

$${\hat{ρ}}_{0} = [ \begin{matrix}0 & 0 & 0 \\ 0 & {ρ}_{11} & {ρ}_{10} \\ 0 & {ρ}_{01} & {ρ}_{00}\end{matrix} ] \qquad Equation 24$$

(the matrix columns and rows are ordered as {|r [symbol] ,|1 [symbol] , |0 [symbol] }). Upon solving the resulting coupled first-order differential equations, one finds that the final state after the 2π pulse with decay is, to leading order in γ/Ω,

$${\hat{ρ}}_{f} = [ \begin{matrix}3 γ {t}_{π} {ρ}_{11} / 4 & 0 & 0 \\ 0 & ( 1 - 3 γ {t}_{π} / 4 ) {ρ}_{11} & - {e}^{- γ {t}_{π} / {2}_{{ρ}_{10}}} \\ 0 & - {e}^{- γ {t}_{π} / {2}_{{ρ}_{01}}} & {ρ}_{00}\end{matrix} ] \qquad Equation 25$$

Here

$${t}_{π} = \frac{π}{2 Ω}$$

is the duration of a π pulse. Indeed, Equation 25 confirms that the coherences ρᵣ₁, ρ₁ᵣ vanish upon averaging over all possible transition times during the 2π pulse.

One can then verify that, to leading order in γ/Ω, the Kraus operators

$${M}_{0} = \vert r 〉 〈 r \vert + \sqrt{1 - {p}_{2}} \vert 0 〉 〈 0 \vert + \sqrt{( 1 - {p}_{1} ) ( 1 - {p}_{2} )} \vert 1 〉 〈 1 \vert \qquad Equation 26$$

$${M}_{r} = \sqrt{{p}_{1} ( 1 - {p}_{2} )} \vert r 〉 〈 1 \vert \qquad Equation 27$$

$${M}_{1} = \sqrt{{p}_{2}} \vert 1 〉 〈 1 \vert \qquad Equation 28$$

$${M}_{2} = \sqrt{{p}_{2}} \vert 0 〉 〈 0 \vert \qquad Equation 29$$

give rise to the desired evolution from ρ₀ to ρ_{f} provided one takes p₁=3γt_{π}/4 and p₂=γt_{π}/8.

### Converting Rydberg Leakage to Pauli Errors

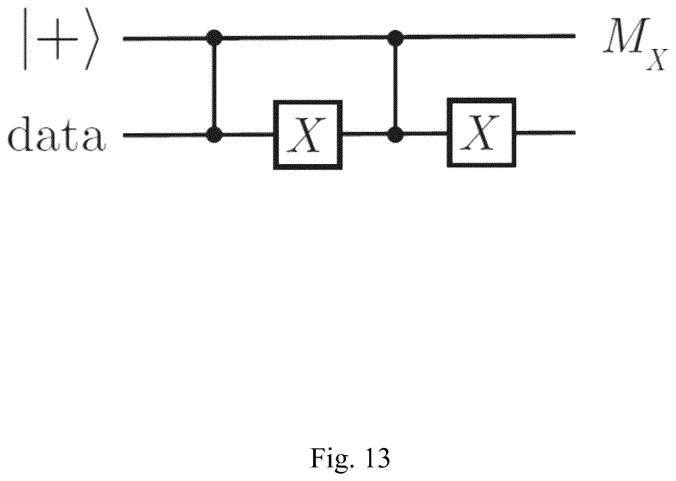

Once a Rydberg leakage error is detected, it can be converted to an atom loss error by ejecting the Rydberg atom, which is naturally done by the anti-trapping potential from the tweezer, and can be expedited by pulsing a weak, ionizing electric field. The exact location of the ejected atom can be determined by following the atom loss protocol outlined below and illustrated in FIG. 13. In this case, the atom loss protocol does not need to be applied in a robust fashion, since an error has already occurred. Subsequently, the ejected atom can be replaced with a fresh atom prepared in the |1 [symbol] state.

Although this process simply replaces the Rydberg atom by an atom in the |1 [symbol] state, by using the operator identity

$$\vert 1 〉 〈 1 \vert = \frac{1}{2} ( 1 - Z ) ,$$

the resulting state is now a superposition of the original state without error, and the same state with a Z error on this physical qubit. Such Z-type errors can be detected and corrected for using stabilizer measurements in both the seven-qubit and three-qubit codes. This procedure can also be modified to convert the Rydberg leakage error to a Pauli X-type error by applying Hadamard gates at the beginning and end; this is used in the logical CCZ gate for Ryd-7 (see Algorithm 3).

To reduce the need for applying the atom loss correction circuit, one could add a preventative step after every entangling gate which incoherently re-pumps any remnant population in several most probable Rydberg states into the |1 [symbol] qubit state. This re-pumping can be implemented via the following three-step procedure:
1. Swap the population in |1 [symbol] and the stretched ground state

$$\vert F = I + \frac{1}{2} , {m}_{F} = I + \frac{1}{2} 〉 .$$

2. For the most probable final states |r′ [symbol] of a BBR transition (or the Rydberg state |r [symbol] in the case of RD), perform a Rydberg laser pulse that sends |r′ [symbol] (or |r [symbol] ) to a short-lived P state. In particular, choose the P state with the smallest possible n, largest possible F, and largest possible m_{F}. This state will quickly decay to the stretched state

$$\vert F = I + \frac{1}{2} , {m}_{F} = I + \frac{1}{2} 〉 .$$

and cannot decay to any other ground state.
3. Repeat Step (1).

While the above description focuses on the most probable final states |r′ [symbol] for BBR errors, the other BBR errors can be corrected by extending step 2 to cover those states.

By applying this procedure preventatively, one can convert a large fraction of Rydberg leakage errors to Z-type errors without the need for the atom loss correction circuit of FIG. 13.

### Atom Loss Errors

Referring to FIG. 13, a circuit for detecting atom loss is illustrated.

As mentioned above, neutral atom setups can also suffer from atom loss errors if the trapping is imperfect, or if the trapping lasers need to be turned off during Rydberg excitation (e.g., as is typically done for ⁸⁷Rb in various embodiments). Fortunately, such errors can also be detected and corrected within the FTQC framework provided herein at the cost of one ancilla qubit and some extra gates for each operation. In particular, an atom loss event can be detected by applying the circuit of FIG. 13 for each data qubit after using the optical pumping technique to correct for leakage out of the computational subspace. The ancilla measurement will then produce +1 in the presence of atom loss, and −1 if such an error did not occur. Once detected, an atom loss error can be converted to a single-qubit Pauli-Z or -X type error if a reservoir of atoms is available, for instance by replacing the lost atom with a new atom initialized in to the |0 [symbol] state.

The steps needed for establishing robustness against errors occurring during this circuit are described below. As in the case of fault-tolerant Rydberg leakage detection described below, to protect against ancilla errors in FIG. 13, a multi-step ancilla measurement protocol is again adopted, requiring two positive ancilla measurements to confirm an atom loss error. On the other hand, any phase-flip error on the data qubit cannot propagate to more than a single physical qubit error per logical qubit in the universal gate set implementations for Ryd-7 or Ryd-3. Leakage errors (Rydberg or non-Rydberg) can be addressed by repeating the respective re-pumping procedures after applying the atom loss detection circuit. Thus, by incorporating this circuit into the implementation of fault-tolerant stabilizer measurements and logical operations described above, one can also address atom loss errors in the FTQC protocols provided herein.

Note that this circuit can be used for atom loss after correcting for leakage into atomic states outside the computational subspace by using the blockade effect and optical pumping techniques. In addition, this approach does not distinguish between atom loss and leakage into other hyperfine states, so it can also be used to suppress any residual hyperfine leakage errors.

### Fault-Tolerant Detection of Rydberg Leakage Errors

As mentioned above, for fault-tolerant error detection and correction, it is important to address any errors that may occur on an ancilla used to probe for Rydberg population. This can be done by using a multi-step measurement procedure to detect leakage for the ancilla qubit:
1. Perform a Hadamard gate on the ancilla.
2. Check whether the ancilla is in the |1 [symbol] state (e.g., by coupling |1 [symbol] to a cycling transition and detecting fluorescence).
3. Perform an X gate on the ancilla.
4. Check for |1 [symbol] population again.

If neither the second nor the last step yields |1 [symbol] , the ancilla atom must have undergone a leakage error. In that case, one converts any possible ancilla atom Rydberg error to a possible Z-type error. Similarly, because the Rydberg pulses can potentially cause a phase-flip error on the ancilla qubit, if a Rydberg leakage error is detected by the ancilla, the detection protocol must be repeated once more to ensure that the outcome did not result from such an error.

Once a Rydberg leakage error is detected, it can be converted to a phase-flip error by sending the Rydberg state to |1 [symbol] .

Error Syndromes with Postponed Measurements

It is described above how Rydberg leakage detection can be postponed in the Ryd-7 stabilizer measurement and controlled-phase gate protocols to facilitate experimental implementation. This relied on the ability to use stabilizer measurements to distinguish between the possible correlated errors that can result from postponed detection of a Rydberg leakage error. Here, details are presented on how to use error syndromes to identify the corresponding correlated error in each case. As above, one assumes the stabilizers for the Steane code are ordered as

| | | |
|---|---|---|
| g₁ = IIIXXXX | g₂ = IXXIIXX | g₃ = XIXIXIX |
| g₄ = IIIZZZZ | g₅ = IZZIIZZ | g₆ = ZIZIZIZ |

### Equation 30

TABLE 5

| ERROR | g₄ | g₅ | g₆ |
|---|---|---|---|
| X₅X₆X₇ | −1 | +1 | +1 |
| X₆X₇ | +1 | +1 | −1 |
| X₇ | −1 | −1 | −1 |

Table 5 shows error syndromes used to distinguish between correlated errors resulting from postponed detection of Rydberg leakage during measurement of the X₄ X₅ X₆ X₇ stabilizer in the Ryd-7 FTQC protocol. Because the possible correlated errors are all products of Pauli-X errors, Table 5 shows the corresponding values of Z^{⊗4} stabilizer measurements.

For the stabilizer measurement, one will consider (without loss of generality) the measurement of g₁ on qubits 4, 5, 6, 7 using a circuit of the form shown in FIG. 1B. If a Rydberg leakage error occurs on the ancilla atom at any point, the data atoms do not suffer any correlated errors. On the other hand, if a data atom suffers a Rydberg leakage error during the circuit, the possible correlated errors that can result are X₅ X₆ X₇,X₆ X₇,or X₇. These errors can be distinguished by measuring the Z^{⊗4} stabilizers of the seven-qubit code; the corresponding error syndromes are shown in Table 5.

For the case of the logical CCZ gate, the 27 physical Rydberg gates were grouped into groups [symbol] ᵢ of three, and Rydberg leakage detection was performed after each group. Without loss of generality, one will consider the group [symbol] ₁ in FIG. 3. There are two possible correlated errors that could result from the delayed detection of Rydberg leakage in this case (up to a single-qubit error within each logical qubit): R(2_{A},2_{B};2_{C}) R(3_{A},3_{B};3_{C}) and R(3_{A},3_{B};3_{C}). By writing the Rydberg gate as

R(j,k;l)=(1+Zⱼ)(1+Zₖ)(1+Zₗ)−1 Equation 31

one finds that the two cases can be distinguished by measuring the stabilizers g₂ and g₃ for each of the logical qubits. In the former case, at least one of the logical qubits would have either a Z₂ or Z₂ Z₃ error, giving rise to stabilizer eigenvalues (g₂,g₃)=(−1, +1) or (+1, −1), while in the latter scenario, all three sets of stabilizer measurements would yield (−1,−1) or (+1, +1).

### Implementation of a Bias-Preserving Toffoli Gate

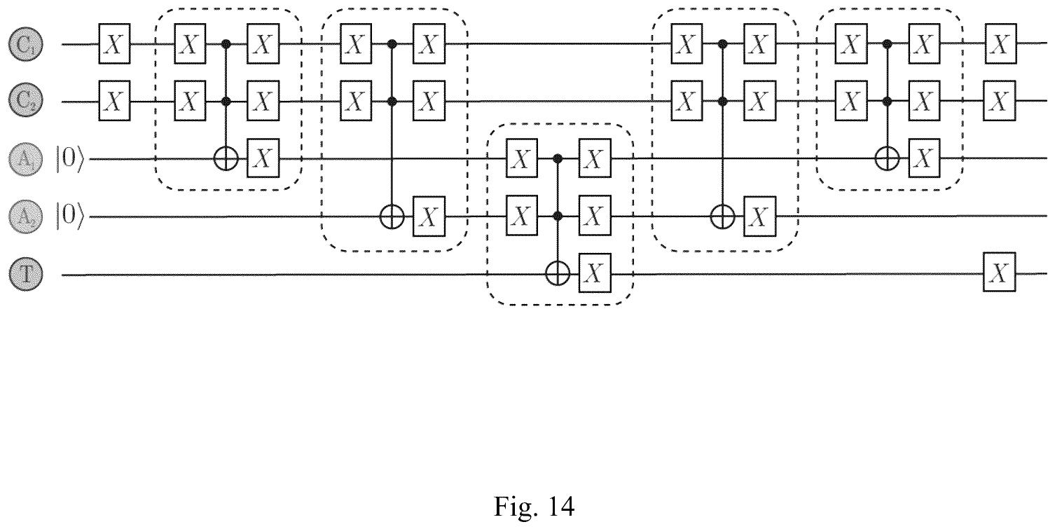

FIG. 8 illustrated how an ancilla atom can be used to eliminate X-type errors resulting from control atom decay in the implementation of a bias-preserving CNOT gate. Analogously, a bias-preserving Toffoli gate can be implemented by making use of two ancilla atoms which lie on either side of the target atom. This protocol is illustrated in FIG. 14.

Referring to FIG. 14, a circuit using two ancilla qubits and multiple Rydberg states to implement a bias-preserving Toffoli gate between control atoms C₁, C₂, and target atom T is illustrated. The ancilla atoms (A₁ and A₂) are chosen to lie on either side of the target atom. The dotted boxes indicate the most natural bias-preserving three-qubit gate for Rydberg systems, where π pulses |1 [symbol] ↔|r₊ [symbol] are applied to each of the first two (the upper two) involved atoms, the bias-preserving pulse sequence of FIG. 7 is applied to the third (lower) atom, and −π pulses |1 [symbol] ↔|r₊ [symbol] are applied to the first two qubits; the Rydberg states |r_{±} [symbol] are chosen to be either |r_{1,±} [symbol] or |r_{2,±} [symbol] for each such gate. In this circuit, set |r_{±} [symbol] =|r_{1,±} [symbol] in the first, second, fourth, and fifth cases, while choosing |r_{±} [symbol] =|r_{2,±} [symbol] for the third one. With this choice of Rydberg levels, the two ancillas will not interact with each other during the third Rydberg gate. However, note that the two control atoms may interact with each other during the first, second, fourth, and fifth entangling gates if the distance between them is less than one blockade radius; this is not problematic because Rydberg errors can occur during at most one of these gates, so at least one ancilla atom will generate the correct interaction with the target atom during the third gate.

As with the case of the bias-preserving CNOT, the choice of Rydberg states differs throughout the procedure. By coupling the atoms to |r_{2,±} [symbol] during the third gate of FIG. 14 and using ancilla atoms on opposite sides of the target atom, one ensures that the ancilla atoms do not interact with each other via Rydberg blockade during this gate; this is important in case one of the ancilla atoms undergoes a radiative decay transition during this gate. On the other hand, the other entangling gates in FIG. 14 all use the Rydberg states |r_{1,±} [symbol] , due to larger distances between the atoms during these gates. The two control atoms may interact with each other during these four gates if the distance between them is less than one blockade radius, which is different from the case of the third gate. This is acceptable because Rydberg errors can occur during at most one of these four gates, so at least one ancilla atom will generate the correct interaction with the target atom during the third gate.

### Computing Resource Costs for Rydberg FMC Protocols

Details are provided below on how to obtain the resource costs for the Ryd-7 and Ryd-3 protocols presented in Table 1 and Table 2.

For the Ryd-7 protocol, each stabilizer measurement requires four two-qubit Rydberg gates in the absence of errors (see Algorithm 1); thus, 24 two-qubit gates are required to measure all stabilizers. If an error occurs, the worst case scenario for the stabilizer measurement is when the first five stabilizers all have +1 eigenvalues, while the very last stabilizer is measured to be −1. In this case, g₄, g₅, and g₆ need to be re-measured, which requires 12 additional two-qubit gates. The logical CCZ gate for Ryd-7 is implemented using 27 physical three-qubit gates in the absence of error, as described in Algorithm 3. The worst case error in this case is a Rydberg leakage error that occurred during the first entangling gate in the final group [symbol] ₉ of FIG. 3. In this scenario, identifying the location of the Rydberg leakage error requires up to 18 additional two-qubit gates, while measuring the stabilizers g₂, g₃, . . . , g₆ for all three logical qubits would amount to 60 additional two-qubit gates; the correction circuit could require up to two additional three-qubit gates.

In the Ryd-3 protocol, each of the two stabilizer measurements requires two bias-preserving CNOT gates (FIG. 1E), and each bias-preserving CNOT gate is broken down to two two-atom gates and one three-atom entangling gate. Thus, in the absence of error, the stabilizer measurements would require eight two-qubit gates and four three-qubit gates. If an error occurs, the worst case scenario is if the second stabilizer is measured to be −1; in this case, both stabilizers need to be re-measured, and the gate cost is doubled. The Ryd-3 CCZ gate can be implemented in a round-robin fashion in the same way as the Ryd-7 CCZ, which is bias-preserving and uses 27 physical three-qubit gates.

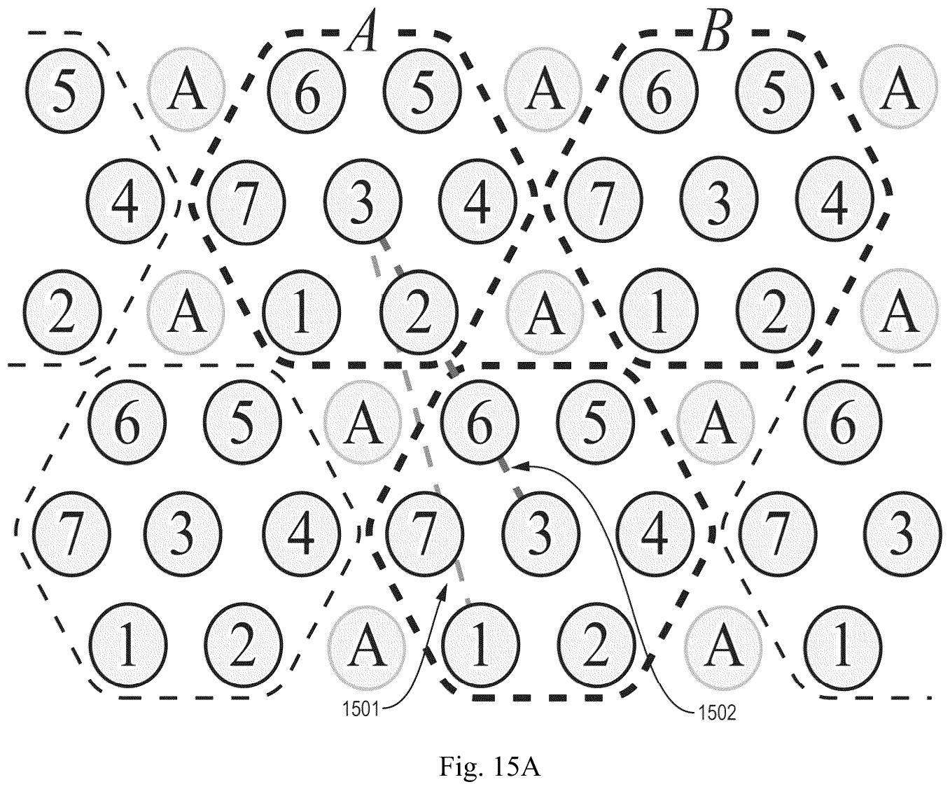

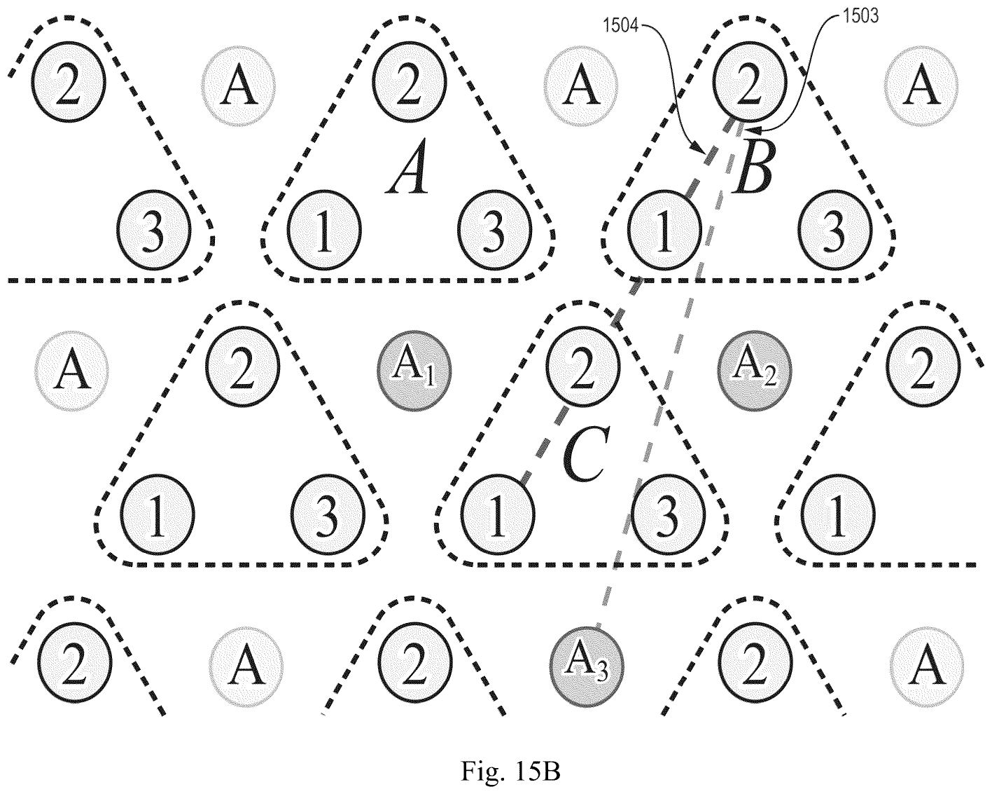

Finally, the Ryd-3 Hadamard gate consists of a fault-tolerant, bias-preserving Toffoli gate followed by single-qubit measurements and rotations (FIG. 10). The pieceable fault-tolerant Toffoli gate in the Ryd-3 code consists of nine physical bias-preserving Toffoli gates and two rounds of error correction. As discussed above, each round of error correction involves eight two-atom Rydberg gates and four three-atom Rydberg gates. When the data atoms within each logical qubit are indexed as in FIG. 15B and a logical Toffoli gate CCX_{ABC} is implemented between the three qubits A, B, C highlighted in bold, the number of Rydberg gates required to implement each physical Toffoli gate depends on the blockade radius R_{B,1}. If the blockade radius R_{B,1} is larger than 3.61 d, each physical Toffoli gate can be implemented using two ancilla atoms (one on either side of the target atom) and five three-atom Rydberg gates; this is because the distance between any physical control atom Cᵢ and any ancilla Aⱼ in FIG. 14 will always be less than the blockade radius R_{B,1}, so the entangling gates can be implemented directly. In this case, each physical Toffoli gate involves five three-atom Rydberg gates, so the total gate count (upon including the QEC steps) is 16 two-atom gates and 53 three-atom gates in the absence of errors. On the other hand, if one wishes to reduce the blockade radius requirement to R_{B,1}>3 d, there are two physical Toffoli gates (corresponding to the choices j_{A}=l_{C}=1, k_{B}=2 and j_{A}=l_{C}=3, k_{B}=2), where the distance between one of the physical control atoms and one of the ancilla atoms (2_{B} and A₃ in FIG. 15B) would be too large to directly implement a Rydberg entangling gate required for the physical Toffoli gate. Instead, in place of the first (respectively, second) three-atom Rydberg gate involving A₃, one would implement a Rydberg gate with the same two control atoms and one of the ancilla atoms A₁ or A₂, whichever is not involved in the rest of the FIG. 14 circuit, followed (respectively, preceded) by a bias-preserving CNOT gate between that ancilla and A₃. These gates can be implemented directly because both A₁ and A₂ are within the blockade radius of 2_{B}, 1_{A}, 2_{A}, 3_{A}, and A₃. In this way, four extra two-atom gates are required for the logical Toffoli (two for the physical Toffoli with j_{A}=l_{C}=1, k_{B}=2 and two for the physical Toffoli with j_{A}=l_{C}=3, k_{B}=2), which increases the total gate count to 20 two-atom gates and 53 three-atom gates in the absence of error, as shown in Table 2. With errors, the worst case scenario is if the final stabilizer measurement in the second round of QEC yields −1, in which case the stabilizers need to be measured again; this adds another eight two-atom gates and four three-atom gates to the total resource cost.

Referring to FIGS. 15A, B, example labeling is provided of atoms for the Ryd-7 and Ryd-3 FTQC protocols, respectively, used to derive the gate counts and blockade radius requirements. Data atoms are shown with numbers, while ancilla atoms are shown by an “A”.

Referring to FIG. 15A, in the Ryd-7 protocol, each logical qubit consists of seven data atoms (dotted hexagons). For each data atom, a number is used to indicate which physical qubit of the seven-qubit logical state the atom encodes. With this labeling, the blockade radius R_{B} is defined by the interaction range needed to perform a logical CCZ gate between three neighboring logical qubits such as A, B, and C. Using the specific CCZ protocol given in Algorithm 3, the blockade radius requirement is then R_{B}>3.61 d, where d is the spacing between nearest neighbors on the lattice; this is determined by the distance between physical atoms 3_{A} and 1_{C} (thinner, light grey dotted line 1501). However, by using a different set of physical CCZ gates to implement the logical CCZ, this requirement can be reduced to R_{B}>3 d (thicker, dark grey dotted line 1502).

Referring to FIG. 15B, in the Ryd-3 protocol, each logical qubit consists of three data atoms (dotted triangles). For each data atom, a number is used to indicate which physical qubit of the three-qubit logical state the atom encodes. With this labeling, the larger blockade radius R_{B,1} is determined by the interaction range required for performing a logical Toffoli gate between three neighboring logical qubits such as A, B, and C. In this case, there are two possibilities for R_{B,1}—either R_{B,1}>3.61 d (thinner, light grey dotted line 1503) or R_{B,1}>3 d (thicker, dark grey dotted line 1504). When the larger blockade radius of 3.61d can be realized, the resource cost for the logical Toffoli and Hadamard gates can be reduced by four two-qubit entangling gates compared to the numbers presented in Table 2.

### Computing Rydberg Blockade Radius Requirements for Rydberg FTQC Protocols

To obtain the blockade radius requirement for the Rydberg FTQC protocols, one must identify each physical qubit with an atom on the lattice, and then determine the maximum distance between two atoms which must interact with each other during a Rydberg gate. When the underlying atoms are placed in a triangular lattice, FIGS. 15A, B depict convenient identifications for the Ryd-7 and Ryd-3 codes, respectively. In these figures, numbers are used to label the indices of data atoms within each logical qubit. (The index of a physical qubit within each logical qubit is the position, counting from the left, of that qubit in the definition of the logical states; see Equation 6 and Equation 7 for the seven-qubit code, or Equation 12 for the three-qubit code.)

In the Ryd-7 protocol, the blockade radius is defined by the interaction range needed to perform a logical CCZ gate between three neighboring logical qubits, such as A, B, and C. Using the specific protocol given in Algorithm 3, which involves 27 physical CCZ gates between atoms j_{A}, k_{B}, l_{C}∈{1,2,3}, one finds that the largest interaction range is required to perform the physical CCZ gate between farthest-separated triples such as (j_{A}, k_{B}, l_{C})=(3, 3, 1). For this specific case, the distances between atom pairs are

$$dist ( {j}_{A} , {k}_{B} ) = 3 d , dist ( {j}_{A} , {l}_{C} ) = \sqrt{{( \frac{7}{2} )}^{2} + \frac{3}{4}} d \approx 3.61 d ,$$

and dist(k_{B}, l_{C})=4 d. To apply the three-qubit Rydberg gate R(j_{A}, k_{B}; l_{C}), this would require a blockade radius of R_{B}>4 d. However, this is not entirely necessary for the purposes described herein: instead, it is sufficient that two out of the three distances dist(j_{A}, k_{B}), dist(j_{A}, l_{C}), and dist(k_{B}, l_{C}) be less than the blockade radius. To see this, suppose, for example, that the distance between the two control atoms j_{A} and k_{B} is greater than R_{B}. In this case, applying the same pulse sequence as illustrated in FIG. 2B would result in a three-qubit gate R=diag(1, −1, −1, −1, −1, −1,1,1), which can also be obtained from the CCZ gate by single-qubit unitaries (R∝Y₁ Y₂ (CCZ)X₁ X₂).

The argument above allows the blockade radius requirement for Ryd-7 to be reduced to R_{B}>3.61 d (thinner, light grey dotted line 1501 in FIG. 15A). In fact, by modifying the implementation of the logical CCZ gate, it is possible to further reduce this requirement to R_{B}>3 d (thicker, dark grey dotted line 1502 in FIG. 15A).

In the Ryd-3 protocol, the blockade radius R_{B,1} is determined by the interaction range required to implement the logical Toffoli gate between neighboring logical qubits (e.g., A, B, and C in FIG. 15B). There are two possibilities in this case. To directly implement every physical bias-preserving Toffoli gate using the circuit of FIG. 14, the distance between 2_{B} and A₃ must be less than R_{B,1}; this requires

$${R}_{B , 1} > \sqrt{{( \frac{7}{2} )}^{2} + 3 / 4} d \approx 3.61 d$$

(thinner, light grey dotted line 1503 in FIG. 15B). However, this requirement can be reduced to R_{B,1}>3 d (thicker, dark grey dotted line 1504 in FIG. 15B) at the expense of four additional two-atom entangling gates per logical Toffoli or Hadamard operation.

### Blockade Radius Reduction for Ryd-7

To reduce the blockade radius requirement from R_{B}=3.61 d to R_{B}=3 d in the Ryd-7 protocol, one must modify the implementation of the logical CCZ operation. Recall that Algorithm 3 implements a logical CCZ gate using 27 physical CCZ gates between the first three physical qubits of every logical qubit. This round-robin decomposition makes use of Equation 11, which is now derived:

$${CCZ}_{ABC} = {\prod }_{{j}_{A} , {k}_{B} , {l}_{C} ∈ \{ 1 , 2 , 3 \}} CCZ ( {j}_{A} , {k}_{B} , {l}_{C} ) \qquad Equation 32$$

To begin the derivation, recall, first, that the logical states of the seven-qubit code have well-defined parity: the number of physical qubits in the |1 [symbol] state is always even for |0 [symbol] _{L} and odd for |1 [symbol] _{L}. It then follows that the logical CCZ gate can be implemented in a fully round-robin fashion involving all physical qubits

$${CCZ}_{ABC} = {\prod }_{{j}_{A} , {k}_{B} , {l}_{C} ∈ \{ 1 , 2 , … , 7 \}} CCZ ( {j}_{A} , {k}_{B} , {l}_{C} ) \qquad Equation 33$$

This is because the round-robin implementation results in a −1 phase accumulation for each triple (j_{A}, k_{B}, l_{C}) of physical qubits in the |1 [symbol] state, and the number of such triples is odd if all logical qubits are in the |1 [symbol] _{L} logical state, while it is even if at least one logical qubit is in the |0 [symbol] _{L} state. To reduce this to Equation 32, notice that for each choice of j_{A} and k_{B}, the product

$${\prod }_{{l}_{C} ∈ \{ 4 , 5 , 6 , 7 \}} CCZ ( {j}_{A} , {k}_{B} , {l}_{C} ) \qquad Equation 34$$

acts as an identity operation on the logical qubits, because g₄=Z₄ Z₅ Z₆ Z₇ is a stabilizer of the seven-qubit code. One then multiplies both sides of Equation 33 by this operator, and uses the fact that all the CCZ gates commute with each other and square to the identity operator. In this way, the product over l_{C} in the logical CCZ gate can be reduced from l_{C}∈{1, 2, . . . , 7} to l_{C}∈{1,2,3}. Because the CCZ gate is symmetric in the three involved qubits, this same argument can be applied to reduce the products over j_{A} and k_{B} to obtain Equation 32.

To reduce the blockade radius requirement from R_{B}=3.61 d to R_{B}=3 d, one can replace the product in Equation 34 by

$${\prod }_{{l}_{C} ∈ \{ 1 , 2 , 4 , 7 \}} CCZ ( {j}_{A} , {k}_{B} , {l}_{C} ) \qquad Equation 35$$

in this derivation for one of the logical qubits, say qubit C. This is because the single-qubit operator Z₁ Z₂ Z₄ Z₇=g₂g₃ is the product of two stabilizers, so the operator in Equation 35 also acts trivially on the logical subspace. It follows that

$${CCZ}_{ABC} = {\prod }_{\begin{matrix}{j}_{A} , {k}_{B} , {l}_{C} ∈ \{ 1 , 2 , 3 \} \\ {l}_{C} ∈ \{ 3 , 5 , 6 \}\end{matrix}} CCZ ( {j}_{A} , {k}_{B} , {l}_{C} ) \qquad Equation 36$$

Thus, the 27 physical CCZ gates in Algorithm 3 may be replaced by the 27 CCZ gates used in the right hand side of Equation 36.

Given the geometrical layout of individual atoms within each logical qubit shown in FIG. 15A, the required interaction range for implementing the logical CCZ operation using these 27 gates is smaller than the interaction range required to perform the 27 gates of Algorithm 3. Furthermore, notice that these 9 physical qubits need not all be within the blockade radius of each other, so long as every physical qubit j_{A}∈{1,2,3} is within distance R_{B} of every l_{C}∈{3,5,6}, and every k_{B}∈{1,2,3} is within distance R_{B} of every l_{C}∈{3,5,6}. This requirement is satisfied for any R_{B}>3 d, as shown in FIG. 15A.

### Square Lattice Geometry for Ryd-3

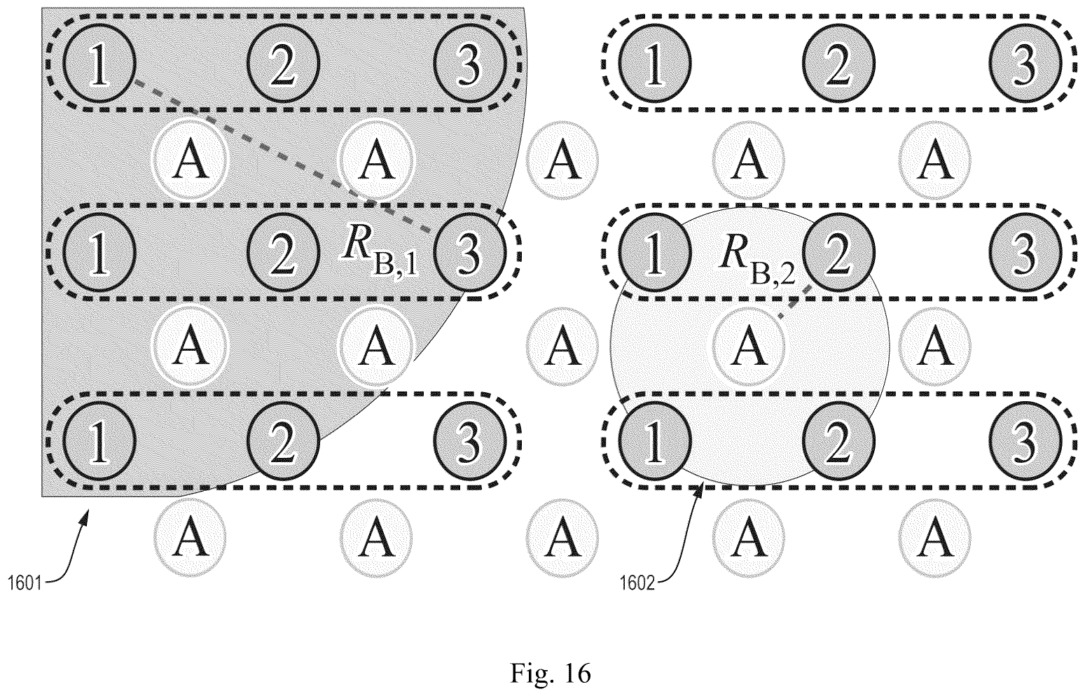

Referring to FIG. 16, a square lattice geometry for the Ryd-3 FTQC protocol is illustrated. Data (numbered) and ancilla (A) atoms are placed on the vertices of a square lattice in an alternating fashion, with three data atoms comprising a logical qubit (dotted boxes). The numbers on each data atom indicate the index of that atom within each logical qubit; this is relevant for the implementation of stabilizer measurements and logical operations. Two Rydberg states with different blockade radii are required to implement the bias-preserving CNOT and Toffoli gates. The larger blockade radius R_{B,1} must be larger than \sqrt{10}d (˜3.16 d, dark grey 1601), where d is the nearest-neighbor spacing on the lattice, while the smaller blockade radius must satisfy d<R_{B,2}<2 d (light grey 1602). The interaction range R_{B,1} is needed to perform a logical CCZ gate between the three logical qubits indicated in bold, which is the logical operation requiring the largest interaction range

$${CCZ}_{ABC} = {\prod }_{{j}_{A} , {k}_{B} , {l}_{C} ∈ \{ 1 , 2 , 3 \}} CCZ ( {j}_{A} , {k}_{B} , {l}_{C} ) \qquad Equation 37$$

which is implemented from 27 physical CCZ gates. To implement each physical gate, the distance between every pair (j_{A}, l_{C}) and (k_{B}, l_{C}) must be less than the larger blockade radius R_{B,1}. The longest such distance is √10 d as shown in the dark grey dotted line 1601 of FIG. 16, so the corresponding blockade radius requirement for this geometry is R_{B,1}>√10 d.

With these blockade radii, the protocols described above can be directly applied to perform all logical operations. The higher density of ancilla atoms in this arrangement enables implementing every physical Toffoli gate in the logical Toffoli operation directly using the circuit of FIG. 14, without the need for additional ancilla atoms or CNOT gates (as was the case for two physical Toffoli operations under the triangular lattice geometry). In this way, for the square lattice geometry, the number of two-qubit entangling operations required for the logical Hadamard or Toffoli operations may be reduced by 4 compared to the numbers shown in Table 2.

### Optical Pumping Procedure for the Bias-Preserving CNOT

To implement the bias-preserving CNOT pulse sequence shown in FIG. 7, it is important that the optical pumping procedure in the final step pumps only the m_{F}>0 states to the |1 [symbol] state, and only the m_{F}<0 states to the |0 [symbol] state. This requirement is essential to ensuring that the CNOT does not generate any X- or Y-type errors. For magnetic field regimes typically used in alkali atom Rydberg experiments, this state selectivity may not be straightforward to implement, as the level separation between different m_{F} states within a single hyperfine manifold may be much smaller than the linewidth of the lasers used for optical pumping. To address this challenge, one can utilize a Rydberg state as a shelving state (due to its long lifetime) to avoid unwanted pumping of m_{F}<0 (respectively, m_{F}>0) states to |1 [symbol] (|0 [symbol] . Thus, in Step 706 of FIG. 7, the optical pumping of m_{F}>0 states into the |1 [symbol] state can be implemented for ⁸⁵Rb as follows:
1. Swap the population between the |1 [symbol] state and the stretched ground state

$$\vert F = I + \frac{1}{2} , {m}_{F} = I + \frac{1}{2} 〉 .$$

2. Swap the population between the |0 [symbol] state and the ground state |F=3, m_{F}=0 [symbol] .
3. Apply a resonant π pulse to shelve any population in the |F=2, m_{F}=−2) state into the Rydberg state

$$\vert {nS}_{\frac{1}{2}} , {m}_{J} = - \frac{1}{2} , {m}_{I} = - \frac{5}{2} 〉 .$$

4. Use a light to excite states in the F=2 ground state manifold to the 5P_{3/2}F=3 manifold; these excited states decay quickly back to the ground state.
5. Apply resonant π pulses |F=3, m_{F}=1 [symbol] ↔|F=2, m_{F}=1 [symbol] and |F=3, m_{F}=2 [symbol] ↔|F=2, m_{F}=2 [symbol] .
6. Repeat Steps 4 and 5 as necessary; after several iterations, all population that started with m_{F}>0 will be in the |F=3, m_{F}=3 [symbol] state.
7. Repeat Steps 1, 2, and 3.

Because the |F=2, m_{F}=−2 [symbol] state can only be populated if a Rydberg error occurred in one of the earlier steps of the bias-preserving CNOT, to leading order in the total error probability, one may assume that the Rydberg state

$$\vert {nS}_{\frac{1}{2}} , {m}_{J} = - \frac{1}{2} , {m}_{I} = - \frac{5}{2} 〉$$

will not decay if it is populated in the above procedure. In this way, the only F=2 states that can be populated at the beginning of Step 4 above will be the m_{F}>0 states, so the optical pumping will work in the same way as the protocol described above (FIG. 5).

An analogous procedure can then be applied to pump the m_{F}<0 states into |0 [symbol] . In this latter case, it will not be necessary to shelve population in the Rydberg state, as all m_{F}>0 population will already have been transferred to the |1 [symbol] state.

An exemplary device for fault tolerant quantum computation includes a two-dimensional array of optical tweezers configured to provide confinement for the atoms. Rearrangement of the atoms to form desired defect-free arrays with arbitrary geometries may be provided using two-dimensional AODs as set out below. Lasers are provided to excite the atoms from their electronic ground state to a Rydberg state (highly excited electronic state), where the atoms interact with each other via strong van der Waals interactions. Read-out of the atomic states is provided via fluorescence imaging. This allows detection of atoms in the ground state, while atoms in the Rydberg state are detected as losses (due to the anti-trapping effect of the optical tweezers).

### Formation of Array of Particles Using Optical Tweezers

Optical trapping of neutral atoms is a powerful technique for isolating atoms in vacuum. Atoms are polarizable, and the oscillating electric field of a light beam induces an oscillating electric dipole moment in the atom. The associated energy shift in an atom from the induced dipole, averaged over a light oscillation period, is called the AC Stark shift. Based on the AC Stark shift induced by light that is detuned (i.e., offset in wavelength) from atomic resonance transitions, atoms are trapped at local intensity maxima (for red detuned, that is, longer wavelength trap light), because the atoms are attracted to light below the resonance frequency. The AC Stark shift is proportional to the intensity of the light. Thus, the shape of the intensity field is the shape of an associated atom trap. Optical tweezers utilize this principle by focusing a laser to a micron-scale waist, where individual atoms are trapped at the focus. Two-dimensional (2D) arrays of optical tweezers are generated by, for example, illuminating a spatial light modulator (SLM), which imprints a computer-generated hologram on the wavefront of the laser field. The 2D array of optical tweezers is overlapped with a cloud of laser-cooled atoms in a magneto-optical trap (MOT). The tightly focused optical tweezers operate in a “collisional blockade” regime, in which single atoms are loaded from the MOT, while pairs of atoms are ejected due to light-assisted collisions, ensuring that the tweezers are loaded with at most single atoms, but the loading is probabilistic, such that the trap is loaded with a single atom with a probability of about 50-60%.

To prepare deterministic atom arrays, a real-time feedback procedure identifies the randomly loaded atoms and rearranges them into pre-programmed geometries. Atom rearrangement requires moving atoms in tweezers which can be smoothly steered to minimize heating, by using, for example, acousto-optic deflectors (AODs) to deflect a laser beam by a tunable angle which is controlled by the frequency of an acoustic waveform applied to the AOD crystal. Dynamic tuning of the acoustic frequency translates into smooth motion of an optical tweezer. A multi-frequency acoustic wave creates an array of laser deflections, which, after focusing through a microscope objective, forms an array of optical tweezers with tunable position and amplitude that are both controlled by the acoustic waveform. Atoms are rearranged by using an additional set of dynamically moving tweezers that are overlaid on top of the SLM tweezer array.

### Exemplary Hardware

Optical tweezer arrays constitute a powerful and flexible way to construct large scale systems composed of individual particles. Each optical tweezer traps a single particle, including, but not limited to, individual neutral atoms and molecules for applications in quantum technology. Loading individual particles into such tweezer arrays is a stochastic process, where each tweezer in the system is filled with a single particle with a finite probability p<1, for example p˜0.5 in the case of many neutral atom tweezer implementations. To compensate for this random loading, real-time feedback may be obtained by measuring which tweezers are loaded and then sorting the loaded particles into a programmable geometry. This may be performed by moving one particle at a time, or in parallel.

Parallel sorting may be achieved by using two acousto-optic deflectors (AODs) to generate multiple tweezers that can pick up particles from an existing particle-trapping structure, move them simultaneously, and release them somewhere else. This can include moving particles around within a single trapping structure (e.g., tweezer array) or transporting and sorting particles from one trapping system to another (e.g., between one tweezer array and another type of optical/magnetic trap). This sorting is flexible and allows programmed positioning of each particle. Each movable trap is formed by the AODs and its position is dynamically controlled by the frequency components of the radiofrequency (RF) drive field for the AODs. Since the RF drive of the AODs can be controlled in real time and can include any combination of frequency components, it is possible to generate any grid of traps (such as a line of arbitrarily positioned traps), move the rows or columns of the grid, and add or remove rows and columns of the grid, by changing the number, magnitude, and distribution of the frequency components in the RF drive fields of the AODs.

In an exemplary embodiment, an optical tweezer array is created using a liquid crystal on silicon spatial light modulator (SLM), which can programmatically create flexible arrangements of tweezers. These tweezers are fixed in space for a given experimental sequence and loaded stochastically with individual atoms, such that each tweezer is loaded with probability p˜0.5. A fluorescence image of the loaded atoms is taken, to identify in real-time which tweezers are loaded and which are empty.

After detecting which tweezers are loaded, movable tweezers overlapping the optical tweezer array can dynamically reposition atoms from their starting locations to fill a target arrangement of traps with near-unity filling. The movable tweezers are created with a pair of crossed AODs. These AODs can be used to create a single moveable trap which moves one atom at a time to fill the target arrangement or to move many atoms in parallel.

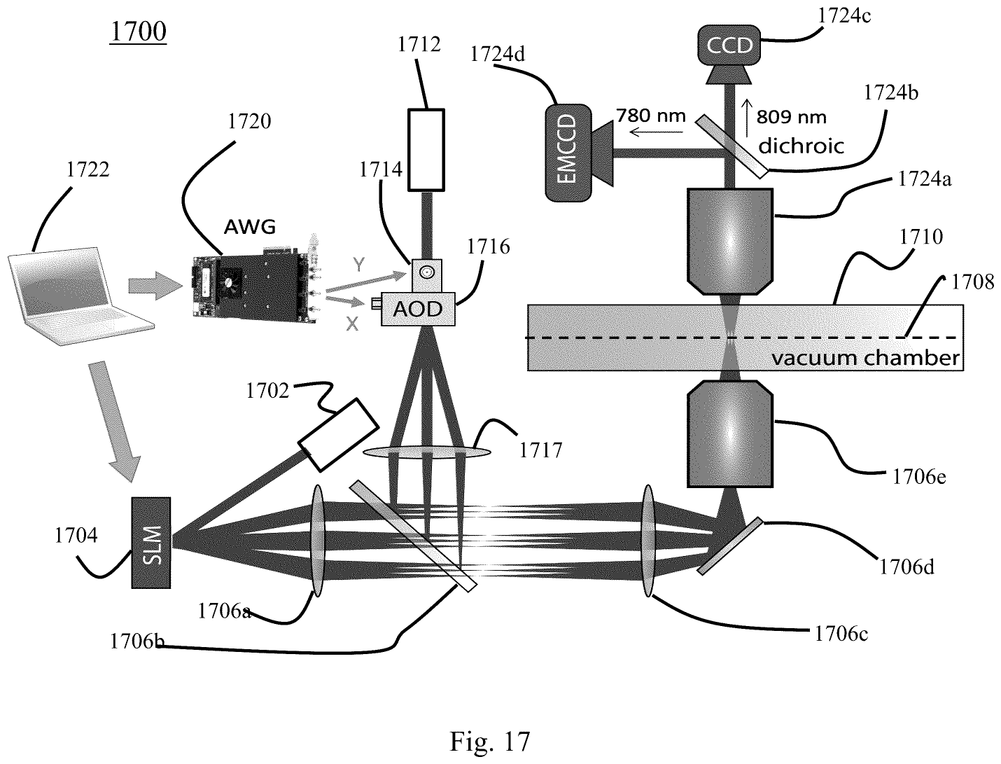

Referring to FIG. 17, a schematic view is provided of an apparatus 1700 for fault-tolerant quantum computation according to embodiments of the present disclosure. As shown in FIG. 17, using a beam generated by a light source 1702 (for example, a coherent light source, in some example embodiments—a monochromatic light source), SLM 1704 forms an array of trapping beams (i.e., a tweezer array) which is imaged onto trapping plane 1708 in vacuum chamber 1710 by an optical train that, in the example embodiment shown in FIG. 17, comprises elements 1706a, 1706c, 1706d, and a high numerical aperture (NA) objective 1706e. Other suitable optical trains can be employed, as would be easily recognized by a person of ordinary skill in the art. Using a beam generated by light source 1712 (for example, a coherent light source; in some example embodiments—a monochromatic light source), a pair of AODs 1714 and 1716, having non-parallel directions of acoustic wave propagation (for example, orthogonal directions) creates dynamically movable sorting beams. By using the optical train, such as the one depicted in FIG. 17 (elements 1717, 1706b, 1706c, 1706d, and 1706e), the sorting beams are overlapped with the trapping beams. It is understood that other optical train can be used to achieve the same result. For example, source 1702 and 1712 can be a single source, and the trapping beam and the sorting beam are generated by a beam splitter.

The dynamic movement of the steering beams is accomplished by employing two non parallel AODs 1714, 1716, arranged in series. In the example embodiment depicted in FIG. 17, one AOD defines the direction of “rows” (“horizontal”—the ‘X’ AOD) and the other AOD defines the direction of “columns” (“vertical”—the ‘Y’ AOD). Each AOD is driven with an arbitrary RF waveform from an arbitrary waveform generator 1720, which is generated in real-time by a computer 1722 which processes the feedback routine after analyzing the image of where atoms are loaded. If each AOD is driven with a single frequency component, then a single steering beam (“AOD trap”) is created in the same plane 1708 as the SLM trap array. The frequency of the X AOD drive determines the horizontal position of the AOD trap, and the frequency of the Y AOD drive determines the vertical position; in this way, a single AOD trap can be steered to overlap with any SLM trap.

In FIG. 17, laser 1702 projects a beam of light onto SLM 1704. SLM 1704 can be controlled by computer 1722 in order to generate a pattern of beams (“trapping beams” or “tweezer array”). The pattern of beams is focused by lens 1706a, passes through mirror 1706b, and is collimates by lens 1706c on mirror 1706d. The reflected light passes through objective 1706e to focus an optical tweezer array in vacuum chamber 1710 on trapping plane 1708. The laser light of the optical tweezer array continues through objective 1724a, and passes through dichroic mirror 1724b to be detected by charge-coupled device (CCD) camera 1724c.

Vacuum chamber 1710 may be illuminated by an additional light source (not pictured). Fluorescence from atoms trapped on the trapping plane also passes through objective 1724a, but is reflected by dichroic mirror 1724b to electron-multiplying CCD (EMCCD) camera 1724d.

In this example, laser 1712 directs a beam of light to AODs 1714, 1716. AODs 1714, 1716 are driven by arbitrary wave generator (AWG) 1720, which is in turn controlled by computer 1722. Crossed AODs 1714, 1716 emit one or more beams as set forth above, which are directed to focusing lens 1717. The beams then enter the same optical train 1706b . . . 1706e as described above with regard to the optical tweezer array, focusing on trapping plane 1708.

It will be appreciated that alternative optical trains may be employed to produce an optical tweezer array suitable for use as set out herein.

Excitation of Atoms in Arrays of Optical Tweezers into Rydberg States

At the micrometer length scales separating optical tweezers, atoms in their ground electronic states have negligible van der Waals interactions. Fortunately, neutral atoms offer a remarkable way to switch on strong interactions through the coherent excitation of the atoms into Rydberg states.

The properties of atomic states scale dramatically with principal quantum number. Rydberg states are highly excited electronic states of the atoms, wherein one of the electrons of the atom has a high principal quantum number n in a range of between 30 and 100. In a classical picture of the atom, this situation corresponds to one (negatively charged) electron orbiting far away from the (positively charged) ionic core on atomic length scales, thus forming an oscillating electric dipole. Two atoms excited into the same Rydberg state can exhibit very strong dipolar interactions over distances of several tens of microns. The interaction energy V(R)=C₆/R⁶, where R is the interatomic distance, and the coefficient C₆ scales with a very large power law C₆∝n¹¹, with typical values of the interaction energy V(R) in a range of between several megahertz and several gigahertz for atoms that are separated by several microns. The interaction energy can be employed for a number of important applications, such as quantum entanglement and quantum gates, by implementation of a Rydberg blockade mechanism.

Consider an ideal two-level atom, having a ground state |g [symbol] and a Rydberg state |r [symbol] . These two states are laser-coupled with a coupling strength set by the angular Rabi frequency Ω, the inverse of the duration of a Rabi cycle, also referred to as a Rabi flop, that is the cyclic absorption and stimulated emission of a quantum of energy by a two-level atom in the presence of an oscillatory driving field. The Rabi frequency is proportional to the strength of the coupling between the light and the atomic transition, and to the amplitude of the light's electric field. For two such atoms, also referred to herein as Rydberg atoms, if their interatomic distance R is large, such that the van der Waals interaction energy V_{vdW} can be neglected compared to the laser coupling strength, that is V_{vdW}<<ℏΩ (where ℏ is the reduced Planck's constant), the atoms can be regarded as independent particles, and thus both can be excited to the Rydberg state at the same time. However, for small interatomic distances, the van der Waals interaction between the Rydberg states can become very strong, and lead to an energy shift of the state |rr [symbol] , the state where both atoms are in the same Rydberg state, of magnitude V(R)=C₆/R⁶. If this interaction energy shift is larger than the laser coupling strength, such that V_{vdW}>>ℏΩ, then the excitation of the doubly excited state is no longer possible. The suppression of more than a single excitation inside a certain radius is called the Rydberg blockade. The blockade radius R_{b} is the distance at which the interaction energy and the laser coupling strength are equal, such that R_{b}=(C₆/ℏΩ)^{1/6} As the van der Waals interaction coefficient scales as C₆˜n¹¹, the blockade radius increases as n^{11/6} with the principal quantum number n, with typical values of R_{b} in a range of between 2 μm and 20 μm. The blockade radius decreases with increasing laser coupling strength (i.e., higher Rabi frequency Ω). As an additional or alternative control parameter, the interaction energy shift can also be increased by reducing the interatomic distance R, with the lower limit of R set by the optical resolution of the imaging system used to focus the optical tweezers, typically to about 2 μm.

Several implementations of optical excitation from an atomic ground state to a target Rydberg state are available. The simplest is direct laser excitation with a single-photon transition. The wavelengths for such transitions in Rydberg atoms are typically in the ultraviolet. For example, the single-photon wavelength for ⁸⁷Rb is 297 nm. Ultraviolet lasers pose serious experimental challenges, due to, for example, material degradation, and unavailability of optical fibers and low-loss optics. Alternatively, two-photon laser excitation can be used to couple the atomic ground state to a target Rydberg state through an intermediate electronic excited state by illuminating the atoms from opposite sides with two counterpropagating laser beams.

Consistent with the above description, the term “blockade” is used herein to refer to the phenomenon in which a laser-stimulated transition of an atom in a pair of interacting atoms from a first state (e.g., ground state) to an excited state cannot be achieved (is blockaded) due to a mismatch between the laser frequency and a shifted energy level of the excited state, where the shift in the energy level is electrically or magnetically induced. For example, a blockade can be achieved by a dipole-dipole interaction between two neighboring atoms where one is excited into a Rydberg state.

Detuning from Resonance with an Excited State

The coherent evolution of two atoms under laser excitation from a ground state |g [symbol] to a Rydberg state |r [symbol] is described by the Hamiltonian

$$\frac{H}{ℏ} = \frac{Ω}{2} {\sum }_{i} ( \vert {g}_{i} 〉 〈 {r}_{i} \vert + \vert {r}_{i} 〉 〈 {g}_{i} \vert ) - Δ {\sum }_{i} {n}_{i} + {\sum }_{i < j} {V}_{ij} {n}_{i} {n}_{j} \qquad Equation 38$$

where Vᵢⱼ is the van der Waals interaction energy (V(R)=C₆/R⁶) nᵢ=|rᵢ [symbol] [symbol] rᵢ|, and Ω and Δ are the Rabi frequency and detuning of the laser excitation frequency away from the transition resonance frequency, respectively. For an interatomic distance R such that

$$\frac{{R}_{b}}{R} \approx 1 ,$$

sweeping the detuning Δ from negative to positive values while keeping the Rabi frequency Ω fixed implements the nearest-neighbor Rydberg blockade, where only one out of every pair of nearest-neighbor atoms can be excited to |r [symbol] .

Furthermore, in the two-photon laser excitation scheme, it is preferable to detune the two excitation lasers, that typically have one frequency in the blue range of the optical spectrum, such as 420 nm, and the other frequency in the red or infrared, such as 1013 nm, by a frequency shift δ away from the intermediate state (δ»Ω_{B}, Ω_{R}, where Ω_{B} and Ω_{R} are the Rabi frequencies of the blue and red lasers, respectively). This detuning avoids populating the intermediate state, thereby preventing spontaneous emission from this state, and enables the treatment of the time evolution of the population of atoms as a two-level system between |g [symbol] and |r [symbol] .

It will be appreciated that in various embodiments, the pulse sequences described herein may be generated by computer control of a laser source. Likewise, the detection of states as set out herein may be performed through various techniques known in the art and provided to a computer controller. Accordingly, it will be appreciated that in various embodiment computer instructions may be provided to perform said control and detection steps set out herein.

It will also be appreciated that a variety of methods may be used to read out the state of an array of atoms. For example, a quantum gas microscope may be used to determine whether each atom in an array is in an excited or ground state, as described in Browaeys, et al., Many-Body Physics with Individually-Controlled Rydberg Atoms, DOI: 10.1038/s41567-019-0733-z (available at https://arxiv.org/abs/2002.07413), which is hereby incorporated by reference in its entirety.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of error detection in a quantum computer, the quantum computer comprising a plurality of qubits encoding a plurality of data qudits and an ancilla qudit, the method comprising:
arranging the qubits encoding the plurality of data qudits into a grouping wherein the qubits encoding each of the plurality of data qudits are within an interaction distance of an interacting state of the qubits encoding the ancilla qudit; and
detecting a leakage error of a first data qudit of the plurality of data qudits into the interacting state by detecting a state of the ancilla qudit.

2. The method of claim 1, wherein each of the plurality of data qudits and the ancilla qudit is encoded in the atomic states of neutral atoms.

3. The method of claim 2, wherein each of the plurality of data qudits is encoded in the atomic states of a first species of neutral atoms, and the ancilla qudit is encoded in the atomic states of a second species of neutral atoms.

4. The method of claim 1, wherein each of the plurality of data qudits and the ancilla qubit corresponds to a qubit.

5. The method of claim 1, wherein the interacting state is a Rydberg state.

6. The method of claim 1, wherein the grouping is a seven qudit grouping.

7. The method of claim 1, wherein the grouping is a three qudit grouping.

8. A method of error correction in a quantum computer, the quantum computer comprising a plurality of qubits encoding a plurality of qudits, the method comprising:
selecting quantum states of the plurality of qudits such that angular momentum selection rules prohibit mixing between the selected quantum states during a leakage error of one of the plurality of qudits into a noninteracting state; and
correcting the leakage error by optical pumping of the noninteracting state, the optical pumping preserving coherence of the selected quantum states in the absence of the leakage error.

9. The method of claim 8, wherein each of the plurality of qudits is encoded in atomic states of neutral atoms.

10. The method of claim 9, wherein selecting the quantum states of the plurality of qudits comprises:
selecting a first qudit state having a first magnetic quantum number and a second qudit state having a second magnetic quantum number, the first and second magnetic quantum numbers having opposite signs.

11. The method of claim 10, wherein correcting the leakage error further comprises:
prior to the optical pumping, coherently transferring atoms in the first qudit state into a first shelving state;
prior to the optical pumping, coherently transferring atoms in the second qudit state into a second shelving state;
subsequent to the optical pumping, coherently transferring the population of atoms in the first shelving state into the first qudit state;
subsequent to the optical pumping, coherently transferring the population of atoms in the second shelving state into the second qudit state, wherein
the optical pumping does not transfer atoms out of the first shelving state and
the optical pumping transfers atoms from any ground state other than the first shelving state into the second shelving state.

12. The method of claim 8, wherein each of the plurality of qudits corresponds to a qubit.

13. A method of implementing a controlled gate in a quantum computer, the quantum computer comprising a plurality of qubits encoding at least one target qudit and at least one control qudit, the method comprising:
conditionally, according to a control state of the at least one control qudit, coherently transferring qubits encoding the at least one target qudit from a plurality of states to corresponding shelving states, each selected from a first plurality of shelving states, the at least one control qudit precluding said transferring when the control state is an interacting state, wherein
the plurality of states is a subset of possible qudit states, and each possible qudit state can be populated by a decay process from at most one of the first plurality of shelving states;
conditionally, according to a control state of the at least one control qudit, coherently transferring qubits encoding the at least one target qudit from the plurality of states to corresponding shelving states selected from a second plurality of shelving states when an error occurred during the transfer from the first plurality of states to the corresponding shelving states, the at least one control qudit precluding said transferring when the control state is an interacting state;
modifying any of the plurality of qubits in the plurality of states;
conditionally, according to a control state of the at least one control qudit, coherently transferring qubits encoding the at least one target qudit from the shelving states of the first plurality of shelving states to each shelving state's corresponding state from the plurality of states; and
incoherently transferring any qubits encoding the target qudit not in a qudit state to a corresponding qudit state.

14. The method of claim 13, wherein each of the plurality of qudits is encoded in atomic states.

15. The method of claim 13, wherein each of the at least one target qudit and at least one control qudit correspond to a qubit.

16. The method of claim 13, wherein modifying any of the plurality of qubits comprises applying a unitary operation.

17. The method of claim 16, wherein the unitary operation is an X gate.

18. A system comprising:
a confinement system configured to arrange a plurality of particles in an array, the plurality of particles configured to encode a plurality of data qudits and an ancilla qudit, the confinement system further configured to arrange the plurality of particles encoding the plurality of data qudits into a grouping wherein the particles encoding each of the plurality of data qudits are within an interaction distance of an interacting state of the particles encoding the ancilla qudit, wherein
the confinement system comprises a laser source arranged to create a plurality of confinement regions and a source of an atom cloud, the atom cloud capable of being positioned to at least partially overlap with the plurality of confinement regions;
a detector configured to detect a state of the ancilla qudit, and thereby detect a leakage error of a first data qudit of the plurality of data qudits into the interacting state.

19. The device of claim 18, wherein the array is two-dimensional.

20. A system comprising:
a confinement system configured to arrange a plurality of particles in an array, the plurality of particles configured to encode a plurality of data qudits and an ancilla qudit,
wherein
the confinement system comprises a first laser source arranged to create a plurality of confinement regions and a source of an atom cloud, the atom cloud capable of being positioned to at least partially overlap with the plurality of confinement regions;
a second laser source configured to drive each of the plurality of particles into one of a plurality of quantum states, the plurality of quantum states selected such that angular momentum selection rules prohibit mixing between the plurality of quantum states during a leakage error of one of the plurality of particles into a noninteracting state;
a third laser source configured to optically pump the noninteracting state, the optical pumping preserving coherence of the plurality of quantum states in the absence of the leakage error.

21. The device of claim 20, wherein the array is two-dimensional.
